(19) United States
(12) Patent Application Publication
(10) Pub. No.: US 2026/0217896 A1
(43) Pub. Date: Jul. 30, 2026

(54) BIODEGRADABLE BIO-BASED POLYURETHANES

(71) Applicants: The Regents of the University of California, Oakland, CA (US); Algenesis Corporation, Cardiff, CA (US)

(72) Inventors: Aaron M. Bruckbauer, San Diego, CA (US); Gordon Bailey Scofield, San Diego, CA (US); Marco Nicholas Allemann, San Diego, CA (US); Ryan Matthew Simkovsky, Carlsbad, CA (US); Stephen Patrick Mayfield, Cardiff, CA (US); Michael Burkart, San Diego, CA (US)

(21) Appl. No.: 19/629,661

(22) Filed: Mar. 26, 2026

Related U.S. Application Data
(63) Continuation of application No. PCT/US2024/048723, filed on Sep. 26, 2024.
(60) Provisional application No. 63/585,833, filed on Sep. 27, 2023.
(60) Provisional application No. 63/557,681, filed on Feb. 26, 2024.

(51) Int. Cl. C08G 18/42; C08G 18/08; C08G 18/24; C08G 18/32; C08G 18/66; C08G 18/73; C08G 101/00

(52) U.S. Cl. CPC C08G 18/4216; C08G 18/14; C08G 18/246; C08G 18/3206; C08G 18/664; C08G 18/73; C08G 2101/00; C08G 2110/0008; C08G 2110/0066; C08G 2230/00

(57) ABSTRACT

Disclosed herein are biodegradable polyurethanes comprising subunits from an aliphatic diisocyanate, an aliphatic chain extender, and a polyester-polyol, wherein the polyester-polyol comprises subunits from 2,5-furandicarboxylic acid and/or linear aliphatic diacid(s).

### CROSS-REFERENCE TO RELATED APPLICATIONS

This application is a bypass continuation of International Application No. PCT/US2024/048723, filed on Sep. 26, 2024, which claims priority to U.S. Provisional Application No. 63/585,833, filed on Sep. 27, 2023, and to U.S. Provisional Application No. 63/557,681, filed on Feb. 26, 2024, the contents of each of which are incorporated by reference herein in their entireties.

### STATEMENT OF GOVERNMENT SUPPORT

This invention was made with government support under 2011924 awarded by the National Science Foundation (NSF), and under DE-EE0009295 awarded by the United States Department of Energy (DOE). The government has certain rights in the invention.

### FIELD OF DISCLOSURE

The present technology relates generally to the field of biodegradable bio-based polymers. In particular, presented herein are biodegradable polyurethanes.

### SUMMARY

Provided herein in one aspect is a biodegradable polyurethane comprising subunits from an aliphatic diisocyanate, a chain extender, and a polyester-polyol, wherein the polyester-polyol comprises subunits from 2,5-furandicarboxylic acid. In some embodiments, the aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; isophorone diisocyanate; methylene dicyclohexyl diisocyanate; or a combination of two or more thereof. In some embodiments, the aliphatic diisocyanate comprises 1,3-trimethylene diisocyanate; 1,5-pentamethylene diisocyanate; 1,7-heptamethylene diisocyanate; or a combination of two or more thereof. In some embodiments, the aliphatic diisocyanate comprises 1,4-tetramethylene diisocyanate; 1,6-hexamethylene diisocyanate; 1,8-octamethylene diisocyanate; 1,12-diisocyanatododecane; or a combination of two or more thereof. In some embodiments, the aliphatic diisocyanate is derived from a photosynthetic source. In some embodiments, the photosynthetic source comprises algae, plant(s), or a combination thereof. In some embodiments, the chain extender comprises 1,3-propanediol; 1,4-butanediol; 1,5-pentanediol; 1,6-hexanediol; or a combination of two or more thereof. In some embodiments, the chain extender comprises 1,3-propanediol. In some embodiments, the polyester-polyol comprises subunits with one or more linear aliphatic dicarboxylic acids with at least 3 carbons and one or more C₂-C₆ diols. In some embodiments, the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof. In some embodiments, the one or more linear aliphatic dicarboxylic acids comprise azelaic acid. In some embodiments, the one or more linear aliphatic dicarboxylic acids are derived from a photosynthetic source. In some embodiments, the photosynthetic source comprises algae, plant(s), or a combination thereof. In some embodiments, subunits from 2,5-furandicarboxylic acid are present in an amount of 1 mol % to 30 mol % relative to subunits from total molar amount of all dicarboxylic acids used to prepare the polyester-polyol. In some embodiments, subunits from 2,5-furandicarboxylic acid are present in an amount of 10 mol % to 30 mol % relative to subunits from total molar amount of all dicarboxylic acids used to prepare the polyester-polyol. In some embodiments, the one or more C₂-C₆ diols comprise 1,3-propanediol; 1,4-butanediol; 1,5-pentanediol; 1,6-hexanediol; or a combination of two or more thereof. In some embodiments, the one or more C₂-C₆ diols comprise 1,3-propanediol. In some embodiments, the 2,5-furandicarboxylic acid is derived from a photosynthetic source. In some embodiments, the photosynthetic source comprises algae, plant(s), or a combination thereof. In some embodiments, the polyester-polyol has a molecular weight as measured by gel permeation chromatography (GPC) of about 3900 g/mol to about 11000 g/mol. In some embodiments, the biodegradable polyurethane has 20% to 40% hard segments as calculated by the following equation:

$$Hard segment ( \% ) = \frac{{g}_{( chain extender )} + {g}_{( diisocyanate )}}{{g}_{( total mass )}} * 100$$

wherein g_{(chain extender)} is mass of chain extender, g_{(diisocyanate)} is mass of diisocyanate, and g_{(total mass)} is total mass of the polyurethane. In some embodiments, the molar ratio of subunits from polyester-polyol to subunits from chain extender is 0.3:1 to 1.7:1. In some embodiments, the molar ratio of subunits from diisocyanate to subunits from chain extender is 1.4:1 to 3.0:1. In some embodiments, the molar ratio of subunits from diisocyanate to subunits from polyester-polyol is 1.70:1 to 4.65:1. In some embodiments, the chain extender is incorporated in an amount of 1 to 20 parts per 100 parts of polyester-polyol to prepare the biodegradable polyurethane. In some embodiments, the aliphatic diisocyanate is incorporated in an amount of 20 to 50 parts per 100 parts of polyester-polyol to prepare the biodegradable polyurethane. In some embodiments, the biodegradable polyurethane is in the form of a thermoset polyurethane. In some embodiments, the biodegradable polyurethane disclosed herein is in the form of a foam. In some embodiments, the biodegradable polyurethane is in the form of a thermoplastic polyurethane.

Provided herein in another aspect is a method to prepare a biodegradable polyurethane, the method comprising: contacting 2,5-furandicarboxylic acid, one or more linear aliphatic dicarboxylic acids with at least 3 carbons, and one or more C₂-C₆ diols in a first polymerization reaction to obtain a polyester-polyol; and contacting the polyester-polyol with a chain extender and an aliphatic diisocyanate in a second polymerization reaction to obtain the biodegradable polyurethane. In some embodiments, the aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; isophorone diisocyanate; methylene dicyclohexyl diisocyanate; or a combination of two or more thereof. In some embodiments, the aliphatic diisocyanate comprises 1,3-trimethylene diisocyanate; 1,5-pentamethylene diisocyanate; 1,7-heptamethylene diisocyanate; or a combination of two or more thereof. In some embodiments, the aliphatic diisocyanate comprises 1,4-tetramethylene diisocyanate; 1,6-hexamethylene diisocyanate; 1,8-octamethylene diisocyanate; 1,12-diisocyanatododecane; or a combination of two or more thereof. In some embodiments, the aliphatic diisocyanate is derived from a photosynthetic source. In some embodiments, the photosynthetic source comprises algae, plant(s), or a combination thereof. In some embodiments, the chain extender comprises 1,3-propanediol; 1,4-butanediol; 1,5-pentanediol; 1,6-hexanediol; or a combination of two or more thereof. In some embodiments, the chain extender comprises 1,3-propanediol. In some embodiments, the polyester-polyol further comprises subunits with one or more linear aliphatic dicarboxylic acids with at least 3 carbons and one or more C₂-C₆ diols. In some embodiments, the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof. In some embodiments, the one or more linear aliphatic dicarboxylic acids comprise azelaic acid. In some embodiments, the one or more linear aliphatic dicarboxylic acids are derived from a photosynthetic source. In some embodiments, the photosynthetic source comprises algae, plant(s), or a combination thereof. In some embodiments, 2,5-furandicarboxylic acid is present in an amount of 1 mol % to 30 mol % relative to total molar amount of all dicarboxylic acids used to prepare the polyester-polyol. In some embodiments, 2,5-furandicarboxylic acid is present in an amount of 10 mol % to 30 mol % relative to total molar amount of all dicarboxylic acids used to prepare the polyester-polyol. In some embodiments, the one or more C₂-C₆ diols comprise 1,3-propanediol; 1,4-butanediol; 1,5-pentanediol; 1,6-hexanediol; or a combination of two or more thereof. In some embodiments, the one or more C₂-C₆ diols comprise 1,3-propanediol. In some embodiments, the 2,5-furandicarboxylic acid is derived from a photosynthetic source. In some embodiments, the photosynthetic source comprises algae, plant(s), or a combination thereof. In some embodiments, the molar ratio of polyester-polyol to chain extender is 0.3:1 to 1.7:1. In some embodiments, the molar ratio of diisocyanate to chain extender is 1.4:1 to 3.0:1. In some embodiments, the molar ratio of subunits from diisocyanate to subunits from polyester-polyol is 1.70:1 to 4.65:1. In some embodiments, the aliphatic diisocyanate is incorporated in an amount of 20 to 50 parts per 100 parts of polyester-polyol. In some embodiments, the chain extender is incorporated in an amount of 1 to 20 parts per 100 parts of polyester-polyol. In some embodiments, the method further comprises providing the 2,5-furandicarboxylic acid, the one or more linear aliphatic dicarboxylic acids, the one or more C₂-C₆ diols, the chain extender, and the aliphatic diisocyanate from photosynthetic source(s); and the photosynthetic source(s) comprise algae, plant(s), or a combination thereof. In some embodiments, the biodegradable polyurethane is in the form of a thermoset polyurethane. In some embodiments, the biodegradable polyurethane is in the form of a foam. In some embodiments, the biodegradable polyurethane is in the form of a thermoplastic polyurethane.

Provided herein in another aspect is a biodegradable polyurethane whose microplastics do not persist in the environment but instead rapidly biodegrade, comprising subunits from an aliphatic diisocyanate, an aliphatic polyester-polyol, and an aliphatic chain extender. In some embodiments, the aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; or a combination of two or more thereof. In some embodiments, the aliphatic diisocyanate is derived from a photosynthetic source. In some embodiments, the photosynthetic source comprises algae, plant(s), or a combination thereof. In some embodiments, the chain extender comprises 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the polyester-polyol comprises subunits with one or more linear aliphatic dicarboxylic acids with at least 3 carbons and one or more C₂-C₁₀ diols. In some embodiments, the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof. In some embodiments, the one or more linear aliphatic dicarboxylic acids are derived from a photosynthetic source. In some embodiments, the photosynthetic source comprises algae, plant(s), or a combination thereof. In some embodiments, the one or more C₂-C₁₀ diols comprise 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the one or more C₂-C₁₀ diols are derived from a photosynthetic source. In some embodiments, the photosynthetic source comprises algae, plant(s), or a combination thereof. In some embodiments, the biodegradable polyurethane disclosed herein is in the form of a foam. In some embodiments, the biodegradable polyurethane disclosed herein is in the form of a thermoplastic (TPU).

Provided herein in another aspect is a biodegradable thermoset polyurethane comprising subunits from a linear aliphatic diisocyanate, a linear aliphatic chain extender, and a linear aliphatic polyester-polyol. In some embodiments, the linear aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; or a combination of two or more thereof. In some embodiments, the linear aliphatic diisocyanate comprises 1,3-trimethylene diisocyanate; 1,5-pentamethylene diisocyanate; 1,7-heptamethylene diisocyanate; or a combination of two or more thereof. In some embodiments, the linear aliphatic diisocyanate comprises 1,4-tetramethylene diisocyanate; 1,6-hexamethylene diisocyanate; 1,8-octamethylene diisocyanate; 1, 12-diisocyanatododecane; or a combination of two or more thereof. In some embodiments, the linear aliphatic diisocyanate is derived from a photosynthetic source. In some embodiments, the photosynthetic source comprises algae, plant(s), or a combination thereof. In some embodiments, the linear chain extender comprises 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the linear chain extender comprises 1,3-propanediol. In some embodiments, the linear aliphatic polyester-polyol comprises subunits with one or more linear aliphatic dicarboxylic acids with at least 3 carbons and one or more C₂-C₁₀ diols. In some embodiments, the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof. In some embodiments, the one or more linear aliphatic dicarboxylic acids comprise azelaic acid. In some embodiments, the one or more linear aliphatic dicarboxylic acids are derived from a photosynthetic source. In some embodiments, the photosynthetic source comprises algae, plant(s), or a combination thereof. In some embodiments, the one or more C₂-C₁₀ diols comprise 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the one or more C₂-C₁₀ diols comprise 1,3-propanediol. In some embodiments, the linear aliphatic chain extender is incorporated in an amount of 1 to 20 parts per 100 parts of polyester-polyol to prepare the biodegradable polyurethane. In some embodiments, the linear aliphatic diisocyanate is incorporated in an amount of 25 to 30 parts per 100 parts of polyester-polyol to prepare the biodegradable polyurethane. In some embodiments, biodegradable thermoset polyurethane is in the form of a foam.

Provided herein in another aspect is a method to prepare a biodegradable polyurethane, the method comprising: contacting one or more linear aliphatic dicarboxylic acids with at least 3 carbons and one or more C₂-C₁₀ diols in a first polymerization reaction to obtain a polyester-polyol; and contacting the polyester-polyol with a chain extender and an aliphatic diisocyanate in a second polymerization reaction to obtain the biodegradable polyurethane. In some embodiments, the aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; or a combination of two or more thereof. In some embodiments, the aliphatic diisocyanate is derived from a photosynthetic source. In some embodiments, the photosynthetic source comprises algae, plant(s), or a combination thereof. In some embodiments, the chain extender comprises 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the polyester-polyol comprises subunits with one or more linear aliphatic dicarboxylic acids with at least 3 carbons and one or more C₂-C₁₀ diols. In some embodiments, the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof. In some embodiments, the one or more linear aliphatic dicarboxylic acids are derived from a photosynthetic source. In some embodiments, the photosynthetic source comprises algae, plant(s), or a combination thereof. In some embodiments, the one or more C₂-C₁₀ diols comprise 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the one or more C₂-C₁₀ diols are derived from a photosynthetic source. In some embodiments, the photosynthetic source comprises algae, plant(s), or a combination thereof. In some embodiments, the biodegradable polyurethane disclosed herein is in the form of a foam. In some embodiments, the biodegradable polyurethane disclosed herein is in the form of a thermoplastic (TPU).

Provided herein in another aspect is a method to prepare a biodegradable thermoset polyurethane, the method comprising: contacting one or more linear aliphatic dicarboxylic acids with at least 3 carbons and one or more C₂-C₁₀ diols in a first polymerization reaction to obtain a linear aliphatic polyester-polyol; and contacting the linear aliphatic polyester-polyol with a linear aliphatic chain extender and a linear aliphatic diisocyanate in a second polymerization reaction to obtain the biodegradable thermoset polyurethane. In some embodiments, the linear aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; or a combination of two or more thereof. In some embodiments, the linear aliphatic diisocyanate comprises 1,3-trimethylene diisocyanate; 1,5-pentamethylene diisocyanate; 1,7-heptamethylene diisocyanate; or a combination of two or more thereof. In some embodiments, the linear aliphatic diisocyanate comprises 1,4-tetramethylene diisocyanate; 1,6-hexamethylene diisocyanate; 1,8-octamethylene diisocyanate; 1,12-diisocyanatododecane; or a combination of two or more thereof. In some embodiments, the linear aliphatic diisocyanate is derived from a photosynthetic source. In some embodiments, the photosynthetic source comprises algae, plant(s), or a combination thereof. In some embodiments, the linear aliphatic chain extender comprises 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the linear aliphatic chain extender comprises 1,3-propanediol. In some embodiments, the linear aliphatic polyester-polyol comprises subunits with one or more linear aliphatic dicarboxylic acids with at least 3 carbons and one or more C₂-C₁₀ diols. In some embodiments, the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof. In some embodiments, the one or more linear aliphatic dicarboxylic acids comprise azelaic acid. In some embodiments, the one or more linear aliphatic dicarboxylic acids are derived from a photosynthetic source. In some embodiments, the photosynthetic source comprises algae, plant(s), or a combination thereof. In some embodiments, the one or more C₂-C₁₀ diols comprise 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the one or more C₂-C₁₀ diols comprise 1,3-propanediol. In some embodiments, the linear aliphatic diisocyanate is incorporated in an amount of 20 to 50 parts per 100 parts of polyester-polyol. In some embodiments, the linear aliphatic chain extender is incorporated in an amount of 1 to 20 parts per 100 parts of polyester-polyol. In some embodiments, the method further comprises providing the one or more linear aliphatic dicarboxylic acids, the one or more C₂-C₁₀ diols, the linear aliphatic chain extender, and the linear aliphatic diisocyanate from photosynthetic source(s); and the photosynthetic source(s) comprise algae, plant(s), or a combination thereof. In some embodiments, the biodegradable polyurethane is in the form of a foam.

### BRIEF DESCRIPTION OF THE DRAWINGS

FIGS. 1A-1D: Production and analysis of poly(propylene furonate-azelate) (PPFA) polyol. PPFA polyol was generated according to the (FIG. 1A) synthesis scheme and analyzed by (FIG. 1B) ¹H (top) and ¹³C NMR (bottom), (FIG. 1C) GPC, and (FIG. 1D) FTIR. Peaks of note in (b) include ester-attached methylene at 8=173 ppm (d) include carbonyl peak at 1730 cm⁻¹ and carbon-oxygen bond at 1170 cm⁻¹.

FIGS. 2A-2D: Physical property analysis of generated foams. (FIG. 2A) Stress-strain curves measuring material tensile strength and elongation (n=3, one test shown for simplicity). (FIG. 2B) Force-displacement curve measuring tear c strength (n=3, one test shown for simplicity). (FIG. 2C) Cyclic force loading demonstrating energy dissipation (n=10, 10th cycle shown for simplicity). (FIG. 2D) Thermal profile by differential scanning curve (DSC)(n=3, one test shown for simplicity).

FIGS. 3A-3D: Structural and morphology studies using (FIG. 3A) x-ray diffraction (XRD) of PPFA-6A and commercial cupsole. (FIG. 3B) atomic force microscopy (AFM) of PPFA-6A phase profile (top left) and topography (top right) and cupsole phase profile (bottom left) and topography (bottom right). (FIG. 3C) scanning electron microscopy (SEM) of PPFA-6A (top left, bottom left) and cupsole (top right, bottom right)(FIG. 3D) optical microscope images of PPFA-6A (left) and cupsole (right).

FIGS. 4A-4E: Biodegradation analysis of PPFA-6A. (FIG. 4A) Photographs of PPFA-6A at week 0 (left) and week 12 (right). (FIG. 4B) SEM of PPFA-6A foam samples after 0, 4, 8, or 12 weeks (left to right) in compost. (FIG. 4C) Respirometry of foam samples over 200 days. (FIG. 4D) Structural analysis using Fourier transform infrared (FTIR) of PPFA-6A (left) and control ethylene vinyl acetate (EVA)(right) over the course of 12 weeks. Traces are stacked sequentially from Week 0 at the bottom to Week 12 at the top (FIG. 4E) Mass loss of PPFA-6A and EVA over 12 weeks in compost.

FIGS. 5A-5E: Molded foams of PPFA-6A. (FIG. 5A) Foam after casting into a 1-inch cube mold at 55° C. (FIG. 5B) Foam poured into a heated footbed mold at 55° C. (FIG. 5C) Finalized product using the PPFA-6A foam in a footwear application. (FIG. 5D) Foam after casting into a 10-mm slab mold at 55° C. (FIG. 5E) Demonstration of flexibility of finished prototype flip flop product.

FIGS. 6A-6B: Nuclear magnetic resonance (NMR) spectra of PPFA. (FIG. 6A) 1H NMR spectra. (FIG. 6B) 13C NMR spectra.

FIGS. 7A-7B: Fourier Transform Infrared Spectroscopy (FTIR) spectra of (FIG. 7A) PPFA. (FIG. 7B) PPFA-6A.

FIGS. 8A-8C: (FIG. 8A) Tensile strength and elongation of PPFA-6A and commercial cupsole. (FIG. 8B) Tear c strength of PPFA-6A and commercial cupsole. (FIG. 8C) Hysteresis of PPFA-6A and commercial cupsole.

FIGS. 9A-9B: Thermal profile of PPFA-6A by (FIG. 9A) Differential scanning calorimetry of PPFA-6A (top) and cupsole (bottom) in 3 heat cycles. (FIG. 9B) Thermogravimetric analysis (TGA).

FIG. 10 depicts generating microplastics particles and tracking their biodegradation in compost. Microplastic particles were generated by sanding solid sheets of plastic materials and size selection of the resulting particulates by sieving. Particles smaller than 5 mm and larger than 350 μm were selected and mixed with fresh compost in equal mass ratios. Biodegradation of microplastic particles in compost was tracked by extraction and direct particle visualization. Additionally, biodegradation and mineralization of microplastics to CO₂ in compost was monitored by aerobic respirometry performed at 45° C. Microbial enrichments were performed to isolate strains that utilize biodegradable microplastics as a carbon source and to identify possible depolymerization products.

FIGS. 11A-11B depict comparison of persistent EVA and transient TPU-FC1 microplastic particles. (FIG. 11A) Representative images of microplastic extraction filters. Microplastic particles were stained with Nile Red and illuminated with blue light for imaging. Particles appear bright against the darker filter background. Full color images and images with quantified microplastics using ImageJ are provided in FIGS. 16A-16C. (FIG. 11B) Particle counts of various microplastics materials over time in compost and background compost at Day 0, 90, and 200. Values represent the average of at least 3 independent microplastic extraction procedures. Two-way ANOVA, ****=p<0.0001; **=p<0.01; ns=p>0.05.

FIG. 12 depicts biodegradation of materials in compost monitored by CO₂ evolution respirometry. Percent theoretical biodegradation calculated as described in Materials and Methods. Dashed lines indicate 75% theoretical biodegradation at 45 days, which the cellulose control material must reach as an experimental validation condition of the ASTM5338 standard.

FIGS. 13A-13D depict characterization of bacteria capable of utilizing thermoplastic polyurethane as a sole carbon source. (FIG. 13A) Growth curves of various strains grown with TPU-FC1 as a sole carbon source in minimal media at 22° C. (FIGS. 13B-13D) Growth of various strains on diacids, diol, and diamine monomers derived from the TPU-FC1 formulation, each compound was provided as sole carbon sources in minimal media at a concentration of 1 g/L. Data presented are the average of three biological replicates. Note the change in y-axis scale for FIG. 13D.

FIG. 14 depicts depolymerization of TPU-FC1 into monomers and oligomers. GC chromatograms of cell-free supernatants from cultures of Rhodococcus sp. 2b grown with TPU-FC1 as a sole carbon source. Peaks 1 and 3 appeared after 2 days incubation. Peak 2 is the diethyl succinate internal standard. Peak 4 was present in both the sample and control and was assumed to be a component of the media. Peak 1 was identified as the TPU-FC1 diol monomer based on its fragmentation pattern and compared against an authentic standard. Peak 3 was proposed to be a TPU-FC1 oligomer based on fragmentation structure prediction.

FIGS. 15A-15F depict scanning electron microscopy of biodegraded TPU products compared to controls. (FIGS. 15A-15B) Coated fabric after two-week incubation in compost. (FIG. 15C) Control image of coated fabric that was not placed in compost. (FIGS. 15D-15E) Phone case after 12-month incubation in compost. (FIG. 15F) Control image of injection molded phone case that was not placed in compost.

FIGS. 16A-16C depict full scale images of all microplastic extraction filters. Tables to the left are particle counts of quantified microplastics generated in ImageJ. (FIG. 16A) Filters from TPU-FC1 at the indicated times/replicates. (FIG. 16B) Filters from the EVA samples at the indicated times/replicates. (FIG. 16C) Compost only control filters at the indicated times/replicates.

FIGS. 17A-17D depict biodegradation of various prototype products made from bio-based TPU materials. (FIG. 17A) TPU-coated fabric after 2 weeks in compost conditions. (FIG. 17B) Control sample of TPU-coated fabric that was not exposed to compost after 2 weeks. (FIG. 17C) Injection molded TPU phone case after one year in compost. (FIG. 17D) Control images of TPU phone case not exposed to compost.

FIG. 18 depicts biodegradation comparing aliphatic and aromatic TPUs that have been either pelletized or made into microplastics. TPU-HC2, a TPU composed of an aliphatic polyester-polyol and an aromatic isocyanate. Data is converted from amounts of carbon dioxide detected over time in a respirometer based upon the theoretical carbon content of each sample as per equation 1.

FIG. 19 depicts biodegradation comparing TPUs that have been ground into microplastics which vary either in the identity of their isocyanate moieties or the hardness of the final TPU. TPUs are labeled based on the isocyanate used (“Arom”=an aromatic isocyanate, “Cyclic Aliph.”=a cyclic aliphatic isocyanate, and “Linear Aliph.”=a linear aliphatic) and the hardness of the final product (“Soft”=71 Shore A, “Med.”=85 Shore A, and “Hard”=94 Shore A). Data is converted from amounts of carbon dioxide detected over time in a respirometer based upon the theoretical carbon content of each sample as per equation 1.

FIG. 20 depicts FTIR analysis of polyester-polyols SP1, SP2₍₁₀₎, SP2₍₂₀₎, and SP2₍₃₀₎.

FIG. 21 depicts gel permeation chromatography analysis of polyester-polyols SP1, SP2₍₁₀₎, SP2₍₂₀₎, and SP2₍₃₀₎.

FIGS. 22A-22D depict mechanical properties of TPUs SP16A-20, SP2₍₁₀₎6A-20, SP2₍₂₀₎6A-20, SP2₍₃₀₎6A-20, SP16A-40, SP2₍₁₀₎6A-40, SP2₍₂₀₎6A-40, and SP2₍₃₀₎6A-40. FIG. 22A: tensile strength at mechanical failure; FIG. 22B: elongation percent at break; FIG. 22C: Young's Modulus; FIG. 22D: hardness under shore A durometer testing.

FIG. 23 depicts reaction kinetics at specific reaction time points at industrial standards of cream time, rise time, tack-free time, and pinch time for polyurethane (PU) foams SP26A, SP27A, SP244M, CP16A, and CP17A compared with commercial cupsole.

FIGS. 24A-24E depict mechanical properties of PU foams SP26A, SP27A, SP244M, CP16A, and CP17A compared with commercial cupsole. FIG. 24A: stress-strain curve measuring tensile strength and elongation. FIG. 24B: force-displacement curve measuring tear c strength. FIG. 24C: density. FIG. 24D: rebound measurement. FIG. 24E: hardness test of the PU foams. All tests were done in triplicate.

FIG. 25 depicts commercial applicability of PU foams SP26A, SP27A, SP244M, CP16A, and CP17A in production of flip flop footwear. SP27A and CP17A foams are 100% renewable foams.

FIG. 26 depicts percent biodegradation of PU foams SP26A, SP27A, SP244M, CP16A, and CP17A compared to commercial cupsole at day 40 by respirometry.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

### Polyurethanes Incorporating Furandicarboxylic Acid

The first synthetic plastic was first discovered in 1907 with a polymerization reaction between phenol and formaldehyde and two decades later polyvinyl chloride (PVC) was synthesized at B.F. Goodrich. The general use and widespread need for ubiquitous plastics didn't occur until the 1950s due to the demand for scientific innovation during World War II with the excess petroleum oil produced. Thus, synthetic plastics became the main focus for the use of excess oil with the idea of a mechanically robust plastic material that would last forever. However, bioplastics existed long before this such as natural rubbers and latex, which were developed in the late 19th century with bioplastics to date becoming a highly focused area of research. Now, over half a billion tons of plastics are produced each year with less than 9% of this being recycled globally and less than 1% considered renewable or biodegradable. The rest of the plastic is either discarded ending up in oceans and landfills, or incinerated, with the released carbon increasing global greenhouse gas emissions.

Polyurethanes (PUs), which account for 10% of all plastic produced globally, are a versatile class of plastics with a wide range of applications from thermoplastics, such as coatings and adhesives, to thermosets, including construction materials, fashion, and footwear. The versatility of this class of plastic comes from the two main components, a polyol and a diisocyanate, that are reacted through condensation to form a PU. Polyols are polymer chains containing multiple hydroxyl functionality and are most commonly polyether polyols that are not biodegradable and have historically been produced from petroleum feedstocks. Polyester-polyols are an alternative to polyether polyols that can be bio-sourced, because they are derived from condensation of dicarboxylic acids (diacids) and diols that can be biologically derived and are biodegradable. Typically, polyols are comprised of long, linear chains that contribute to the soft segments of the polyurethanes giving rise to properties such elasticity and flexibility. Diisocyanates are a reactive species that are exclusively derived from petroleum at scale, with the aromatic diisocyanates having no known biological alternative. To date, the most commonly used isocyanates for the synthesis of polyurethanes are the aromatic isocyanates, methylene diphenyl diisocyanate (MDI) and toluene diisocyanate (TDI), which make up more than 90% of all polyurethane products, both thermoset and thermoplastic. However, the only renewable isocyanates are aliphatic isocyanates such as 1,5-pentamethylene diisocyanate (5-PDI) and 1,7-heptamethylene diisocyanate (7-HDI) derived from corn and algae, respectively, and their petroleum counterpart 1,6-hexamethylene diisocyanate (6-HDI). Diisocyanates form rigid sections of the PU due to the hydrogen bonding from the urethane group resulting in the hard segment contributing to appreciable material properties such as thermal transitions and durability. The versatility of PUs comes from the diversity of properties that can be achieved by the combinatorics of the diversity of these monomers in spite of the limited diversity provided by petroleum-derived monomers compared to the much larger potential diversity of biologically sourced monomers.

The central dogma of PU formulation states that aromatic moieties are important for generating desirable and commercially relevant PU properties for thermoset foams, which dominate the PU sector in widespread applications such as furniture, construction, automotive, and footwear. These aromatic groups have been exclusively derived from MDI and TDI. In contrast, aliphatic isocyanates have found use in transparent coating applications and adhesives. Because petroleum-derived polyols are solely aliphatic and only aliphatic isocyanates have the promise of being derived from biological sources at commercial scales, the PU central dogma suggests that a fully bio-sourced PU foam should not be achievable without the use of aromatic polyols.

Furan dicarboxylic acid (FDCA), an aromatic biologically sourced monomer, has been considered by the U.S. Department of Energy as an important renewable building block for future polymer materials. Much of the research on FDCA is on poly(ethylene furanoate), an alternative to poly(ethylene terephthalate)(PET), which is currently under commercial production. In more recent years, the synthesis of flame-retardant rigid polyurethane foams using FDCA and MDI has been achieved, but not much more is known about its potential, specifically, in PU foam systems.

Accordingly, described herein in one aspect is the use of FDCA in polyol synthesis to maintain the aromatic moieties that dogma dictates is required for foams with an aliphatic isocyanate. As a result, an aliphatic PU foam is produced that is mechanically robust, thermally stable, and biodegradable. Moreover, the process can be used as a drop-in solution to petroleum manufacturing plants for a variety of applications, such as the footwear industry, depending on the formulation.

In a further aspect, described herein is a biodegradable polyurethane comprising, consisting essentially of, or consisting of subunits from an aliphatic diisocyanate, a chain extender, and a polyester-polyol, wherein the polyester-polyol comprises subunits from 2,5-furandicarboxylic acid.

In some embodiments, the aliphatic diisocyanate comprises, consists essentially of, or consists of 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; isophorone diisocyanate; methylene dicyclohexyl diisocyanate; or a combination of two or more thereof. In some embodiments, the aliphatic diisocyanate comprises, consists essentially of, or consists of 1,3-trimethylene diisocyanate; 1,5-pentamethylene diisocyanate; 1,7-heptamethylene diisocyanate; or a combination of two or more thereof. In some embodiments, the aliphatic diisocyanate comprises, consists essentially of, or consists of 1,4-tetramethylene diisocyanate; 1,6-hexamethylene diisocyanate; 1,8-octamethylene diisocyanate; 1,12-diisocyanatododecane; or a combination of two or more thereof. In some embodiments, the aliphatic diisocyanate comprises, consists essentially of, or consists of 1,6-hexamethylene diisocyanate; 1,7-heptamethylene diisocyanate; or a combination thereof. In some embodiments, the aliphatic diisocyanate comprises, consists essentially of, or consists of 1,6-hexamethylene diisocyanate. In some embodiments, the aliphatic diisocyanate comprises, consists essentially of, or consists of 1,7-heptamethylene diisocyanate.

In some embodiments, the aliphatic diisocyanate is derived from a photosynthetic source. In some embodiments, the photosynthetic source comprises algae, plant(s), or a combination thereof.

In some embodiments, the chain extender comprises, consists essentially of, or consists of 1,3-propanediol; 1,4-butanediol; 1,5-pentanediol; 1,6-hexanediol; or a combination of two or more thereof. In some embodiments, the chain extender comprises, consists essentially of, or consists of 1,3-propanediol. In some embodiments, the chain extender is derived from a photosynthetic source. In some embodiments, the photosynthetic source comprises algae, plant(s), or a combination thereof.

In some embodiments, the polyester-polyol further comprises subunits from one or more linear aliphatic dicarboxylic acids with at least 3 carbons and one or more C₂-C₆ diols.

In some embodiments, the one or more linear aliphatic dicarboxylic acids comprise, consist essentially of, or consist of malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof. In some embodiments, the one or more linear aliphatic dicarboxylic acids comprise, consist essentially of, or consist of azelaic acid.

In some embodiments, the one or more linear aliphatic dicarboxylic acids are derived from a photosynthetic source. In some embodiments, the photosynthetic source comprises algae, plant(s), or a combination thereof.

In some embodiments, the one or more C₂-C₆ diols comprise, consist essentially of, or consist of 1,3-propanediol; 1,4-butanediol; 1,5-pentanediol; 1,6-hexanediol; or a combination of two or more thereof. In some embodiments, the one or more C₂-C₆ diols comprise, consist essentially of, or consist of 1,3-propanediol. In some embodiments, the one or more C₂-C₆ diols are derived from a photosynthetic source. In some embodiments, the photosynthetic source comprises algae, plant(s), or a combination thereof.

In some embodiments, the 2,5-furandicarboxylic acid is derived from a photosynthetic source. In some embodiments, the photosynthetic source comprises algae, plant(s), or a combination thereof.

In some embodiments, the polyester-polyol has a molecular weight as measured by gel permeation chromatography (GPC) of about 3900 g/mol to about 11000 g/mol. This includes about 3900, 4000, 4500, 5000, 5500, 6000, 6500, 7000, 7500, 8000, 8500, 9000, 9500, 10000, 10500, or 11000 g/mol, including any value therebetween. In some embodiments, the polyester-polyol has a molecular weight as measured by GPC of about 3900 g/mol to about 6000 g/mol.

In some embodiments, the polyester-polyol has a polydispersity index (PDI) of 1.4 to 1.9. This includes a PDI of 1.4, 1.5, 1.6, 1.7, 1.8, or 1.9, including any value therebetween.

In some embodiments, subunits from 2,5-furandicarboxylic acid are present in an amount of 1 mol % to 30 mol % relative to subunits from total molar amount of all dicarboxylic acids (i.e., 2,5-furandicarboxylic acid and the one or more linear aliphatic dicarboxylic acids) used to prepare the polyester-polyol. This includes 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 mol %, including any value therebetween. In some embodiments, subunits from 2,5-furandicarboxylic acid are present in an amount of 10 mol % to 30 mol % relative to subunits from total molar amount of all dicarboxylic acids used to prepare the polyester-polyol. In some embodiments, subunits from 2,5-furandicarboxylic acid are present in an amount of 10 mol % relative to subunits from total molar amount of all dicarboxylic acids used to prepare the polyester-polyol. In some embodiments, subunits from 2,5-furandicarboxylic acid are present in an amount of 20 mol % relative to subunits from total molar amount of all dicarboxylic acids used to prepare the polyester-polyol. In some embodiments, subunits from 2,5-furandicarboxylic acid are present in an amount of 30 mol % relative to subunits from total molar amount of all dicarboxylic acids used to prepare the polyester-polyol.

In some embodiments, the molar ratio of subunits from polyester-polyol to subunits from chain extender is 0.3:1 to 1.7:1. This includes 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, and 1.7:1, and any value therebetween. In some embodiments, the molar ratio of subunits from polyester-polyol to subunits from chain extender is 1.3:1 to 1.7:1. This includes 1.3:1, 1.4:1, 1.5:1, 1.6:1, and 1.7:1, and any value therebetween. In some embodiments, the molar ratio of subunits from polyester-polyol to subunits from chain extender is 0.30:1 to 0.40:1. This includes 0.30:1, 0.31:1, 0.32:1, 0.33:1, 0.34:1, 0.35:1, 0.36:1, 0.37:1, 0.38:1, 0.39:1, and 0.40:1, and any value therebetween.

In some embodiments, the molar ratio of subunits from aliphatic diisocyanate to subunits from chain extender is 1.4:1 to 3.0:1. This includes 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, and 3.0:1, and any value therebetween. In some embodiments, the molar ratio of subunits from aliphatic diisocyanate to subunits from chain extender is 2.5:1 to 3.0:1. This includes 2.5:1, 2.6:1, 2.7:1, 2.8:1, 2.9:1, and 3.0:1, and any value therebetween. In some embodiments, the molar ratio of subunits from aliphatic diisocyanate to subunits from chain extender is 1.40:1 to 1.55:1. This includes 1.40:1, 1.41:1, 1.42:1, 1.43:1, 1.44:1, 1.45:1, 1.46:1, 1.47:1, 1.48:1, 1.49:1, 1.50:1, 1.51:1, 1.52:1, 1.53:1, 1.54:1, and 1.55:1, and any value therebetween.

In some embodiments, the molar ratio of subunits from aliphatic diisocyanate to subunits from polyester-polyol is 1.70:1 to 4.65:1. This includes 1.70:1, 1.80:1, 1.90:1, 2:1, 2.10:1, 2.20:1, 2.30:1, 2.40:1, 2.50:1, 2.60:1, 2.70:1, 2.80:1, 2.90:1, 3:1, 3.10:1, 3.20:1, 3.30:1, 3.40:1, 3.50:1, 3.60:1, 3.70:1, 3.80:1, 3.90:1, 4:1, 4.10:1, 4.20:1, 4.30:1, 4.40:1, 4.50:1, 4.60:1, and 4.65:1, and any value therebetween. In some embodiments, the molar ratio of subunits from aliphatic diisocyanate to subunits from polyester-polyol is 1.70:1 to 1.95:1. This includes 1.70:1, 1.71:1, 1.72:1, 1.73:1, 1.74:1, 1.75:1, 1.76:1, 1.77:1, 1.78:1, 1.79:1, 1.80:1, 1.81:1, 1.82:1, 1.83:1, 1.84:1, 1.85:1, 1.86:1, 1.87:1, 1.88:1, 1.89:1, 1.90:1, 1.91:1, 1.92:1, 1.93:1, 1.94:1, and 1.95:1, and any value therebetween. In some embodiments, the molar ratio of subunits from aliphatic diisocyanate to subunits from polyester-polyol is 4.10:1 to 4.65:1. This includes 4.10:1, 4.15:1, 4.20:1, 4.25:1, 4.30:1, 4.35:1, 4.40:1, 4.45:1, 4.50:1, 4.55:1, 4.60:1, and 4.65:1, and any value therebetween.

In some embodiments, the biodegradable polyurethane has 1% to 40% hard segments as calculated by the following equation:

$$Hard segment ( \% ) = \frac{{g}_{( c hain extender )} + {g}_{( diisocyanate )}}{{g}_{( total mass )}} * 100$$

wherein g_{(chain extender)} is the mass of chain extender (e.g., PDO), g_{(diisocyanate)} is the mass of diisocyanate (e.g., 6-HDI), and g_{(total mass)} is the total mass of the polyurethane. This includes 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% hard segments, including any value therebetween. In some embodiments, the biodegradable polyurethane has 20% hard segments. In some embodiments, the biodegradable polyurethane has 40% hard segments. In some embodiments, the biodegradable polyurethane has 20% to 40% hard segments.

In some embodiments, the chain extender is incorporated in an amount of 1 to 20 parts per 100 parts of polyester-polyol to prepare the biodegradable polyurethane. This includes 1, 2, 3, 4, 5, 6, 7, 8, 9, 10, 11, 12, 13, 14, 15, 16, 17, 18, 19, or 20 parts, or any value therebetween, per 100 parts of polyester-polyol. In some embodiments, the chain extender is incorporated in an amount of 3 parts per 100 parts of polyester-polyol to prepare the biodegradable polyurethane.

In some embodiments, the aliphatic diisocyanate is incorporated in an amount of 20 to 50 parts per 100 parts of polyester-polyol to prepare the biodegradable polyurethane. This includes 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts, or any value therebetween, per 100 parts of polyester-polyol. In some embodiments, the aliphatic diisocyanate is incorporated in an amount of 26 to 40 parts per 100 parts of polyester-polyol to prepare the biodegradable polyurethane.

In some embodiments, the biodegradable polyurethane disclosed herein is in the form of a thermoset polyurethane. In some embodiments, the biodegradable polyurethane disclosed herein is in the form of a foam. In some embodiments, the biodegradable polyurethane disclosed herein is in the form of a thermoplastic polyurethane (TPU).

### Methods of Preparation of Polyurethanes Incorporating Furandicarboxylic Acid

In another aspect, disclosed herein is a method to prepare a biodegradable polyurethane disclosed herein.

In some embodiments, the method comprises, consists essentially of, or consists of:
contacting 2,5-furandicarboxylic acid, one or more linear aliphatic dicarboxylic acids with at least 3 carbons, and one or more C₂-C₆ diols in a first polymerization reaction to obtain a polyester-polyol; and
contacting the polyester-polyol with a chain extender and an aliphatic diisocyanate in a second polymerization reaction to obtain the biodegradable polyurethane.

In some embodiments, the method further comprises providing the 2,5-furandicarboxylic acid, the one or more linear aliphatic dicarboxylic acids, the one or more C₂-C₆ diols, the chain extender, the aliphatic diisocyanate, or any combination of two or more thereof, from photosynthetic source(s). In some embodiments, the method further comprises providing the 2,5-furandicarboxylic acid from photosynthetic source(s). In some embodiments, the method further comprises providing the one or more linear aliphatic dicarboxylic acids, from photosynthetic source(s). In some embodiments, the method further comprises providing the one or more C₂-C₆ diols from photosynthetic source(s). In some embodiments, the method further comprises providing the chain extender from photosynthetic source(s). In some embodiments, the method further comprises providing the aliphatic diisocyanate from photosynthetic source(s). In some embodiments, the method further comprises providing the 2,5-furandicarboxylic acid, the one or more linear aliphatic dicarboxylic acids, the one or more C₂-C₆ diols, the chain extender, and the aliphatic diisocyanate from photosynthetic source(s). In some embodiments, the photosynthetic source(s) comprise algae, plant(s), or a combination thereof.

In some embodiments, the molar ratio of polyester-polyol to chain extender is 0.3:1 to 1.7:1. This includes 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, and 1.7:1, and any value therebetween. In some embodiments, the molar ratio of polyester-polyol to chain extender is 1.3:1 to 1.7:1. This includes 1.3:1, 1.4:1, 1.5:1, 1.6:1, and 1.7:1, and any value therebetween. In some embodiments, the molar ratio of polyester-polyol to chain extender is 0.30:1 to 0.40:1. This includes 0.30:1, 0.31:1, 0.32:1, 0.33:1, 0.34:1, 0.35:1, 0.36:1, 0.37:1, 0.38:1, 0.39:1, and 0.40:1, and any value therebetween.

In some embodiments, the molar ratio of aliphatic diisocyanate to chain extender is 1.4:1 to 3.0:1. This includes 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, and 3.0:1, and any value therebetween. In some embodiments, the molar ratio of aliphatic diisocyanate to chain extender is 2.5:1 to 3.0:1. This includes 2.5:1, 2.6:1, 2.7:1, 2.8:1, 2.9:1, and 3.0:1, and any value therebetween. In some embodiments, the molar ratio of aliphatic diisocyanate to chain extender is 1.40:1 to 1.55:1. This includes 1.40:1, 1.41:1, 1.42:1, 1.43:1, 1.44:1, 1.45:1, 1.46:1, 1.47:1, 1.48:1, 1.49:1, 1.50:1, 1.51:1, 1.52:1, 1.53:1, 1.54:1, and 1.55:1, and any value therebetween.

In some embodiments, the molar ratio of aliphatic diisocyanate to polyester-polyol is 1.70:1 to 4.65:1. This includes 1.70:1, 1.80:1, 1.90:1, 2:1, 2.10:1, 2.20:1, 2.30:1, 2.40:1, 2.50:1, 2.60:1, 2.70:1, 2.80:1, 2.90:1, 3:1, 3.10:1, 3.20:1, 3.30:1, 3.40:1, 3.50:1, 3.60:1, 3.70:1, 3.80:1, 3.90:1, 4:1, 4.10:1, 4.20:1, 4.30:1, 4.40:1, 4.50:1, 4.60:1, and 4.65:1, and any value therebetween. In some embodiments, the molar ratio of aliphatic diisocyanate to polyester-polyol is 1.70:1 to 1.95:1. This includes 1.70:1, 1.71:1, 1.72:1, 1.73:1, 1.74:1, 1.75:1, 1.76:1, 1.77:1, 1.78:1, 1.79:1, 1.80:1, 1.81:1, 1.82:1, 1.83:1, 1.84:1, 1.85:1, 1.86:1, 1.87:1, 1.88:1, 1.89:1, 1.90:1, 1.91:1, 1.92:1, 1.93:1, 1.94:1, and 1.95:1, and any value therebetween. In some embodiments, the molar ratio of aliphatic diisocyanate to polyester-polyol is 4.10:1 to 4.65:1. This includes 4.10:1, 4.15:1, 4.20:1, 4.25:1, 4.30:1, 4.35:1, 4.40:1, 4.45:1, 4.50:1, 4.55:1, 4.60:1, and 4.65:1, and any value therebetween.

Rapidly Biodegradable Polyester Polyurethanes with Aliphatic Isocyanates

One of the major consequences of ubiquitous plastic usage by humans is the generation of microplastics: tiny plastic particles that persist in the environment and have now been documented to spread though all parts of the planet. While the reported size range for microplastics varies, they are generally defined as particles between 5 mm and 500 μm in size. These particles can originate from any plastic source, including bottles, bags, and packaging, as well as synthetic textiles, tire wear, and microbeads from personal care products. Microplastics are typically formed through a variety of physical and chemical processes, such as physical or chemical-induced fragmentation, abrasion, manufacturing processes, and UV degradation. Microplastics have now been documented to accumulate in all environmental compartments, such as water bodies, soil, precipitation, and even dispersed in the air; and pose potential risks to ecosystems and organisms. Microplastics are now part of the food chain, and early evidence suggests the potential for significant harm to animal and humans from these materials.

The only real way to mitigate the environmental impact of microplastics, is to develop plastics that do not generate persistent microplastics as part of their normal lifecycle. Even plastics that are properly collected and recycled generate microplastics as part of the normal wear from everyday use or as a consequence of recycling or washing processes. Thus, to prevent the accumulation of microplastics, new plastic materials must be developed that are completely biodegradable so that any particles generated from these products will quickly degrade in the environment. Biodegradation is the process by which microbes break down polymers into simpler molecules that can be used as a source of carbon to produce biomass. This requires that the polymer contains chemical bonds, most notably in the polymer's primary backbone structure, that are physically accessible to enzymes that naturally recognize these bonds as substrates, and that the underlying monomer molecules that are released through this enzymatic cleavage can be consumed by microorganisms. In natural environments, this process is typically performed by consortia of microbes secreting hydrolytic enzymes, which sever the polymer to release a variety of monomer and oligomers that can then be utilized as a carbon nutrient source by the microbes. Catabolism of these polymer-derived oligomers and monomers leads to the generation of organismal biomass and CO₂ via respiration. While many biobased materials are derived from natural renewable sources, they can potentially persist in the environment due to their limited ability to biodegrade or due to chemical processing that make them inaccessible to biological cleavage, as occurs with the vulcanization of rubber.

There is a need for rapidly biodegradable polymers that do no produce persistent microplastics.

Accordingly, in another aspect, described herein is the use of aliphatic moieties to generate polyurethane materials that are fully and rapidly biodegradable so that microplastics generated from these are rapidly biodegradable and do not persist in the environment. Further, the use of specific formulation methodologies control the rate by which the complete product and its resultant microplastics biodegrade in a manner that is more rapid and complete than similar products made with aromatic or cyclic aliphatic moieties.

In another aspect, disclosed herein is a rapidly biodegradable polyurethane comprising, consisting essentially of, or consisting of subunits from an aliphatic diisocyanate, a chain extender, and a polyester-polyol. In some embodiments, the rapidly biodegradable polyurethane comprises, consists essentially of, or consists of subunits from a linear aliphatic diisocyanate, a linear aliphatic chain extender, and a linear aliphatic polyester-polyol.

In some embodiments, the linear aliphatic diisocyanate comprises, consists essentially of, or consists of 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; or a combination of two or more thereof. In some embodiments, the aliphatic diisocyanate comprises, consists essentially of, or consists of 1,3-trimethylene diisocyanate; 1,5-pentamethylene diisocyanate; 1,7-heptamethylene diisocyanate; or a combination of two or more thereof. In some embodiments, the aliphatic diisocyanate comprises, consists essentially of, or consists of 1,4-tetramethylene diisocyanate; 1,6-hexamethylene diisocyanate; 1,8-octamethylene diisocyanate; 1,12-diisocyanatododecane; or a combination of two or more thereof. In some embodiments, the aliphatic diisocyanate comprises, consists essentially of, or consists of 1,6-hexamethylene diisocyanate; 1,7-heptamethylene diisocyanate; or a combination thereof. In some embodiments, the aliphatic diisocyanate comprises, consists essentially of, or consists of 1,6-hexamethylene diisocyanate. In some embodiments, the aliphatic diisocyanate comprises, consists essentially of, or consists of 1,7-heptamethylene diisocyanate.

In some embodiments, the linear aliphatic diisocyanate is derived from a photosynthetic source. In some embodiments, the photosynthetic source comprises algae, plant(s), or a combination thereof.

In some embodiments, the linear aliphatic chain extender comprises, consists essentially of, or consists of 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the chain extender comprises, consists essentially of, or consists of 1,3-propanediol. In some embodiments, the linear aliphatic chain extender is derived from a photosynthetic source. In some embodiments, the photosynthetic source comprises algae, plant(s), or a combination thereof.

In some embodiments, the linear aliphatic polyester-polyol comprises, consists essentially of, or consists of subunits with one or more linear aliphatic dicarboxylic acids with at least 3 carbons and one or more C₂-C₁₀ diols.

In some embodiments, the one or more linear aliphatic dicarboxylic acids comprise, consist essentially of, or consist of malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof. In some embodiments, the one or more linear aliphatic dicarboxylic acids comprise, consist essentially of, or consist of azelaic acid. In some embodiments, the one or more linear aliphatic dicarboxylic acids are derived from a photosynthetic source. In some embodiments, the photosynthetic source comprises algae, plant(s), or a combination thereof.

In some embodiments, the one or more C₂-C₁₀ diols comprise, consist essentially of, or consist of 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof. In some embodiments, the one or more C₂-C₁₀ diols comprise, consist essentially of, or consist of 1,3-propanediol. In some embodiments, the one or more C₂-C₁₀ diols are derived from a photosynthetic source. In some embodiments, the photosynthetic source comprises algae, plant(s), or a combination thereof.

In some embodiments, the linear aliphatic chain extender is incorporated in an amount of 1 to 20 parts per 100 parts of polyester-polyol to prepare the biodegradable polyurethane. This includes 1, 2, 3, 4, 5, 6, 7, 8, 9, 10, 11, 12, 13, 14, 15, 16, 17, 18, 19, or 20 parts, or any value therebetween, per 100 parts of polyester-polyol. In some embodiments, the linear aliphatic chain extender is incorporated in an amount of 3 parts per 100 parts of polyester-polyol to prepare the biodegradable polyurethane.

In some embodiments, the linear aliphatic diisocyanate is incorporated in an amount of 20 to 50 parts per 100 parts of polyester-polyol to prepare the biodegradable polyurethane. This includes 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts, or any value therebetween, per 100 parts of polyester-polyol. In some embodiments, the linear aliphatic diisocyanate is incorporated in an amount of 26 to 27 parts per 100 parts of polyester-polyol to prepare the biodegradable polyurethane.

In some embodiments, the one or more linear aliphatic dicarboxylic acids, the one or more C₂-C₁₀ diols, the linear aliphatic chain extender, and the linear aliphatic diisocyanate are derived from photosynthetic source(s). In some embodiments, the photosynthetic source(s) comprise algae, plant(s), or a combination thereof.

In some embodiments, the biodegradable polyurethane disclosed herein is in the form of a thermoset polyurethane. In some embodiments, the biodegradable polyurethane disclosed herein is in the form of a foam.

Accordingly, in another aspect, disclosed herein is a biodegradable thermoset polyurethane comprising, consisting essentially of, or consisting of subunits from an aliphatic diisocyanate, a chain extender, and a polyester-polyol. In some embodiments, the biodegradable thermoset polyurethane comprises, consists essentially of, or consists of subunits from a linear aliphatic diisocyanate, a linear aliphatic chain extender, and a linear aliphatic polyester-polyol.

In some embodiments, the biodegradable polyurethane disclosed herein is in the form of a thermoplastic polyurethane (TPU).

Methods of Preparation of Rapidly Biodegradable Polyester Polyurethanes with Aliphatic Isocyanates

In another aspect, disclosed herein is a method to prepare a biodegradable polyurethane disclosed herein.

In some embodiments, the method comprises, consists essentially of, or consists of:
contacting one or more linear aliphatic dicarboxylic acids with at least 3 carbons, and one or more C₂-C₁₀ diols in a first polymerization reaction to obtain a linear aliphatic polyester-polyol; and
contacting the linear aliphatic polyester-polyol with a linear aliphatic chain extender and a linear aliphatic diisocyanate in a second polymerization reaction to obtain the biodegradable polyurethane.

In some embodiments, the method further comprises providing the one or more linear aliphatic dicarboxylic acids, the one or more C₂-C₁₀ diols, the linear aliphatic chain extender, the linear aliphatic diisocyanate, or any combination of two or more thereof, from photosynthetic source(s). In some embodiments, the method further comprises providing the one or more linear aliphatic dicarboxylic acids from photosynthetic source(s). In some embodiments, the method further comprises providing the one or more C₂-C₁₀ diols from photosynthetic source(s). In some embodiments, the method further comprises providing the linear aliphatic chain extender from photosynthetic source(s). In some embodiments, the method further comprises providing the linear aliphatic diisocyanate from photosynthetic source(s). In some embodiments, the method further comprises providing the one or more linear aliphatic dicarboxylic acids, the one or more C₂-C₁₀ diols, the linear aliphatic chain extender, and the linear aliphatic diisocyanate from photosynthetic source(s). In some embodiments, the photosynthetic source(s) comprise algae, plant(s), or a combination thereof.

### Other Methods

In another aspect, disclosed herein are methods to accelerate the biodegradation of a thermoset or thermoplastic polyurethane.

Accordingly, in another aspect, disclosed herein is a method to accelerate the biodegradation of a thermoplastic polyester-polyurethane, the method comprising, consisting essentially of, or consisting of minimizing presence of aromatic subunits in the polyester-polyurethane. As used herein, “aromatic subunits” refer to polymer subunits containing phenyl rings or heteroaryl rings. The presence of aromatic subunits may be minimized by partially or completely replacing the aromatic subunits with aliphatic subunits during preparation of the polyester-polyurethane using methods of preparation described herein.

In another aspect, disclosed herein is a method to accelerate the biodegradation of a thermoplastic polyester-polyurethane, the method comprising, consisting essentially of, or consisting of preparing the polyester-polyurethane according to the methods described herein.

In another aspect, disclosed herein is a method to accelerate the biodegradation of a foam comprising, consisting essentially of, or consisting of a polyester-polyurethane, the method comprising, consisting essentially of, or consisting of minimizing presence of aromatic subunits in the polyester-polyurethane. The presence of aromatic subunits may be minimized by partially or completely replacing the aromatic subunits with aliphatic subunits during preparation of the polyester-polyurethane foam using methods of preparation described herein.

In another aspect, disclosed herein is a method to accelerate the biodegradation of foam comprising, consisting essentially of, or consisting of a polyester-polyurethane, the method comprising, consisting essentially of, or consisting of preparing the polyester-polyurethane according to the methods described herein.

In another aspect, disclosed herein are methods to minimize microplastic production during biodegradation of a thermoplastic polyester-polyurethane.

Accordingly, in another aspect, disclosed herein is a method to minimize microplastic production during biodegradation of a thermoplastic polyester-polyurethane, the method comprising, consisting essentially of, or consisting of minimizing presence of aromatic subunits in the polyester-polyurethane. The presence of aromatic subunits may be minimized by partially or completely replacing the aromatic subunits with aliphatic subunits during preparation of the thermoplastic polyester-polyurethane using methods of preparation described herein.

In another aspect, disclosed herein are methods to minimize microplastic production during biodegradation of a foam comprising, consisting essentially of, or consisting of a polyester-polyurethane.

Accordingly, in another aspect, disclosed herein is a method to minimize microplastic production during biodegradation of a foam comprising, consisting essentially of, or consisting of a polyester-polyurethane, the method comprising, consisting essentially of, or consisting of minimizing presence of aromatic subunits in the polyester-polyurethane. The presence of aromatic subunits may be minimized by partially or completely replacing the aromatic subunits with aliphatic subunits during preparation of the foam using methods of preparation described herein.

### Examples

### Example 1. PU Incorporating Poly(Propylene Furonate-Azelate)(PPFA)

Materials. All chemicals received were used without further purification. Azelaic acid (98%) was purchased from Acros Organics, PDO (98%) and dibutyltin dilaurate catalyst (95%) was purchased from Sigma Aldrich. L-1507, Y, DBT, and A1, where supplied from Momentive. In preparation of PU foams, 1,6-hexamethylene diisocyanate (98%) purity was supplied by Alfa Aesar. The determination of hydroxyl and acid value titrations were performed according to ASTM 1899 and D664, respectively. The reagents used for the titrations were p-toluenesulfonyl isocyanate (96%) and 1.0 M tetrabutylammonium hydroxide in methanol, supplied by Sigma Aldrich. Solvents used for titrations were HPLC grade acetonitrile, toluene, 2-propanol, reagent grade 1-octanol, and potassium hydroxide supplied by Fisher Chemical. Soleic cupsole, referred to here as cupsole, was supplied by Algenesis Materials.

General Procedure of poly(propylene furonate-azelate)(PPFA). In a typical polycondensation reaction for the FDCA polyol, 2-5-furandicarboxylic acid and 1,3-propane diol was combined together in a 2-neck round bottom flask equipped with a magnetic stir bar. A Dean-Stark apparatus with a cooled jacketed reflux condenser was attached to the flask for monitoring of water released from the polymerization reaction under heat while stirring under nitrogen. Once a homogenous mixture was obtained, azelaic acid was added. Typically, after 8 hours, 80% of the expected water by-product was collected in the Dean-Stark apparatus. Then, catalytic dibutyltin dilaurate (DBTL) was added to the mixture, and the polycondensation was continued for typically 48-72 hours. Once the condensation reaction was completed, the polyol was submitted for acid and hydroxyl titrations to obtain acid (<1) and hydroxyl account respectively to ensure reaction completion. After the desired acid number was achieved, the polyol was put in a vacuum oven for 3 days at 90° C. to remove remaining water.

General Preparation for 6-HDI based polyurethane foam (PPFA-6A). A typical flexible foam formulation contains polyol, diisocyanate, surfactant, water, and isocyanate. Additional additives such as blowing catalyst, gelling catalyst, and dyes can be added. Thus, there are several variables which play significant roles in product quality. In a typical foam formulation, polyol, chain extender, surfactant, water, blowing catalyst, gelling catalysts were added to a plastic cup and mixed at 2000 RPM for 1 minute. The mixture was heated to 75° C. and then nucleated with an overhead stirrer. Isocyanate was added to the polyol mixture and mixed at 2350 RPM for 10 seconds, then poured into a closed mold heated to 55° C. Foams were demolded after 24 hours and tested for physical and thermal properties after 48 hours.

Nuclear Magnetic Resonance Spectroscopy (NMR). The 1H and 13C NMR spectra were recorded on a JOEL ECA 400 at ambient temperature. The chemical shifts for the 1H NMR were reported in ppm relative to the central singlet solvent signal of DMSO at 2.5 ppm. The 13C NMR spectra was reported in ppm relative to the signal of DMSO at 39.5 ppm.

Gel Permeation Chromatography (GPC). Gel permeation chromatography (GPC) was carried out in a Malvern GPC system equipped with a single Waters Alliance HPLC e2695 Separation Module pump, two Tosoh TSKgel SuperHZM-N+guard (MW range: 200-700,000 g/mol) columns, a Waters 2414 Differential Refractometer (RI), and a Waters 2998 Photodiode Array Detector (PDA). The molecular weight and molecular weight distribution of the polymers were calculated relative to a polystyrene standard. THF served as the polymer solvent and eluent in an equilibrated system at 40° C.

Thermal Conductivity Measurements. Dynamic mechanical analyzer (DMA) measurement for TPUs was performed on a TA Instruments DMA 850 with a DMA oscillatory temperature ramp using a 3-point bending clamp in the temperature range of −120 to 120° C. in a nitrogen atmosphere.

Differential scanning calorimetry (DSC) analysis was performed on a TA Instruments DSC 2500 from −120° C. to 220° C. at the rate of 10° C./min under a nitrogen atmosphere.

Thermal gravimetric analysis (TGA) was carried out on TA Instruments Discovery TGA from 50° C. to 900° C. using a temperature ramp of 10° C./min in a nitrogen atmosphere.

Mechanical Tests. Viscosity was measured using a Digital Rotary Viscometer at 55° C. with spindle 3 and 30 rpm.

Hardness was measured using a Hoto Instruments Asker C Durometer Model E2-C according to ASTM D2240.

Tensile strength and elongation at break were measured using a Shimadzu 10 kN Universal Testing Machine (UTM) Model AGS-X with standard flat pneumatic grips Model PFG-10 kNA and a California Air Tools Ultra Quiet Air Compressor according to ASTM D3574-17 method E. Strain rate used was 500 mm/min.

Tear strength type C was measured using a Shimadzu 10 kN Universal Testing Machine (UTM) Model AGS-X with standard flat pneumatic grips Model PFG-10 kNA and a California Air Tools Ultra Quiet Air Compressor according to ASTM D624-00. Strain rate used was 500 mm/min.

Compression set was measured using a Universal Grip Co. compression set test fixture according to ASTM D395 method B. 10-mm thick disks were compressed to 8.20 mm thickness for 6 hours at 45° C., then were allowed to cool to room temperature for 30 minutes before measurements were taken.

DIN abrasion resistance was measured using a NextGen DIN Abrasion Tester Model NG-DIN according to ASTM D5963-22. The DIN abrasion tester was set to 84 revolutions.

Resilience was measured using a Bareiss GmbH Rebound Elasticity Teser according to ASTM D7121-05.

Hysteresis loss and max force were measured using a MecMesin MultiTest dV and a 2500 N advanced force gauge (AFG) according to ASTM D3574 method X6. This was performed on 1″×1″×1″ cubes which were then compressed to ½ of their original height (0.5″) using 10 cycles. The first 9 cycles were considered as conditioning, and the data presented was from the 10th cycle.

Structural Analysis. FTIR analysis was performed on a Perkin Elmer Spectrum X fitted with a ZnSe 1 mm ATR cell, 16 scans were taken at a 1.0 cm⁻¹ resolution.

The surface topologies of PU foams were characterized by atomic force microscope (AFM)(Veeco Scanning Probe Microscope) in ambient conditions using tapping mode. Silicon cantilevers and tips (Oxford instruments) have the force constant 8.4-57 N/m and the resonance frequency 200-400 kHz, which were used at a driving frequency of 274 kHz. The foam samples were cut to 10 mm×10 mm×2 mm for the imaging. The scanning size was set to 25×25 μm2, and the scanning rate was set to 0.5 Hz. The various foam samples were attached to a 32 mm aluminum SEM sample stub using carbon tape as the adherent. A Denton Vacuum DESK IV Sputter Coater was used to deposit a thin layer of Iridium to the samples. The sputter coater was set to a sputter setpoint of 95% with a rotation setpoint of 100% and a 90 second sputter time. All samples were imaged under high vacuum using an FEI Quanta FEG 250 scanning electron microscope at a specified voltage of 5 kV. Images were obtained at magnifications ranging from 100× to 2000× of both the foams' surface and open cell structure. Each sample was visually analyzed for comparison of structural details.

X-ray diffraction (XRD) measurements were carried out to investigate the microstructure difference between the PPFA-6A and commercial samples (midsole and insole). XRD profiles of film samples (10 mm×5 mm×1 mm) were measured by using an X-ray diffractometer (Anton Paar XRDynamic 500) with Cu Kα radiation (λ=0.154 nm) running at 40 kV and 49 mA.

Biodegradation Analysis. Biodegradation of PU foams was performed under controlled composting conditions according to ASTM 5338-15 standard, monitoring CO2 evolution. Cellulose served as the positive control; ethylene-vinyl acetate (EVA) and compost only samples served as a negative and blank controls, respectively. The experiment was stopped after 150 days of incubation, once mineralization plateau was reached for most materials. For sample preparation substrates were pelletized into ~5 mm pieces using an industrial pelletizer. Fresh compost was collected from Roger's Community Garden composting site at UCSD. 20 g of sample material(s) and 240 g of fresh compost were thoroughly mixed and samples were incubated in a respirometer (Echo Instruments). Sample chambers were maintained at 45° C. and at ~58% relative humidity for the duration of experiment. Sample chambers were opened biweekly to mix compost and add water as needed.

The compost experiments were carried out on borosilicate glass dishes packed with composted materials collected and sieved from Rogers Garden on the University of California, San Diego campus that the samples are then added to and maintained for the duration of their digestion at 45° C. at high ~58% humidity. Samples were analyzed prior to compost degradation to determine Initial masses, FTIR data, and compression values. Masses were taken via Mettler Toledo AG204 Analytical Balance, FTIR data was taken via the Nicolet i520 FTIR spectrometer, compression values obtained via MecMessin MultiTest-dV Motorized Force Tester. Degraded samples were scheduled for specific timepoints for post-degradation analysis. Fenton's Reagent was created mixing equivolume (30 mL each) 30% Hydrogen Peroxide and an Iron Sulfate complex. The Iron Sulfate complex was created by Dissolving 7.5 g of Iron Sulfate Heptahydrate in 500 mL of DI water, then once dissolved, 3 mL of concentrated Sulfuric Acid was added. The samples were then submerged in the Fenton's solution to ensure contact with all biomaterial. After 30 minutes the reagent and sample were heated in a water bath to 55° C., the heat was then removed as the exothermic reaction catalyzed itself, reaching upwards of 75-80° C. during the peak of the reaction before settling back down at 55° C. The reaction lasted 5 minutes before cooling down for another 15 minutes. The sample was then removed from the solution, rinsed of Fentons, and left to dry overnight in a vacuum desiccator. IR, mass, and compression data were repeated to compare to initial non-degraded standards. The samples were maintained weekly via physical sample transfer into a holding container while the compost was aerated and watered to conditions as similar to the previous week as possible.

### Fabrications of PPFA and PPFA-6A Flexible Foam

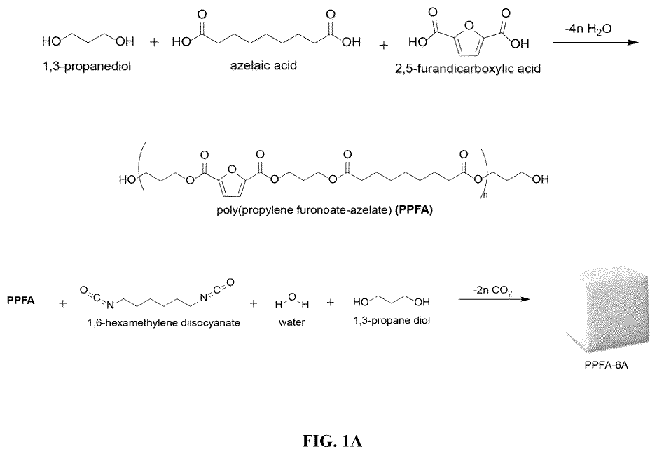

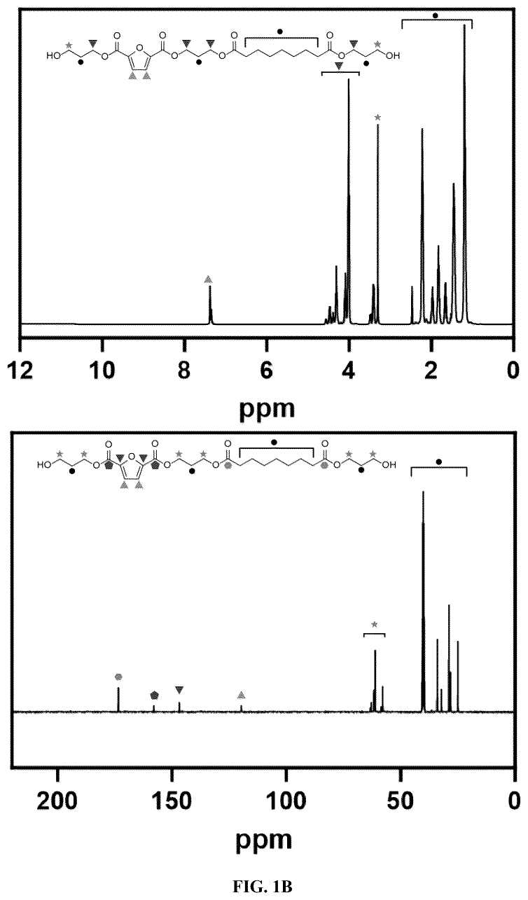

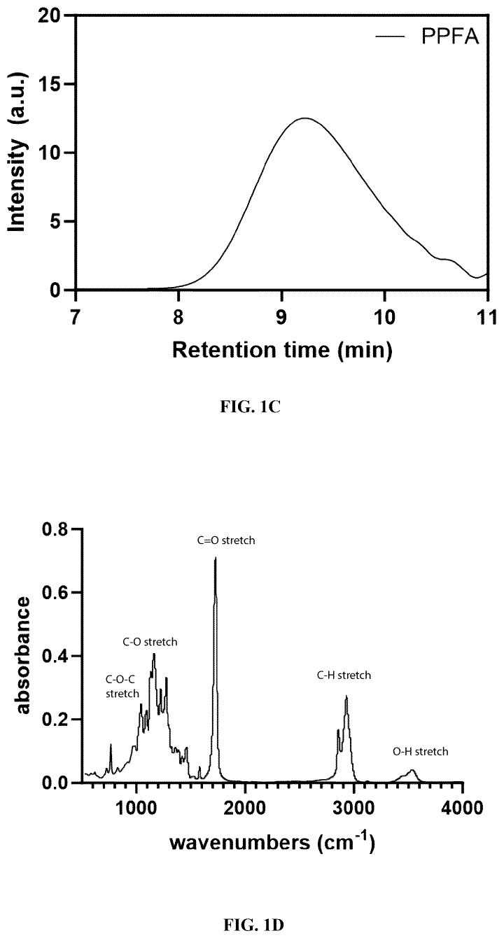

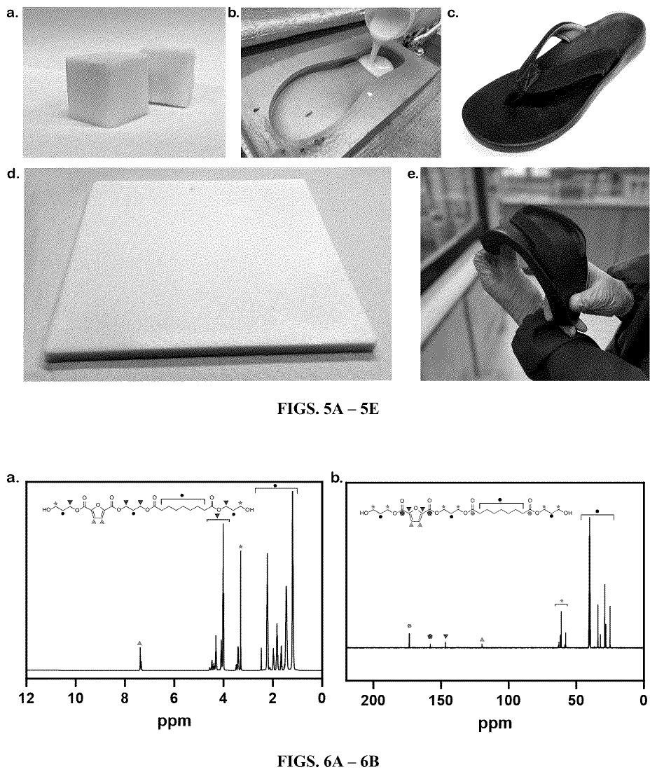

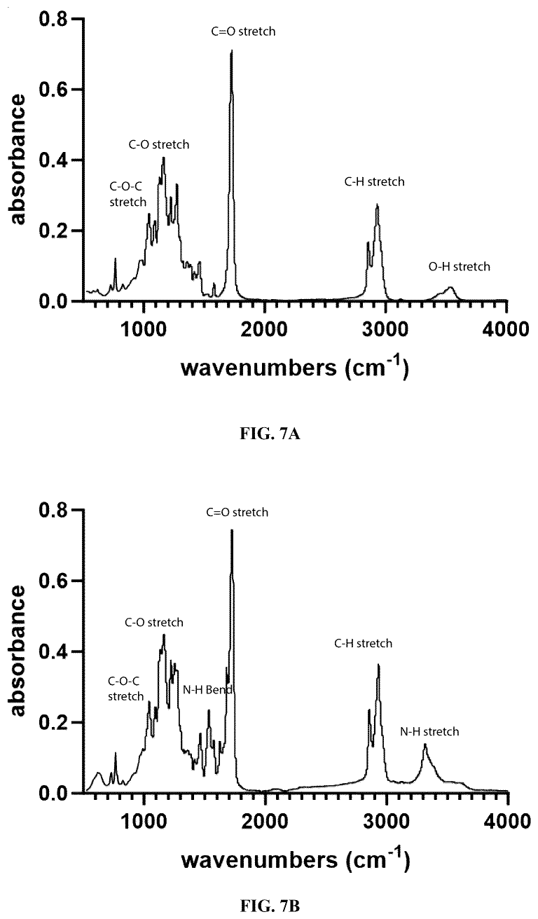

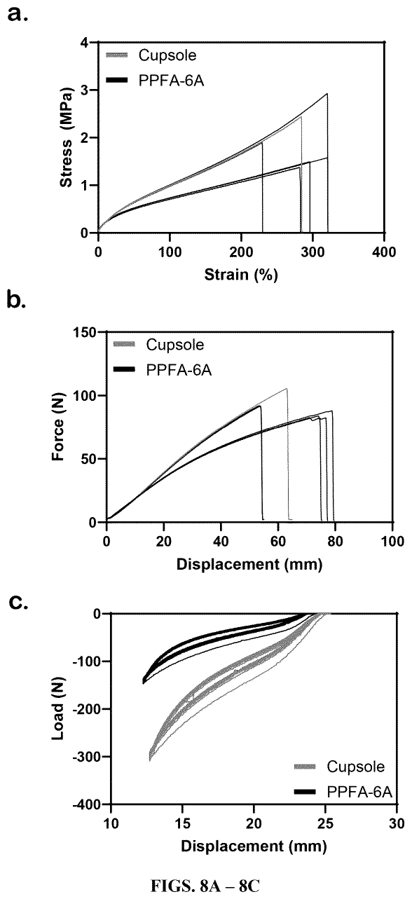

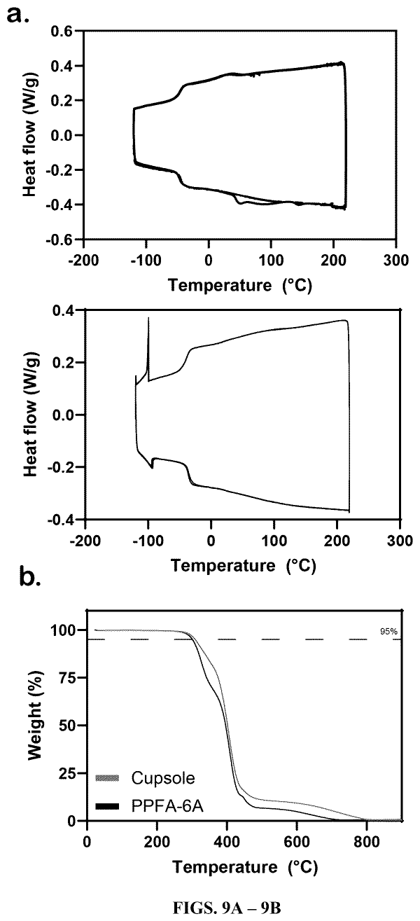

To obtain poly(propylene furonate-azelate)(PPFA), a fully biobased aromatic polyester-polyol, 1,3-propane diol (PDO) was polymerized with sugar-derived FDCA, and lipid-derived azelaic acid catalyzed by dibutyltin dilaurate (DBTDL)(FIG. 1A). The use of two diacids in the polyol formulation has been shown to reduce viscosities of polyester-polyols, an industrially relevant challenge to ensure that polyester-polyols can function in manufacturing equipment typically designed for lower viscosity polyether polyols. The aromatic polyol was structurally characterized using nuclear magnetic resonance (NMR), gel permeation chromatography (GPC) to determine the polyol's polydispersity index (PDI) and molecular weight (MW), and Fourier-transform infrared (FTIR)(FIGS. 1B-1D). Formation of an ester bond between FDCA and PDO was confirmed by the presence of an ester-attached methylene group from the PDO backbone with a distinguished ester carbonyl group at 8=173 ppm in the 13C NMR spectra, and FTIR peaks at 1730 cm⁻¹ and 1170 cm⁻¹ indicating the formation of the ester carbonyl group (FIG. 6 and FIG. 7). GPC analysis demonstrated that the polyol has a PDI of 1.75 and a MW of 6075 g/mol. These results are consistent with the hydroxyl titration with a result of 65 mg KOH/g resulting in a molecular weight of 1680 g/mol (equation 1). PPFA was subjected to viscosity analysis carried out at 65° C. polyol resulting in a viscosity of ~2000 cP.

The characterized PPFA polyester-polyol then underwent subsequent PU synthesis with hexamethylene diisocyanate (6-HDI) and PDO as a chain extender to obtain a PU foam, called here PPFA-6A. Formulation details are described in Table 3. PPFA showed suitable reactivity compared to that of the commercial flexible foam formulation supplied by Algenesis materials which is used exclusively for the footwear industry (Table 4).

### Properties of PPFA-6A Flexible Foam

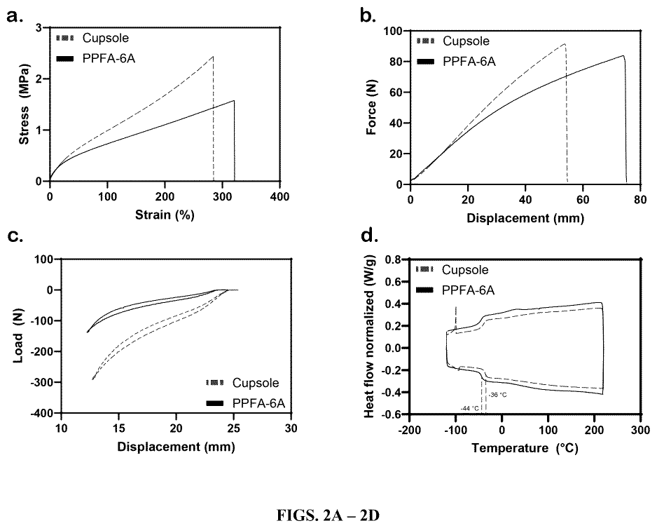

The mechanical and thermal properties of the flexible PU foam, PPFA-6A, were measured by a variety of instruments and compared against a commercial cupsole foam, which is a flexible PU foam used in the footwear industry, to determine its suitability for a similar commercial application. Our preference for the footwear industry was rationalized by its representation of mechanically demanding material while having a limited product lifetime in this generation with many footwear product waste ending up in landfills, oceans, or being incinerated. Comparable properties were defined to be determined by a range of physical metrics commonly requested by companies in the footwear industry (Table 5). A universal testing machine was used to investigate tensile tests such as tensile strength, elongation, and tear c as shown in FIGS. 2A-2B. Energy dissipation of the foam was determined by hysteresis where a 1-inch foam cube was subjected to cyclic compression shown in FIG. 2C and Table 1 (Equation 3 and 4). Other important mechanical properties, hardness, abrasion resistance, density, compression, and rebound were determined as shown in FIG. 2E and Table 2. Glass transition temperature (Tg) was investigated by differential scanning calorimetry (DSC) and determined to be −44° C. with a decomposition temperature (Td) at 301° C. determined by thermogravimetric analysis (TGA) (Table 2). All mechanical and thermal characteristics align closely with the established range of metrics employed by the footwear industry, an example being the commercial cupsole presented here. Of note, the PPFA-6A foam has a 3-fold increase in abrasion resistance and a one-third decrease in density relative to the cupsole foam, meaning that less PPFA-6A foam material is required to generate the same volume of a higher quality foam than is currently commercially available. Because a vast range of formulations can be generated using these same raw ingredients at alternative ratios, resulting in greatly varied foam properties, the potential commercial applications for this foam are diverse.

TABLE 1
Stress-strain based properties of aliphatic based
foam compared to commercial shoe cupsole.

| Sample | Tensile Strength | Elongation | Tear C Strength | Hysteresis |
|---|---|---|---|---|
| Name | (kg/cm²) | (%) | (kg/cm) | (%) |
| PPFA-6A | 15.11 ± 1 | 299 ± 20 | 8.64 ± 0.29 | 81.1 |
| Cupsole | 24.69 ± 5.29 | 278 ± 46 | 9.81 ± 0.81 | 88.5 |

TABLE 2
Mechanical and thermal properties of aliphatic based foam compared to
commercial shoe cupsole.

| Sample | DIN Abrasion | Compression | Hardness | Rebound | Density | T_{g} | T_{d} |
|---|---|---|---|---|---|---|---|
| Name | (mm³) | (%) | (Asker C) | (%) | (cc) | (° C.) | (° C.) |
| PPFA-6A | 32 ± 23 | 20 ± 2.4 | 50 ± 3.0 | 42 ± 2.0 | 234 | −44 | 301 |
| Cupsole | 105 | 19 | 55 | 43 | 380 | −36 | 309 |

### Structure of PPFA-6A Flexible Foam

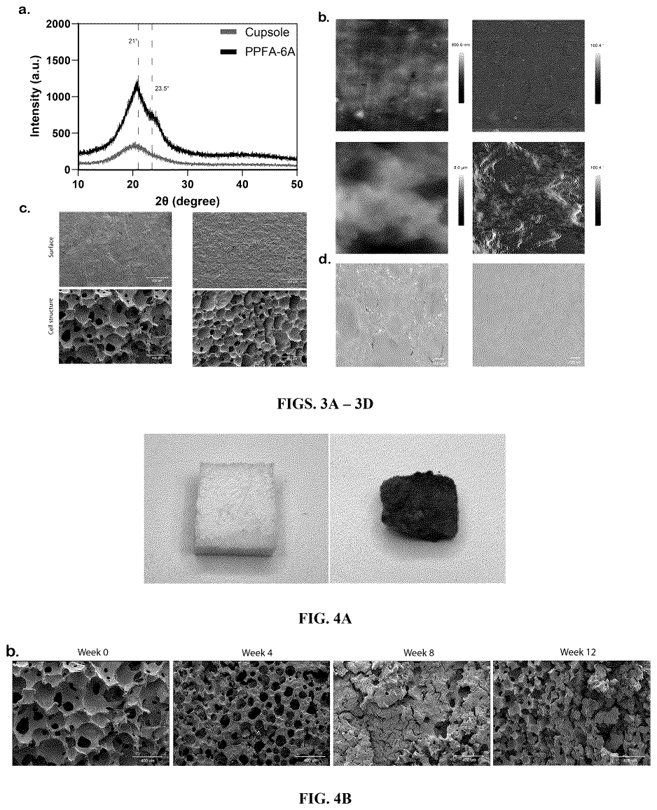

Because PPFA-6A is comprised of an aliphatic isocyanate and has aromatics in the polyol component, instead of the traditional location of aromatics in the isocyanate component, it was unclear how the hard segments would form relative to the historically used aromatic diisocyanate derived foams. X-ray diffraction (XRD) measurements were carried out to investigate the microstructure of PPFA-6A relative to the commercial cupsole. XRD of foam samples were measured and all samples exhibited a distinct broad diffraction peak at a 2θ angle of 21° (FIG. 3A). The interchain spacing “d” can thus be calculated as 4.23 Å using Bragg's law (Equation 5). This peak indicates the presence of short-range, regularly ordered structure comprised of both hard and soft domains, as well as a disordered structure of the amorphous phase of the PU matrix. In comparison, the PPFA-6A peak is significantly sharpened, suggesting the presence of a well-defined short-range microstructural pattern compared to that of the commercial cupsole.

Surface topologies of PPFA-6A and cupsole PU foams were characterized by atomic force microscopy (AFM) in ambient conditions using tapping mode, where areas of higher rigidity in the sample, interpreted as areas with higher levels of aromatic moieties, lead to lower tip-sample adhesion due to reduced energy during tip-sample interactions as compared to soft regions. Thus, PPFA-6A exhibits smaller domain size with a more homogenous surface compared to that of the commercial cupsole shown in FIG. 3B. This may be due to the variation in foam formulation and sample preparation. However, both foam systems show distinct hard and soft regions, an important characteristic for polyurethane foams, which is consistent with the XRD-based interpretation of the microstructure of the foam.

Scanning electron microscopy and optical images were used to further investigate morphology and cell structure. PPFA-6A and commercial cupsole are similar in structure, the skin of the foam appears rough with no openings or holes while the commercial cupsole shows a more heterogenous topography as shown in the AFM (FIG. 3C). Both PPFA-6A and cupsole show nonuniform craters and holes throughout the structure of the foam with verification of open cell structure in both samples. Both PPFA-6A and cupsole formulation have smooth cell structure with uneven depressions. The commercial cupsole foam has smaller depressions which is also indicated by the smaller cell size as shown by the optical images in FIG. 3D.

### Biodegradation of PPFA-6A Flexible Foam

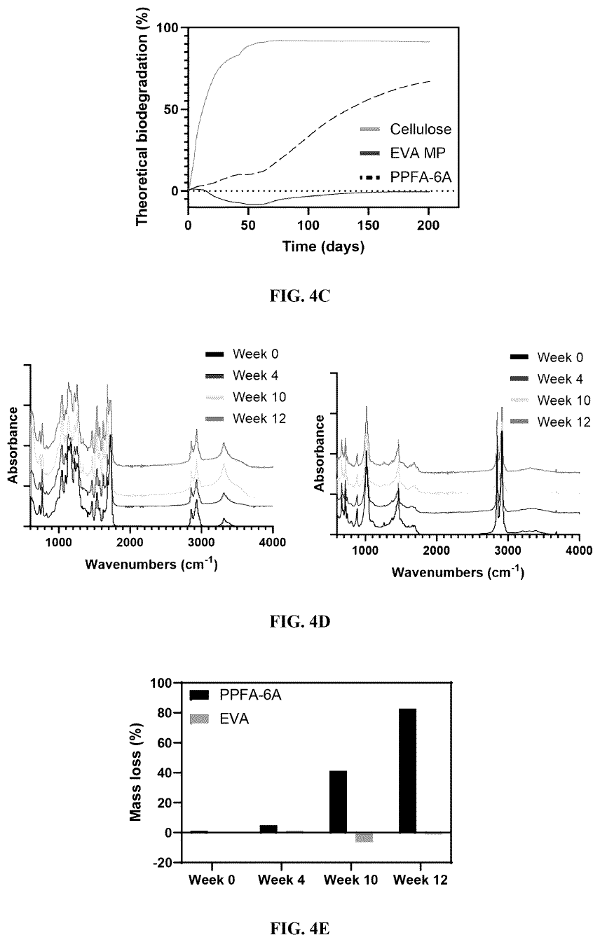

The aliphatic isocyanate based polyurethane foams were susceptible to biodegradation under home composting conditions, as confirmed through qualitative and quantitative methods (FIG. 4). Foam cubes were incubated in compost maintained at 45° C. over the course of 12 weeks. Foam cubes were visually reduced in size and appeared discolored over the course of the experiment (FIG. 4A). SEM imaging of the FDCA foams at various timepoints also confirmed structural changes in the foam along with surface associated microbes compared to the negative control sample of ethyl-vinyl acetate (EVA), a foam known to be non-biodegradable (FIG. 4B). Quantitative biodegradation of the FDCA foam material was assessed by FTIR, respirometry, and mass loss (FIGS. 4C-4E). The FTIR spectrum of the PPFA-6A shows a decrease in signal from week 0 to week 4, and possible structural changes occur at week 10 indicated by a new peak at ~1340 cm⁻¹ and an increase in signal of the hydroxyl and amine stretch at ~3310 cm⁻¹. While not being bound by a specific theory, it is believed that the increase in hydroxyl and amine stretch is due to microorganisms breaking the urethane bond between the carbon-oxygen bond, resulting in an increase in hydroxyl functionality. The control EVA sample indicates no discernible changes over the 12-week biodegradation time period. As shown in FIG. 4D, FDCA foam reached 65% biodegradation within 190 days in compost (Equation 6). Under identical conditions the cellulose control sample reached 75% biodegradation within 45 days, consistent with the specifications of ASTM5338. During the course of 12 weeks, a progressive decline in PPFA-6A mass loss was observed as it underwent degradation, culminating in an 83% total mass reduction by week 12. In contrast, the control sample, EVA, showed no discernible alternations.

### Application of PPFA-6A Flexible Foam

With the aforementioned methodology described above for comparative analysis between the novel aliphatic isocyanate-based foam and the conventional PU foam prevalent in commercial footwear, a drop-in solution was successfully executed and demonstrated to achieve 100% biologically sourced PU products with this molecular design. The synthesized aliphatic isocyanate-based foam, PPFA-6A, was poured into various molds including small cubes, flip flop footbed, and thin slabs to demonstrate the versatility of the material (FIG. 5A, FIG. 5B, FIG. 5D). The resulting foam from the flip flop mold underwent downstream processing into creating a commercially relevant flip flop. A demonstration of its flexibility is shown in FIG. 5C, FIG. 5E.

### Conclusion

Polyurethanes are a diverse class of plastic that make up a large bulk of plastic production today with foam systems having no known route for a 100% sustainable material. The extent of polyurethane sustainability has been achieved through bio-based polyols with no known biological route for the production of essential aromatic diisocyanates, a major component in all polyurethane materials. Nevertheless, detailed characterization of an aliphatic isocyanate-based foam reveals a new approach to 100% sustainable materials with desirable properties. Here, an alternative to the central dogma that utilizes an aromatic polyester-polyol with an aliphatic isocyanate for flexible polyurethane foams was presented. The resultant polyurethane materials exhibit exceptional mechanical properties with high abrasion resistance and low density as well as similar properties in tensile strength, tear c strength, rebound, hardness, and elongation compared to that of a commercial cupsole and well above the baseline metrics for polyurethane foams in the footwear industry with apparent biodegradation. Proof of application was also demonstrated that could be immediately implemented into the market as a drop-in replacement. Furthermore, detailed investigations into structural and morphology show similar morphology and structural characteristics to that of a commercial PU foam.

### Synthesis of Materials

### Poly(Propylene Furonate-Azelate)(PPFA)

67.09 g 2-5-furandicarboxylic acid (0.43 mol, 1.0 eq) and 195.39 g 1,3-propane diol (PDO)(2.57 mol, 6.0 eq) were combined together in a 2-neck round bottom flask equipped with a magnetic stir bar. A Dean-Stark apparatus with a cooled jacketed reflux condenser was attached to the flask for monitoring of water released from the polymerization reaction. The reaction temperature was increased to 150° C., stirred at 500 rpm under a constant nitrogen stream. Once a homogenous mixture was obtained, azelaic acid was added and the temperature was further increased to 170° C. Typically, after 8 hours, 80% of the expected water by-product was collected in the Dean-Stark apparatus. After 24 hours, 2-3 drops of catalytic dibutyltin dilaurate (DBTL) was added to and the polycondensation was continued for typically 48-72 hours. Once the condensation reaction was completed, the polyol was submitted for acid and hydroxyl titrations to obtain acid (<1) and hydroxyl account respectively to ensure reaction completion. After the desired acid number is achieved, the polyol was put in a vacuum oven for 3 days at 90° C. to remove remaining water to afford PPFA.

### PPFA and 1,6-Hexamethylene Diisocyanate Polyurethane Foam (PPFA-6A)

In a typical foam formulation, polyol (PPFA), chain extender (PDO), surfactant (L-1507), water, blowing catalyst (A1), gelling catalysts (DBTDL) were added to a FLACKTEK™ plastic cup and mixed at 2000 RPM for 1 minute (Table 3). The mixture was heated to 75° C. and then nucleated for 30 seconds with an overhead stirrer and heated to 75° C. for 5 minutes. Isocyanate was adjusted based off mass loss from nucleation and then added to the polyol mixture and mixed at 2350 RPM for 10 seconds, then poured into a 10 mm closed mold system that was heated to 55° C. Foams were demolded after 24 hours at 55° C. and tested for physical and thermal properties after 48 hours.

The kinetics of the foam's reaction were assessed through several key parameters. Cream time, characterized as the point at which the mixture exhibits a sharp increase in viscosity. Additionally, rise time, which denotes the duration necessary for the foam to release full expansion. Tack-free time was identified as the point in which the foam ceases to emit material upon perceptible touch. Lastly, pinch time was defined as the moment that the foam can be compressed without any observable tearing or structural alterations (Table 4).

TABLE 3
Table of example formulation of PPFA-6A

| Compound | Part per polyol | Mass (g) |
|---|---|---|
| PPFA | 100 | 126.6 |
| PDO | 3 | 3.798 |
| L-1507 | 1 | 1.266 |
| A1 | 0.100 | 0.127 |
| DBTDL | 0.200 | 0.253 |
| Water | 1 | 1.266 |
| 6-HDI | N/A | 33.09 |

TABLE 4
Table of reaction kinetics of PPFA-6A

| Measurement | Time (s) |
|---|---|
| Cream time | <5 |
| Rise time | 60 ± 10 |
| Tac-free time | 80 ± 17 |
| Pinch time | 110 ± 17 |

### Material Property Testing

### Physical Characterization of PPFA-6A

TABLE 5
Minimum requirements for polyurethane foams in
the footwear industry based off ASTM methods

| | | Commercial foam | |
|---|---|---|---|
| Material Properties | PPFA-6A | requirements* | ASTM Method |
| Hysteresis (%) | 81 | ≥75 | ASTM D3574 |
| Tensile strength (kg/cm²) | 15.1 ± 1 | ≥11.5 | ASTM D3574 |
| Elongation (%) | 299 ± 20 | ≥225 | ASTM D3574 |
| Tear C strength (kg/cm) | 8.64 ± 0.29 | ≥7.5 | ASTM D624 |
| DIN abrasion (m³) | 32 ± 23 | N/A | ASTM D5963-22 |
| Compression (%) | 20 ± 2.4 | ≤22 | ASTM D395 |
| Hardness (Asker C) | 50 ± 3 | 22-65 | ASTM D2240 |
| Rebound (%) | 42 ± 2.0 | ≥28 | ASTM D7121 |
| Density (cc) | 234 ± 3 | N/A | N/A |

*Specific for the footwear industry

### Thermal Characterization of PPFA-6A

### Equations

$$Equation 1 : Calculaion of {M}_{w} . z = functionality of polyol$$

$$Mw = \frac{z * 56.106 ( g / mol )}{OH value [ \frac{mg KOH}{g} ]}$$

$$Equation 2 : Calculation of specific gravity$$

$$ρ = \frac{mass}{volume}$$

$$Example 3 : Loading and unloading calculation using the non - uniform$$

$$trapezoid rule .$$

$${\int }_{a}^{b} f ( x ) d x \approx {\sum }_{c = 1}^{N} \frac{f ( {x}_{c - 1} ) + f ( {x}_{c} )}{2} Δ {x}_{c}$$

$$Equation 4 : Percent energy dissipation calculation . n = 1$$

$$Energy retention \% = \frac{u n l o a d i n g}{l o a d i n g} * 100$$

$$Equation 5 : Interchain spacing calculation using Bragg ’ s law$$

$$n λ = 2 d * sin ( θ )$$

$$Equation 6 : Percent biodegradation calculation and biodegradation$$

$$relative to cellulose .$$

$$\% biodegradation = \frac{\begin{matrix}{CO}_{2} production ( g ) sample - \\ {CO}_{2} production ( g ) compost only\end{matrix}}{\begin{matrix}sample mass ( g ) \times \% carbon \\ content of sample \times {( \% carbon content {CO}_{2} )}^{- 1}\end{matrix}}$$

$$\% biodegradation relative to cellulose = \frac{\% biodegradation}{{max}_{cellulose} * \% biodegradation} \times 100$$

### Example 2. Rapidly Biodegradable Bio-Based Thermoplastic Polyurethane (TPU)

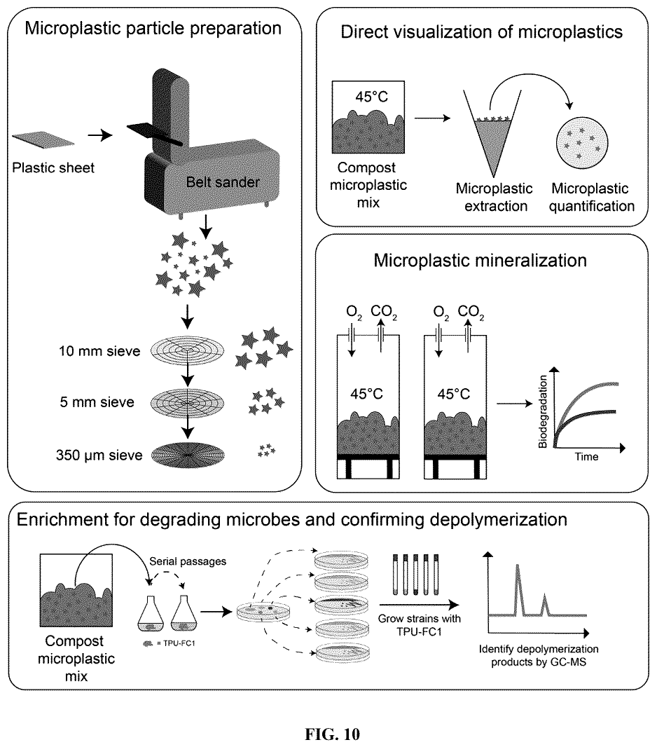

To test the hypothesis that microplastics generated from biodegradable polyester polyurethanes might rapidly degrade in the environment and hence not persist in the natural environment, a bio-based thermoplastic polyurethane (TPU-FC1) was physically grinded to generate microplastics, and multiple methods were used to confirm rapid biodegradation and disappearance of these microplastics in home composting conditions (FIG. 10). Extraction and quantification of microplastic particles indicated that TPU-FC1 particles completely degraded within 200 days, while similar particles derived from a non-biodegradable polymer, ethyl vinyl acetate (EVA), showed no reduction of particle number in the same time frame. Tracking CO₂ production via respirometry under identical composting conditions further confirmed biodegradation and mineralization of TPU-FC1 particles. To identify organisms responsible for this biodegradation, microbial enrichments were performed using TPU-FC1 as a sole carbon and energy source. From these enrichments, a bacterial strain belonging to the genus Rhodococcus was isolated that grows rapidly on TPU-FC1 alone. Feeding studies using this Rhodococcus strain indicated that it can depolymerize the TPU-FC1 material into the starting monomers, which can be quickly consumed by the Rhodococcus and other microorganisms.

Microplastics sample generation. Microplastics of various materials were generated by sanding using a benchtop belt sander with 80 grit sandpaper. Ethylene Vinyl Acetate (EVA) material was purchased as 12″×12″×0.375″ solid sheets from Curbell Plastics (https://www.curbellplastics.com). Thermoplastic polyurethane materials (TPU-FC1) were prepared using methods as described previously (see, e.g., (a) Rajput et al., J. Appl. Polym. Sci., 2022, 139: e53062; (b) Rajput et al., Molecules, 2022, 27:4885), wherein a linear aliphatic polyester-polyol (composed solely of a bio-derived aliphatic diol and two bio-derived aliphatic diacids) was reacted with a linear aliphatic diisocyanate. To prevent cross contamination between different materials, different sanding belts were used for each material. Materials were repeatedly submerged in liquid nitrogen to minimize heating and melting during the grinding procedure. Sanded microplastics were further size selected using a sieve stack and microplastics smaller than 5 mm and larger than 350 μm were retained for further experiments.

Respirometry experiments. Biodegradation of TPU microplastics was performed under controlled composting conditions according to the ASTM 5338-15 standard, monitoring CO₂ evolution, except for the use of home compost temperature of 45° C. instead of thermophilic temperatures to enhance relevance to non-industrial biodegradation conditions. Cellulose served as the positive control; ethylene-vinyl acetate (EVA) and compost only samples served as negative and blank controls, respectively. The experiment was stopped after 200 days of incubation, once the mineralization plateau was reached for most samples. Fresh compost was collected from Roger's Community Garden composting site at the University of California San Diego and filtered with a 1 cm sieve. 20 g of sample microplastics material and 240 g of fresh compost were thoroughly mixed and samples were incubated in a respirometer (Echo Instruments). Sample chambers were maintained at 45° C. and at ~58% relative humidity for the duration of experiment. Sample chambers were opened biweekly to mix compost and add water as needed. Percent biodegradation and biodegradation relative to cellulose was calculated by the following formula:

$$Equation 1$$

$$\% theoretical biodegradation = \frac{\begin{matrix}{CO}_{2} production ( g ) sample - \\ {CO}_{2} production ( g ) compost only\end{matrix}}{\begin{matrix}sample mass ( g ) \times \% carbon content of \\ sample \times {( \% carbon content {CO}_{2} )}^{- 1}\end{matrix}}$$

Microplastics extraction and quantification. Samples of compost to be extracted for microplastics were first dried in open glass beakers in a drying oven for at least 24 h before extraction. Extraction of microplastics was performed using a previously described protocol with minor variations. Briefly, 0.5 g of dried compost sample was sonicated (50% amplitude, 2×30 s) in distilled water and the resulting slurry was passed through several metal mesh sieves. Retained solids on the 0.5 mm and 0.35 mm mesh filters were transferred to a separatory funnel using a solution of saturated CaCl₂)(density=1.55 g/cm³). After vigorous swirling, the solids were allowed to separate based on density for 2 h at room temperature (RT). Approximately 75% of the bottom phase was drained and the remaining top layer containing microplastics was vacuum filtered onto a GF/A filter in a glass filtering apparatus. The filter containing microplastics was transferred to a glass petri dish with 30 ml of Nile Red staining solution (0.2% (w/v) Tween 20 with 4 μg/ml Nile Red) and gently mixed for 15 mins. Stained particles were then vacuum filtered onto a GF/A filter and illuminated with a Blue LED transilluminator and photographed with a Canon DSLR camera. Fluorescent microplastic particles on filters were quantified with ImageJ.

Media and growth conditions. Minimal defined media for enrichments and growth of various strains on TPU-FC1 was Brunner medium 457 (https://bacmedia.dsmz.de/medium/457). For isolation of various strains, either Luria-Bertani (LB) or Reasoner's 2A media (R2A) was used as a rich media. For solid media, 15 g/L of agar was added to the appropriate liquid media. TPU materials were sanded and sieved into a fine powder as described above and autoclaved dry in borosilicate glass flasks for all microbial growth experiments. Microbial growth was quantified by OD₆₀₀ using a spectrophotometer.

Enrichment and identification of TPU utilizing bacteria from compost. Samples of compost (~0.5 g) were combined with 5 ml of sterile PBS and shaken for 1 h at RT. An aliquot of this slurry was inoculated into 50 ml of Brunner minimal media (https://bacmedia.dsmz.de/medium/457) containing shredded 1% (w/v) TPU-FC1 as a sole carbon and energy source. Cultures were maintained at RT (~22° C.) with shaking. Enrichment cultures were passaged once a week by 100-fold dilutions into fresh media containing TPU-FC1 and this passaging procedure was repeated five times. After the fifth passage, aliquots of the culture were diluted and plated onto LB or R2A solid media and plates were incubated at RT. Colonies of interest were restreaked three times for strain purification and subsequently grown in either LB or R2A broth as needed. Isolated strains were re-screened for their ability to catabolize TPU-FC1 as a sole carbon and energy source in minimal media as described above.

Strains of interest were grown in R2A or LB liquid as needed and genomic DNA was extracted using a Zymo Research Soil and Tissue Genomic DNA purification kit following manufacturer guidelines. For phylogenetic strain identification, the 16S rRNA gene was PCR amplified from purified genomic DNA using the universal prokaryotic 16S rRNA primer set (27F=AGAGTTTGATCMTGGCTCAG (SEQ ID NO:1), 1492R=GGTTACCTTGTTACGACTT (SEQ ID NO:2)) using Q5 polymerase (New England Biosciences). PCR products were purified using the Promega SV Gel PCR purification kit and sent to Primordium labs for DNA sequencing. Sequences were queried by BLAST against the NCBI 16S rRNA database for phylogenetic identification.

Identification of depolymerization products by isolated bacteria. Isolates of interest were grown with TPU-FC1 as the sole carbon source as described above. At indicated timepoints, 1 mL of culture was removed and centrifuged to remove growing cells. The cell free supernatant was filtered through a 0.2 μm (PES) filter and stored at −20° C. until further analysis. Samples were speed vacuumed at 45° C. for 200 mins to evaporate the media. 5 μL 1M NaOH and 50 μL of internal standard (1 μL/mL diethyl succinate in ethyl acetate) were added. Samples were extracted three times with 100 uL ethyl acetate, which was then blown off with nitrogen gas. 50 μL of ethyl acetate, 2 μL MilliQ water, and 20 μL chloroform were added to each sample. 25 μL was silylated with 25 μL MSTFA and reacted for 20 mins. The GCMS was run using an HP-5 MS column. Samples were injected at 2 mL/min at a split of 10:1. The inlet temperature was 250° C. The oven was at 50° C. for 5.35 mins, then ramped to 120° C. at 10° C./min, then ramped to 280° C. at 50° C./min and held for 10 mins.

Imaging of biodegraded samples with scanning electron microscopy. Samples of interest were fixed for imaging by using a formaldehyde fixation protocol similar to previous work with slight modification. Samples of interest were immersed in phosphate buffer containing 4% formalin and incubated for 2 h at RT for fixation. Fixation solution was removed and samples were washed once with an equal volume of phosphate buffer and then sequentially exposed to an ethanol gradient (50, 65, 80, 95%) for sample dehydration. Samples were then dried and attached to aluminum stubs using carbon tape, after which an Emitech K575X Sputter Coater was used to deposit an iridium layer and excess coating was removed with compressed air prior to imaging. All samples were imaged at high vacuum using an FEI Quanta FEG 250 scanning electron microscope, at magnifications ranging from 100× to 8,000× magnification and visually inspected for structural modifications and the presence of microbial biofilms.

### Comparative Biodegradation of Microplastics

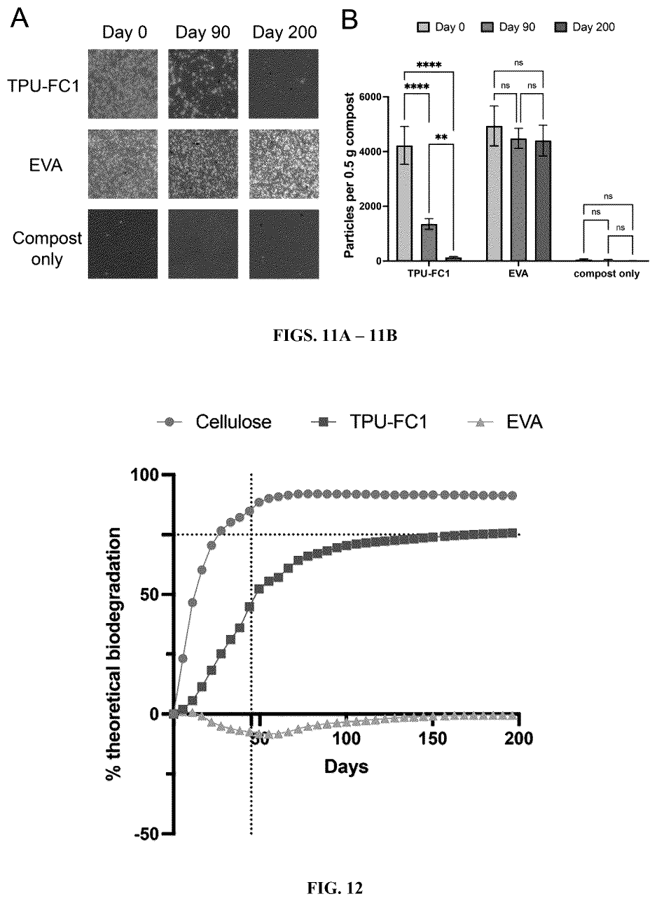

Microplastic particles generated from a bio-based polyester thermoplastic polyurethane (TPU-FC1), and from a petroleum-based thermoplastic ethyl vinyl acetate (EVA), were mixed with freshly collected compost in a defined 1:12 mass ratio and incubated in glass dishes at 45° C. Samples of the compost containing the microplastics were removed at 0, 90, and 200 days, and a differential density-based extraction procedure was performed to separate microplastic particles from the compost matrix. Microplastic particles, visualized by fluorescent staining with Nile Red, were abundant at the day zero time point in both plastic-containing samples, while few particles were observed in the compost control, as expected (FIG. 11A). It is important to note that though the blank sample has significantly fewer microplastic particles than the plastic-containing samples across all time points, the number observed was non-zero (52±29 on Day 0), consistent with findings of microplastics in nearly all environments. Examination of samples after 90 days of aerobic composting showed a 68% decrease in the number of particles for TPU-FC1, from 4221±694 to 1352±196 particles per half gram of compost (FIG. 11B). In contrast, the amount of EVA particles remaining after 90 days were not significantly different from the initial time point. After 200 days of aerobic composting, particle counts of microplastics in the TPU-FC1 sample dropped to 135±34 particles per half gram of compost, a 97% overall reduction from the starting count. In contrast, particle counts of the EVA microplastics, a non-biodegradable polymer, remained unchanged at the 200-day time point (FIG. 11B).

Extraction and direct visualization of microplastics indicated that microplastics were successfully generated, and particles above the 350 μm mesh size threshold were accurately extracted and quantified. The loss of TPU-FC1 microplastic particles is indicative of biodegradation and that microplastics generated from this material are transient and not persistent, unlike the persistence of EVA microplastics that is consistent with EVA not being biodegradable. While this extraction and visualization procedure can only visualize particles within a particular size range (>350 μm), it is expected that smaller particles would degrade at similar or perhaps faster rates given their larger surface area to volume ratio, with the fate of the carbon in those degraded microplastics being biochemically turned into biomass and CO₂ through mineralization.

### Tracking Biodegradation of TPU-FC1 Microplastics by Respirometry

To verify the biodegradation of these materials as microplastic particles and their predicted fate due to complete mineralization, a parallel set of samples with identical microplastics and compost were incubated at 45° C. in respirometry chambers designed to track CO₂ evolution under aerobic conditions consistent with the ASTM 5338-15 standard method (FIG. 1). Additional compost only and cellulose samples were also included as internal controls to monitor background CO₂ evolution and bioactivity of compost on a control substrate, respectively. As shown in FIG. 12, the cellulose positive control reached 75% CO₂ evolution within 45 days, indicating that the compost inoculum was sufficiently active as required by the ASTM 5338 standard. As expected for a non-biodegradable material, EVA microplastic particles showed no CO₂ evolution over the course of the 200-day experiment. Instead, negative biodegradation values were calculated as a consequence of subtraction of the blank compost's CO₂ evolution, indicating that the EVA either absorbs CO₂ from the metabolically active compost or the EVA microplastics kill the metabolic activity of the compost's microbiome. In close agreement with the extraction and visualization particle count data, the bio-based TPU-FC1 transient microplastics displayed significant biodegradation, reaching 76% CO₂ evolution at the 200-day time point. Thus, respirometry confirms the biodegradability of the bio-based TPU-FC1 material and demonstrates that one outcome of that biodegradation is the conversion of the carbon from the microplastics into CO₂.

### Isolation and Characterization of Bacteria Capable of Biodegrading TPU-FC1 Material

To confirm the alternative fate of TPU-FC1 as biomass, to identify microbial species capable of degrading the bio-based TPU-FC1 material, and to identify intermediate depolymerization products, microbial enrichment experiments were performed. Minimal media containing shredded TPU-FC1 as the sole carbon source, was inoculated with samples of compost that showed active biodegradation activity. Cultures were diluted 100-fold every week for five weeks and dilutions plated onto either LB or R2A solid agar plates. Colonies were picked based on unique morphological characteristics and restreaked multiple times for clonal isolation. Axenic isolates from the 5-week time point, were screened for their ability to utilize TPU-FC1 as a sole carbon source for growth as monitored by optical density, and confirmed strains were identified by 16S rRNA sequencing. A previous culture collection derived from enrichments using various biodegradable polyurethane foams was also screened for strains capable of using TPU-FC1 as a sole carbon source.

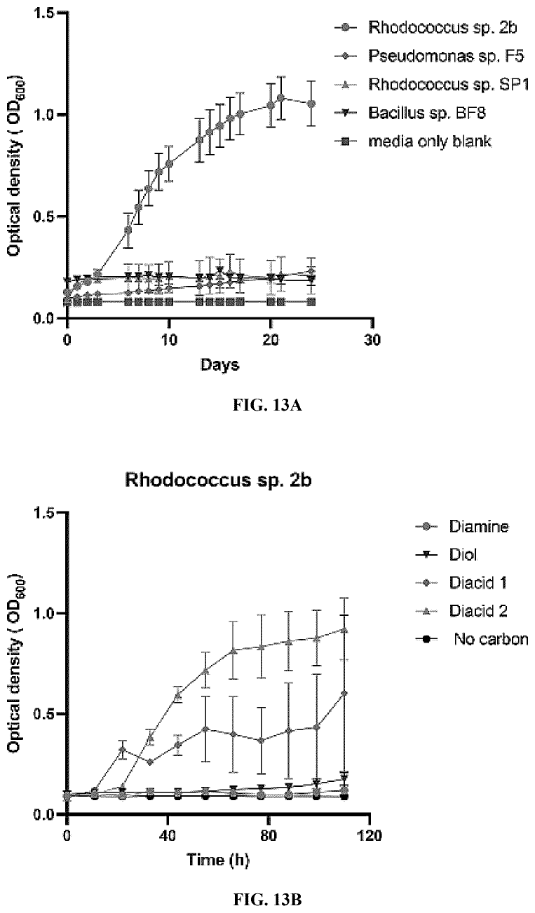

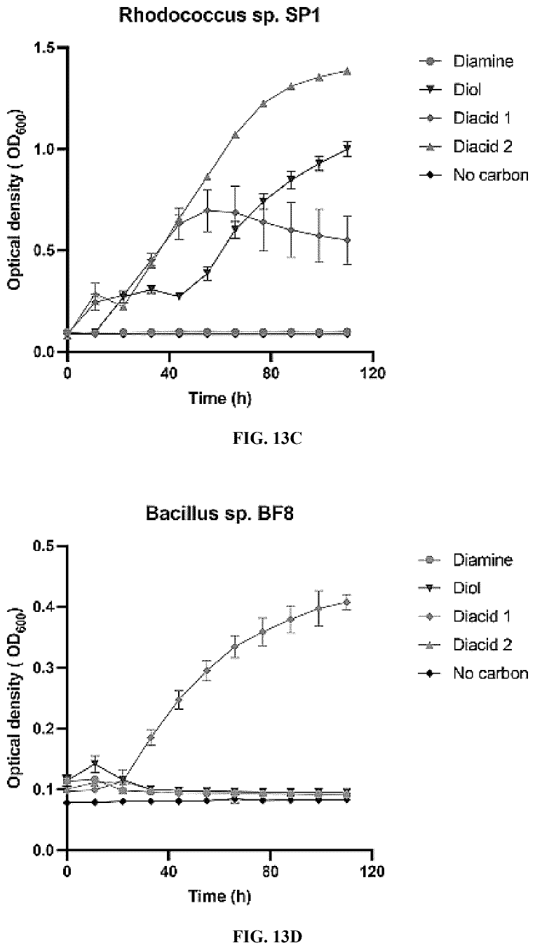

Two novel bacterial strains capable of utilizing TPU-FC1 as a sole carbon source were isolated from this set of enrichment experiments (Table 6, FIG. 13A). The best performing strain, designated 2b, was identified as a member of the Rhodococcus genus based on 16S rRNA sequence. Another strain, BF8, isolated in these enrichments was identified as a member of the genus Bacillus. From our previous terrestrial culture collection, two strains, Rhodococcus sp. SP1 and Pseudomonas sp. F5, also were noted to demonstrate some ability to catabolize TPU-FC1 under these experimental conditions (FIG. 13A). Bacteria belonging to the genus Rhodococcus, Pseudomonas, and Bacillus have been previously demonstrated to be involved with degradation of polyurethane. Their relative ubiquity in soil and other terrestrial environments with high biodegradation activities strongly suggests that TPU-FC1 would likely biodegrade in other environments besides compost.

Based on the monomer composition of TPU-FC1, generated from two diacids, one diol, and a linear aliphatic diisocyanate that is predicted to be released as a diamine through the biodegradation process, these isolated strains were assayed for their ability to use each monomer component as a sole carbon source in minimal media. Growth with either of TPU-FC1's diacids as sole carbon sources was relatively robust across all three strains. While Rhodococcus sp. 2b grew well on TPU-FC1 as a sole carbon source, it grew relatively modestly on the various monomers except for diacid 2 (FIG. 13B). In contrast, while growth of Rhodococcus sp. SP1 on the TPU-FC1 polymer was relatively modest (FIG. 13A), growth on both diacids and diol components was relatively robust compared to the other strains (FIG. 13C). These observations indicate that some strains may be more capable of cleaving TPU-FC1 into monomers, while others are more adept at scavenging the released monomers, supporting the notion that a community of organisms, rather than a single organism, enables efficient biodegradation in natural environments. Growth with the aliphatic diamine as a sole carbon source was nearly undetectable across all strains, though this could indicate that the diamine is not the correct product of biodegradation of the isocyanate moiety. Based on the robust growth characteristics of Rhodococcus sp. 2b on TPU-FC1, it was selected for further investigation of possible depolymerization products.

TABLE 6
Strains capable of catabolizing TPU-FC1

| | Closest phylogenetic match based on 16S rRNA |
|---|---|
| Strain | sequence (% nucleotide ID) |
| 2b | Rhodococcus fascians strain CF17 (99.5%) |
| SP1 | Rhodococcus qingshengii JCM 15477 (100%) |
| F5 | Pseudomonas aeruginosa DSM 50071 (100%) |
| BF8 | Bacillus altitudinis 41KF2b (100%) |

Identification of Depolymerization Products from TPU-FC1

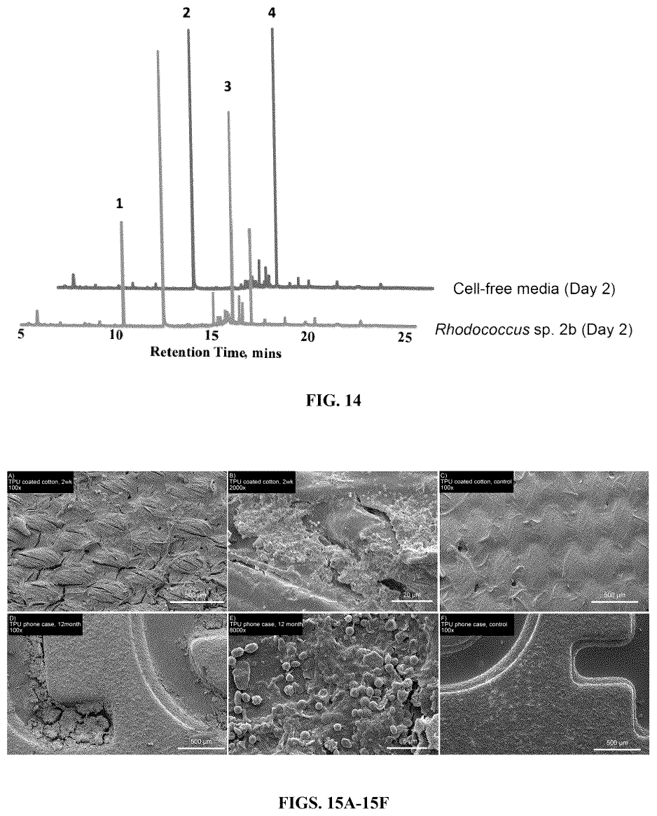

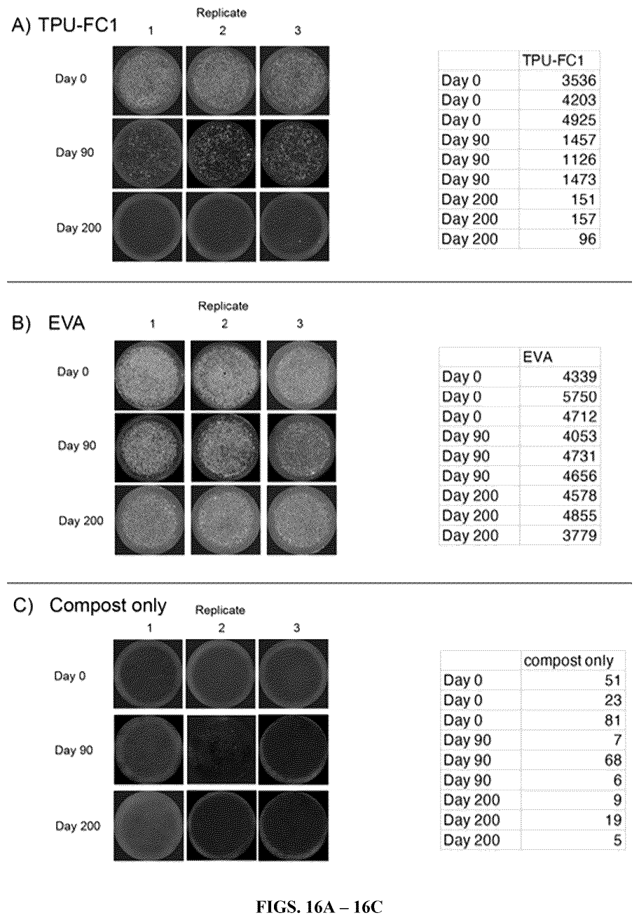

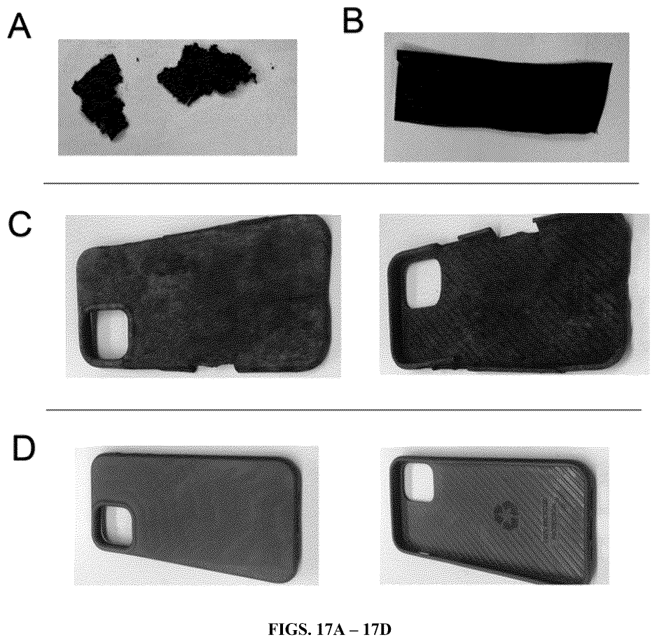

Given the robust growth of Rhodococcus sp. 2b using TPU-FC1 as a sole carbon source, further analysis of culture supernatants were performed to identify intermediate depolymerization products. Culture supernatants taken after 5 days of growth did not show the presence of any predicted monomers, in contrast to the detectable presence of monomers in a cell-free control sample of minimal media with TPU-FC1. This indicated that the Rhodococcus efficiently consumes released monomers and that an earlier time point was required to capture intermediate depolymerization products. GC-MS analysis of Rhodococcus sp. 2b supernatants taken after only two days of growth on TPU-FC1 as a sole carbon source showed significant accumulation of the diol monomer (Peak 1) and a TPU oligomer (Peak 3) in the culture supernatant, neither of which were present in cell-free control supernatant after two days of incubation (FIG. 14). Based on mass spectral data, the oligomer was predicted to contain a single urethane bond linking an aliphatic diamine to a linear diacid. The release and accumulation of these monomers indicates that Rhodococcus sp. 2b can depolymerize the supplied TPU-FC1 material. The lack of signals for diacid components in the TPU-FC1 formulation can be explained by this strain's ability to utilize these compounds as carbon sources (FIG. 13B). Furthermore, the accumulation of diol agrees with this strain's reduced ability to grow with the diol compound as a sole carbon source.

These results are consistent with depolymerization of the TPU-FC1 polymer and enzymatic cleavage of urethane and/or ester bonds found therein. While the newly isolated Rhodococcus sp. 2b strain is unable to completely catabolize the complete suite of monomers derived from this polymer as sole carbon sources, it is expected that other members of a given microbial community in the environment could catabolize the remaining monomeric and/or oligomeric components. Interestingly the TPU oligomer noted in the culture supernatant after two days was no longer detected at later time points, especially at higher cell densities. Given the presence of a urethane bond in the oligomer it is suspected that a urethane bond cleaving enzyme produced by Rhodococcus sp. 2b cleaves this bond to further catabolize the remaining compound. Previous work with other polyester-polyurethane degrading bacteria has indicated that depolymerization can occur in a stepwise fashion with ester bonds being initially hydrolyzed followed by urethane bonds. Furthermore, a urethane-bond cleaving enzyme found in Rhodococcus equi TB-60 was found to be inducible by the presence of amide bond containing compounds.

### Potential Product Applications of Biobased TPU Materials

Given the conclusion that the bio-based TPU-FC1 is fully biodegradable, possible product applications for this material were explored. Whether biodegradation of these products occurs in a manner similar to the generated microplastics was also investigated. Softer TPU's have a well-documented application in fabric coating for the purpose of water-proofing and/or sealing. TPU materials can also be injection molded to form plastic products, such as phone cases. To test the biodegradation of these TPUs in a plausible real-world application, TPU-FC-coated cotton fabrics and an injection molded phone case using a similar TPU formulation that uses the same polyol but an aromatic isocyanate in place of TPU-FC1's aliphatic isocyanate were generated. These materials were incubated in compost under identical conditions as the microplastics assays described above. As shown in FIGS. 17A-17D, degradation of these various materials was evident at the macro scale compared to their respective non-composted controls. The coated fabrics (FIGS. 17A-17B) biodegraded rapidly, leaving behind fabric which fragmented easily upon retrieval from compost after only two weeks in compost (FIG. 17B). After a year of compost incubation, the injection molded phone case became brittle and showed signs of discoloration, biofilm development, cracking, and structural degradation (FIG. 17D) compared to the control phone case (FIG. 17C).

Scanning electron microscopy further confirmed the biodegradation of these products. While the control TPU-coated fabrics that were not composted show the presence of the TPU coating masking the underlying fibrous cotton material (FIG. 15C), the TPU-coated fabrics composted for two weeks showed clear loss of the TPU coating, revealing the underlying fabric (FIG. 15A). The coating that remained also showed significant cracking and degradation, along with the accumulation of microbial biofilms (FIG. 15B). Similar results were noted for the injection molded phone case, which showed similar signs of cracking and fissure formation (FIG. 15D) along the surface of the material after 12 months in compost that are not present on the surface of the non-composted sample (FIG. 15F). As with the coated fabrics, microbial biofilms were observed on the surface of the TPU material (FIG. 15E).

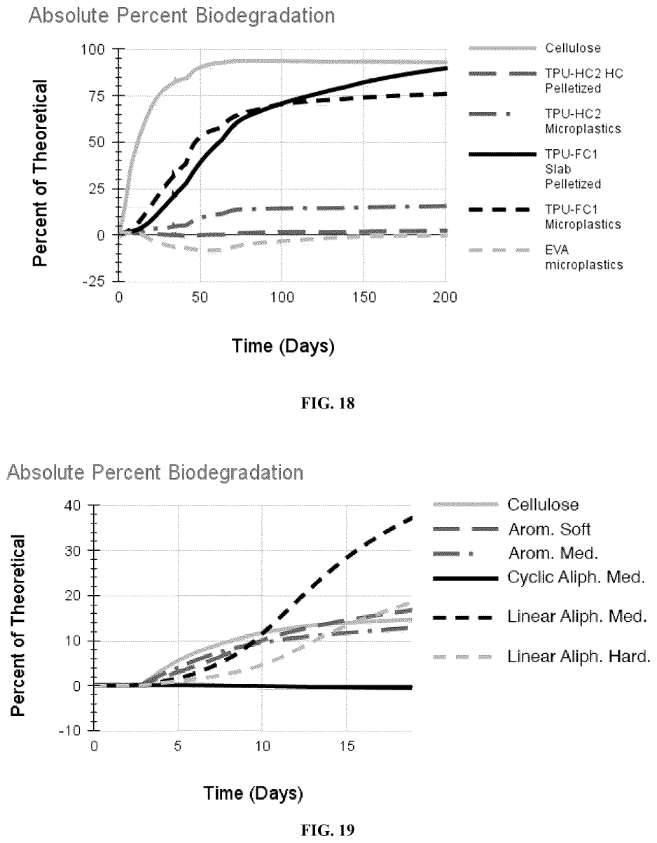

To understand how the nature of the isocyanate impacts the rate of biodegradation, a second set of TPUs (TPU-HC2) which uses the same polyol as TPU-FC1 but uses an aromatic isocyanate in place of the linear aliphatic isocyanate present in TPU-FC1 were generated. These two TPUs were then either pelletized or ground into microplastics as described above and underwent respirometry analysis in a head-to-head comparison to investigate their relative biodegradation rates (FIG. 18). Whether the TPUs were pelletized or in the form of microplastics, the conclusion was clear that the aliphatic isocyanate-containing TPU-FC1 biodegraded far quicker than the TPU-HC2. Fragmentation into microplastics does have some impact on biodegradation rates, with the TPU-HC2 microplastics showing some (~16%) biodegradation while the TPU-HC2 pellets showed negligible (~2%) biodegradation, as is expected purely based on surface area to volume ratios, but this difference cannot account for the major difference in degradation between the two TPU types. Thus, it was shown that the structural nature of the isocyanate moiety in the TPU can have an extreme impact on the rate of biodegradation of the material, with aliphatic isocyanates clearly enabling true rapid biodegradation.

Based on these results, the diversity of isocyanates tested as well as the final hardness of the TPU material were expanded to better understand the impact of the chemical characteristics of the isocyanate or the hardness of the product on the rate of biodegradation. In a rapid biodegradation test of approximately 20 days, it was observed that the linear aliphatic TPU with medium hardness (85 Shore A) biodegraded approximately 40%, which was nearly four times as fast as the cellulose control. Under these same conditions, the same TPU formulated to have a higher hardness (94 Shore A) biodegraded as fast as cellulose. Consistent with the observation that higher hardness results in slower biodegradation rates, the soft aromatic TPU degrades faster than the medium hardness aromatic TPU. As above, when comparing across equal hardness (85 Shore A) but differing isocyanates, the linear isocyanate TPU biodegrades nearly four times faster than the aromatic isocyanate TPU. Interestingly, the cyclic aliphatic isocyanate TPU does not biodegrade at all in this time frame.

### Conclusion

In this work, particle count and respirometry experiments demonstrated that microplastic particles from a bio-based thermoplastic polyurethane can rapidly biodegrade and therefore are transiently present in the environment. In contrast, microplastic particles from a widely used commercial thermoplastic, ethyl vinyl acetate, persists in the environment and showed no significant signs of biodegradation over the course of this experiment. Bacteria capable of utilizing TPU-FC1 as a carbon source were isolated and depolymerization of the material was confirmed by the early accumulation of monomers derived from the original polymer, which are metabolized by microbes in short order. Finally, it was demonstrated that prototype products made from these materials biodegrade under home compost conditions. The generation of microplastics is an unavoidable consequence of plastic usage and mitigating the persistence of these particles by adoption of biodegradable material alternatives is a viable option for a future green circular economy. This work demonstrates that the rate of biodegradation of linear aliphatic polyurethanes is significantly faster than those containing aromatic or cyclic aliphatic moieties.

### Example 3. Comparison of PU with Varying Percentages of 2,5-Furandicarboxylic Acid (FDCA)

Materials. 2,5-Furandicarboxylic acid (98+%) supplied from Shandong Ench. Azelaic acid (98%) was purchased from Acros Organics, 1,3-propanediol (PDO)(98%), was purchased from Susterra, and dibutyltin dilaurate (DBDTL) catalyst (95%) was purchased from Sigma Aldrich, and 1,6-hexamthylene diisocyanate (98%) was obtained from Sigma-Aldrich. Sodium nitrite (98%) was supplied from Fisher Chemical and hydrochloric acid (37%) was supplied from Lab Alley. The determination of hydroxyl and acid value titrations were performed according to ASTM 1899 and D664, respectively. The reagents used for the titrations were p-toluenesulfonyl isocyanate (96%) and 1.0 M tetrabutylammonium hydroxide in methanol, supplied by Sigma Aldrich. Solvents used for titrations and GPC were high performance liquid chromatography grade dimethylformamide, tetrahydrofuran, acetonitrile, toluene, 2-propanol, reagent grade 1-octanol, and potassium hydroxide supplied by Fisher Chemical.

Nuclear Magnetic Resonance Spectroscopy (NMR). ¹H NMR and ¹³C NMR spectra were performed on JEOL 400 MHz in chloroform-d and DMSO-d₆ for polyester-polyols and thermoplastic polyurethanes respectively.

Fourier-Transform Infrared Spectroscopy. Fourier transform infrared spectroscopy (FTIR) analysis was performed using a PerkinElmer spectrum X instrument, which was fitted with a ZnSe 1 mm ATR cell. The spectra were recorded after 16 scans taken at a 1.0 cm⁻¹.

Scanning Electron Microscopy (SEM). Thermoplastic polyurethane samples were imaged under high vacuum using an Phenom G6 Pro SEM cesium hexaboride source scanning electron microscope at 5 kV under back-scattered detection.

Universal Testing Machine. The universal testing machine (UTM) AGS-X 20KN was used to carry out tensile testing at a rate of 100 mm/min in accordance with ASTM D368.

Hardness. Hardness was measured using an ASTM D2240 standard to estimate the Shore A hardness of the TPU samples.

### Preparation of Polyester-Polyols

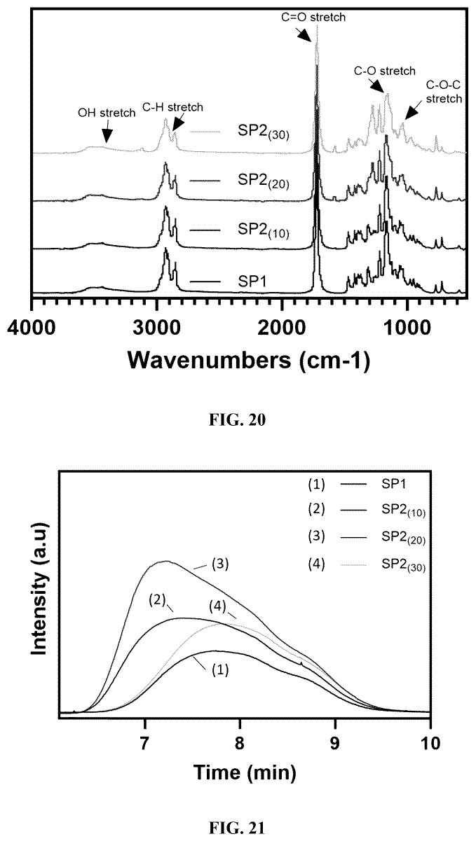

A series of polyester-polyols were prepared with molecular weights averaging 1425 +90 g/mol and with an increasing FDCA aromatic content in the polyol from 0 to 30 mol %. These polyester-polyols were characterized by 1H, 13C, GPC (FIG. 20), and FTIR (FIG. 21).

General Procedure for Synthesis of Polyester-Polyols. The synthesis of the various polyesters were conducted in a two-neck round-bottom flask equipped with a Dean-stark apparatus and a condenser using various ratios of azelaic acid (AzA) to 2,5-furandicarboxylic acid (FDCA) with 1,3-propanediol (PDO) at a total polyester-polyol mass of 500 g with FDCA containing between 0-30% with molar mass by hydroxyl number within 1425±77 g/mol (see Table 7). First, FDCA was solubilized in PDO under reflux and then AzA was added, and the temperature was increased to 170° C. under a nitrogen stream where rapid release of water, the byproduct, was observed over 4-6 hours. Dibutyltin dilaurate (DBTDL) was added when approximately 80% of all water was collected via the Dean-stark apparatus to ensure reaction completion. Progress of the polyester-polyol formation was monitored through acid and hydroxyl titrations until a desired AN of >2.0 mg KOH/g was achieved.

Naming the synthesized polyester-polyols. Synthesized polyols (SP) were denoted as aliphatic (1) or aromatic (2) and the resultant aromatic content from 10 to 30 mol ratio (2₍ₓₓ₎): SP1, SP2₍₁₀₎, SP2₍₂₀₎, and SP2₍₃₀₎.

TABLE 7
Polyester-Polyol: molar amounts of precursors

| polyol | AzA (mol) | FDCA (mol) | PDO (mol) | catalyst (mol %) |
|---|---|---|---|---|
| SP1 | 2.07 | — | 2.44 | 0.021 |
| SP2₍₁₀₎ | 1.90 | 0.21 | 2.45 | 0.021 |
| SP2₍₂₀₎ | 1.71 | 0.43 | 2.47 | 0.021 |
| SP2₍₃₀₎ | 1.51 | 0.65 | 2.53 | 0.021 |

SP1. (a) ¹H NMR (400 MHz, CDCl₃) δ 4.24, 4.23, 4.21, 4.15, 4.13, 4.12, 3.70, 3.68, 3.67, 2.31, 2.29, 2.27, 1.99, 1.97, 1.95, 1.94, 1.92, 1.89, 1.88, 1.86, 1.85, 1.83, 1.64, 1.62, 1.60, 1.58, 1.57, 1.30. (b) ¹³C NMR (100 MHz, CDCl₃) δ 174.37, 173.86, 61.31, 60.98, 59.33, 34.36, 34.30, 31.89, 29.07, 29.03, 29.00, 28.97, 28.13, 25.00, 24.96, 24.93.

SP2 (10). (a) ¹H NMR (400 MHz, CDCl₃) δ 7.21, 7.20, 4.42, 4.41, 4.39, 4.24, 4.22, 4.21, 4.14, 4.13, 4.11, 3.69, 3.68, 3.66, 2.30, 2.28, 2.26, 2.12, 2.11, 2.09, 2.08, 2.06, 1.98, 1.96, 1.95, 1.93, 1.92, 1.89, 1.87, 1.86, 1.84, 1.83, 1.63, 1.61, 1.60, 1.58, 1.56, 1.30. (b) ¹³C NMR (100 MHz, CDCl₃) δ 174.35, 173.84, 158.01, 146.83, 118.68, 62.34, 61.30, 60.96, 60.76, 59.31, 34.35, 34.29, 34.26, 31.87, 29.06, 29.01, 28.99, 28.96, 28.93, 28.11, 24.99, 24.95, 24.91.

SP2 (20). (a) ¹H NMR (400 MHz, CDCl₃) δ 7.21, 7.20, 4.42, 4.41, 4.39, 4.24, 4.22, 4.21, 4.14, 4.13, 4.11, 3.69, 3.68, 3.66, 2.30, 2.28, 2.26, 2.12, 2.11, 2.09, 2.08, 2.06, 1.98, 1.96, 1.95, 1.93, 1.92, 1.89, 1.87, 1.86, 1.84, 1.83, 1.63, 1.61, 1.59, 1.58, 1.56, 1.30. (b) ¹³C NMR (100 MHz, CDCl₃) δ 174.35, 173.85, 158.00, 146.83, 118.68, 62.67, 62.34, 61.30, 60.96, 60.75, 59.30, 59.11, 34.34, 34.28, 34.25, 31.87, 31.75, 29.05, 29.01, 28.98, 28.95, 28.10, 24.98, 24.94, 24.92.

SP2₍₃₀₎. (a) ¹H NMR (400 MHz, CDCl₃) δ 7.21, 7.20, 4.43, 4.41, 4.40, 4.24, 4.23, 4.21, 4.15, 4.13, 4.12, 3.70, 3.68, 3.67, 2.30, 2.29, 2.27, 2.13, 2.11, 2.10, 2.08, 2.07, 1.99, 1.97, 1.95, 1.94, 1.92, 1.88, 1.86, 1.85, 1.83, 1.82, 1.63, 1.62, 1.60, 1.58, 1.56, 1.30. (b) ¹³C NMR (100 MHz, CDCl₃) δ 174.37, 173.86, 158.01, 146.84, 118.69, 62.68, 62.35, 61.31, 60.97, 60.77, 59.33, 59.14, 34.36, 34.30, 34.27, 31.88, 31.76, 29.06, 29.02, 28.97, 28.11, 25.00, 24.96.

Certain properties of the polyester-polyols are described in Table 8.

TABLE 8
Properties of the polyester-polyols

| | acid value | OH value | MW by OH | MW by GPC | polydispersity |
|---|---|---|---|---|---|
| polyol | (mg KOH/g) | (mg KOH/g) | (g/mol) | (g/mol) | index (PDI) |
| SP1 | 1.7 | 82.8 | 1355 | 3.77 × 10³ ± 1.6% | 1.353 ± 3.1% |
| SP2₍₁₀₎ | 1.6 | 76.7 | 1463 | 5.49 × 10³ ± 1.0% | 1.758 ± 2.7% |
| SP2₍₂₀₎ | 0.2 | 74 | 1516 | 1.03 × 10⁴ ± 0.7% | 1.830 ± 1.5% |
| SP2₍₃₀₎ | 0.2 | 82.1 | 1367 | 3.96 × 10³ ± 1.3% | 1.402 ± 2.3% |

### Preparation of the Thermoplastic Polyurethanes (TPUs)

Thermoplastic polyurethanes were prepared using the above-described polyols with 1,3-propanediol (as a chain extender) and 1,6-hexamethylene diisocyanate (6-HDI), and catalyzed using dibutyltin dilaurate (DBTDL) to achieve 20% and 40% hard segments as calculated by the following equation:

$$Hard segment ( \% ) = \frac{{g}_{( chain extender )} + {g}_{( diisocyanate )}}{{g}_{( total mass )}} * 100$$

wherein g_{(chain extender)} is the mass of chain extender (e.g., PDO), g_{(diisocyanate)} is the mass of diisocyanate (e.g., 6-HDI), and g_{(total mass)} is the total mass of the thermoplastic polyurethane. The diisocyanate index was kept at 1.1 for all reactions. The synthesis of the polyester polyurethanes is depicted in Scheme 1. The terminal alcohol functional group on the polyol was converted into a urethane functional group by reacting with 6-HDI, resulting in 8 TPUs. The final products were characterized by 1H, 13C, FTIR, and GPC.

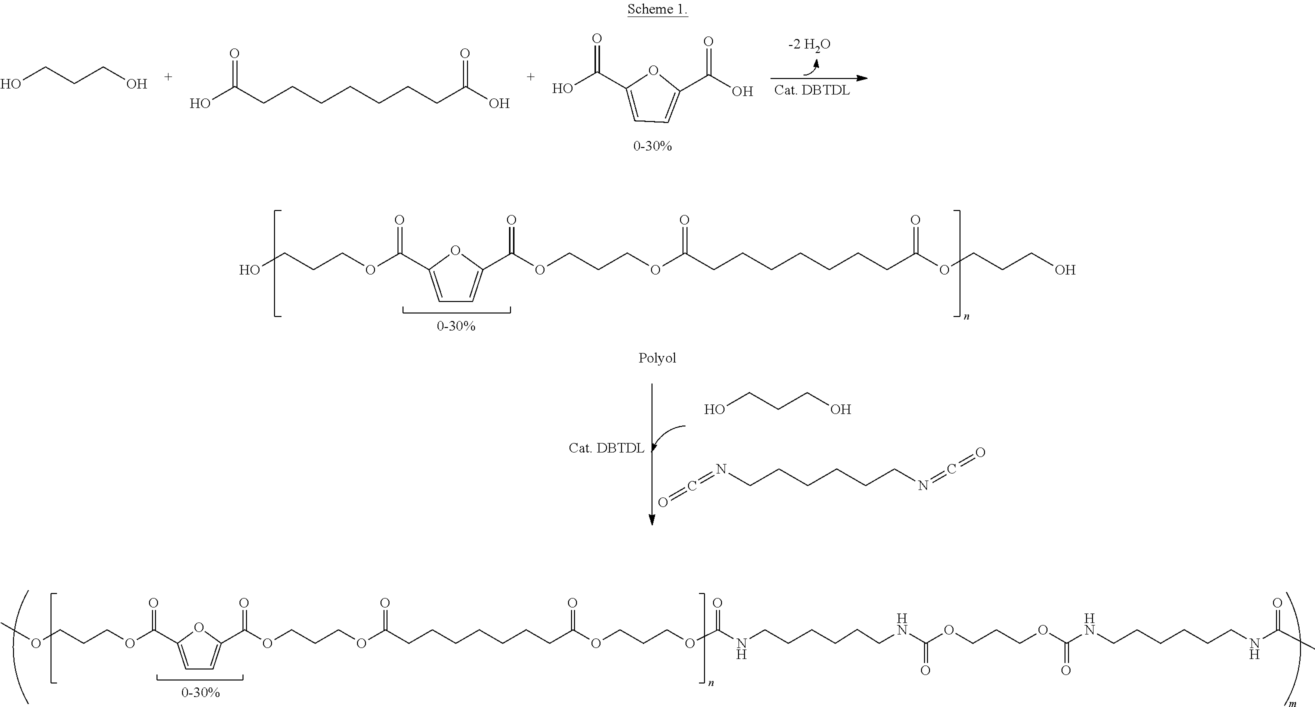

General Procedure for Synthesis of Thermoplastic Polyurethanes. The four above-described polyester-polyols and PDO (utilized as a chain extender) were dried at 80° C. vacuum for 48 h prior to use. Eight thermoplastic polyurethanes were synthesized with one of two targeted hard segments (Table 9). To achieve this, polyester-polyol, PDO, and catalyst DBTDL were added to a 300 g plastic cup and were mixed in a speed mixer for 50 seconds at 2000 rpm. To this homogenized mixture, room temperature 1,6-hexamethylene diisocyanate (6-HDI) was added, followed by speed mixing for another 50 seconds at 2000 rpm. The mixture was then cured at 80° C. for 48 hours and then cured at room temperature for 7 days before material property testing.

TABLE 9
TPUs: molar amounts of precursors

| | | polyol | PDO | catalyst | 6-HDI |
|---|---|---|---|---|---|
| | polyol | (mol) | (mol) | (mol %) | (mol) |
| SP16A-20 | SP1 | 0.01476 | 0.0090 | 0.02 | 0.02614 |
| SP16A-40 | SP1 | 0.01107 | 0.0305 | 0.04 | 0.04573 |
| SP2₍₁₀₎6A-20 | SP2₍₁₀₎ | 0.01367 | 0.0095 | 0.02 | 0.02549 |
| SP2₍₁₀₎6A-40 | SP2₍₁₀₎ | 0.01025 | 0.0315 | 0.02 | 0.04593 |
| SP2₍₂₀₎6A-20 | SP2₍₂₀₎ | 0.01319 | 0.0098 | 0.02 | 0.02529 |
| SP2₍₂₀₎6A-40 | SP2₍₂₀₎ | 0.00989 | 0.0314 | 0.02 | 0.04542 |
| SP2₍₃₀₎6A-20 | SP2₍₃₀₎ | 0.01463 | 0.0088 | 0.02 | 0.02578 |
| SP2₍₃₀₎6A-40 | SP2₍₃₀₎ | 0.01098 | 0.03100 | 0.02 | 0.04617 |

Naming the synthesized thermoplastic polyurethanes (TPUs). TPUs were named according to (a) the type of polyol used: SP1 (aliphatic) or SP2 (aromatic); (b) the diisocyanate used (e.g., 6A=1,6-hexamethylene diisocyanate); and (c) the hard segment percentage (20 or 40): SP16A-20, SP2₍₁₀₎6A-20, SP2₍₂₀₎6A-20, SP2₍₃₀₎6A-20, SP16A-40, SP2₍₁₀₎6A-40, SP2₍₂₀₎6A-40, and SP2 (30) 6A-40.

SP16A-20. (a) ¹H NMR (400 MHz, DMSO-d₆) δ 7.06, 4.06, 4.04, 4.03, 3.98, 3.96, 3.95, 3.38, 2.93, 2.92, 2.28, 2.26, 2.24, 1.88, 1.86, 1.84, 1.52, 1.51, 1.49, 1.47, 1.45, 1.35, 1.23. (b) ¹³C NMR (100 MHz, DMSO-d₆) δ 172.87, 60.59, 33.43, 29.41, 28.36, 28.31, 27.60, 24.40.

SP2 (10) 6A-20. (a) ¹H NMR (400 MHz, DMSO-d₆) δ 7.40, 7.36, 7.05, 4.35, 4.34, 4.32, 4.13, 4.12, 4.10, 4.05, 4.04, 4.02, 3.98, 3.96, 3.94, 3.36, 2.93, 2.91, 2.27, 2.25, 2.23, 2.03, 2.02, 2.00, 1.98, 1.97, 1.89, 1.87, 1.85, 1.84, 1.82, 1.52, 1.50, 1.48, 1.47, 1.45, 1.37, 1.35, 1.33, 1.22, 1.20. (b) ¹³C NMR (100 MHz, DMSO-d₆) δ 173.30, 157.82, 156.62, 146.67, 119.57, 62.81, 60.88, 33.89, 30.54, 29.89, 29.15, 28.85, 28.62, 28.02, 26.47, 24.87.

SP2 (20) 6A-20. (a) ¹H NMR (400 MHz, DMSO-d₆) δ 7.40, 7.36, 7.06, 4.35, 4.34, 4.32, 4.13, 4.12, 4.05, 4.04, 4.02, 3.97, 3.96, 3.94, 2.93, 2.91, 2.27, 2.25, 2.23, 2.03, 2.01, 2.00, 1.98, 1.97, 1.87, 1.85, 1.84, 1.82, 1.80, 1.52, 1.50, 1.48, 1.37, 1.35, 1.33, 1.22, 1.20. (b) ¹³C NMR (100 MHz, DMSO-d₆) δ 173.31, 157.83, 156.63, 146.66, 119.58, 62.81, 60.88, 33.89, 30.55, 29.89, 29.15, 28.84, 28.79, 28.01, 26.47, 24.87.

SP2 (30) 6A-20. (a) ¹H NMR (400 MHz, DMSO-d₆) δ 7.40, 7.36, 7.06, 4.35, 4.34, 4.32, 4.13, 4.12, 4.10, 4.05, 4.04, 4.02, 3.98, 3.96, 3.94, 2.93, 2.91, 2.26, 2.25, 2.23, 2.03, 2.02, 2.00, 1.98, 1.97, 1.87, 1.85, 1.84, 1.82, 1.80, 1.50, 1.48, 1.46, 1.46, 1.44, 1.37, 1.35, 1.33, 1.22, 1.20. (b) ¹³C NMR (100 MHz, DMSO-d₆) & 173.33, 157.83, 156.63, 146.66, 119.58, 62.81, 61.06, 33.89, 30.54, 29.89, 29.15, 28.79, 28.62, 28.07, 26.47, 24.87.

SP16A-40. (a) ¹H NMR (400 MHz, DMSO-d₆) δ 7.07, 4.06, 4.04, 4.02, 3.97, 3.96, 3.94, 2.93, 2.92, 2.27, 2.25, 2.23, 1.87, 1.86, 1.84, 1.52, 1.50, 1.49, 1.45, 1.35, 1.23. (b) ¹³C NMR (100 MHz, DMSO-d₆) δ 173.05, 156.41, 60.79, 33.63, 29.61, 28.87, 28.57, 28.51, 27.80, 26.19, 24.60.

SP2 (10) 6A-40. (a) ¹H NMR (400 MHz, DMSO-d₆) δ 7.41, 7.37, 7.05, 4.36, 4.34, 4.33, 4.14, 4.12, 4.11, 4.06, 4.04, 4.03, 3.98, 3.96, 3.95, 2.94, 2.92, 2.27, 2.25, 2.24, 2.04, 2.02, 2.01, 1.99, 1.97, 1.89, 1.88, 1.86, 1.84, 1.83, 1.53, 1.51, 1.49, 1.47, 1.45, 1.37, 1.36, 1.34, 1.21. (b) 13C NMR (100 MHz, DMSO-d₆) δ 172.85, 157.36, 156.22, 146.20, 119.11, 62.34, 60.42, 33.42, 30.07, 29.42, 28.67, 28.37, 28.15, 27.60, 26.00, 24.40.

SP2 (20) 6A-40. (a) ¹H NMR (400 MHz, DMSO-d₆) δ 7.41, 7.37, 7.07, 4.35, 4.34, 4.32, 4.14, 4.12, 4.10, 4.06, 4.04, 4.02, 3.97, 3.96, 3.94, 2.27, 2.25, 2.23, 2.03, 2.02, 2.00, 1.99, 1.97, 1.89, 1.87, 1.86, 1.84, 1.82, 1.52, 1.50, 1.48, 1.47, 1.37, 1.35, 1.34, 1.23. (b) ¹³C NMR (100 MHz, DMSO-d₆) δ 172.82, 157.33, 156.18, 146.17, 119.11, 62.32, 60.39, 33.40, 30.05, 29.40, 28.65, 28.35, 28.29, 27.58, 25.98, 24.38.

SP2₍₃₀₎6A-40. (a) ¹H NMR (400 MHz, DMSO-d₆) δ 7.40, 7.37, 7.06, 4.35, 4.34, 4.32, 4.13, 4.12, 4.10, 4.05, 4.04, 3.97, 3.96, 3.94, 2.93, 2.92, 2.27, 2.25, 2.23, 2.02, 2.00, 1.98, 1.87, 1.85, 1.84, 1.82, 1.80, 1.50, 1.48, 1.48, 1.46, 1.37, 1.34, 1.21. (b) ¹³C NMR (100 MHz, DMSO-d₆) δ 172.86, 157.35, 156.21, 146.15, 119.12, 62.33, 60.59, 33.42, 30.06, 29.41, 28.67, 28.36, 28.31, 27.59, 25.99, 24.40.

### Structural Characterization of Thermoplastic Polyurethanes

When TPU samples were subjected to ¹H and ¹³C NMR spectroscopy, the major characteristic peak of the urethane appeared at ~6.95 ppm for the —NH proton and ~157 ppm for the carbonyl carbon of the —NHCOO group, signifying successful formation of the urethane linkage in all substrates. A further analysis into the characterization of TPUs utilizing FTIR was also conducted. The complete disappearance of the free isocyanate group (—NCO) peak at ~2250 cm⁻¹ indicated the formation and adequate curing of the TPUs. The peak at ~3350 cm⁻¹ indicated the —NH stretch of the hydrogen bonding urethane group, ~2950 cm⁻¹ is assigned to the —CH stretching vibration of alkane groups, 1720 cm⁻¹ and 1170 cm⁻¹ indicated the formation of ester linkages by C═O stretch and C—O—C stretch respectively. Further analysis of the hard and soft segmented TPUs was achieved by observing the carbonyl stretch at 1600-1850 cm⁻¹ and calculating the hydrogen bond association (HBA) which is usually described as the degree of microphase separation in TPUs:

$$Hydrogen Bonding Association ( HBA , \% ) = \frac{Area C = {O}_{( 1680 )}}{Area C = {O}_{( 1680 )} + Area C = {O}_{( 1720 )}} * 100$$

wherein Area C═O₍₁₆₈₀₎=area of the C═O stretch peak at 1680 cm⁻¹, which represents hydrogen bonded stretching of the carbonyl groups of TPU, and Area C═O (1720)=area of the C═O stretch peak at 1720 cm⁻¹, which represents non-hydrogen bonding stretching of the carbonyl groups of TPU. HBA peaks are calculated via a curve-fitting procedure based on Gaussian distribution of the area under each peak of the FTIR spectra from 1650-1750 cm⁻¹. An HBA increase of 18.8% to 20.1-20.8% was observed when introducing FDCA in the polyester-polyol with TPUs at 20% hard segments. However, no noticeable changes of hydrogen bonding was observed between samples with 10-30 mol % FDCA in the polyester-polyol-based TPUs. This same trend was observed with TPUs poured at 40% hard segment with the aliphatic TPU showing the lowest HBA of 29.3% and the aromatic-aliphatic TPUs having a HBA of 32.2-35.6% This increase in HBA from 20% to 40% hard segments is expected as the amount of urethane groups formed is much greater as the hard segment concentration is increased. This difference in hydrogen bonding may be attributed to the presence of the aromatic ring which provides a rigid and planar structure which can facilitate stronger and more orderly packing within the polymer matrix. This increased rigidity and planarity can enhance the likelihood of hydrogen bonding interactions between urethane groups and carbonyl groups of the hard and soft segments. Additionally, the presence of aromatic rings can provide localized electronic effects which can further promote hydrogen bond formation and lead to increased hydrogen bonding association with aromatic-aliphatic based TPUs compared to that of the aliphatic TPUs. As more strongly hydrogen-bonded urethanes groups are formed (i.e., a larger HBA), the incompatibility of the hard and soft segments increases, resulting in a larger increase in phase separation which in turn affects mechanical and thermal properties. Increasing FDCA in the polyol appears to result in a higher degree of phase separation due to the rigidity and planarity of the aromatic ring.

SEM. The surface morphology of the TPUs was visualized using scanning electron microscopy (SEM). TPUs with 20% or 40% hardness displayed similar surface morphologies. TPU SP16A-20, regardless of percentage hardness, showed a relatively smooth and homogeneous surface which is indicative of well-dispersed hard and soft segments. With the addition of aromatic moieties with SP2₍₁₀₎6A-20, no major changes in morphology were observed. However, as the aromatic content increased to 20% with SP2₍₂₀₎6A-20, surface morphology became more heterogenous with the appearance of minor phase separation. At 30% aromatic content, the heterogenous morphology was more pronounced and voids were observed in SP2₍₃₀₎6A-20, indicating an increase in incompatibility between the hard and soft segments due to the steric hindrance and decreased flexibility of the polymeric chains caused by the higher aromatic content. These observations align with the previous FTIR data, suggesting higher degrees of phase separation as the amount of FDCA moiety is increased in the polymers.

### Mechanical Property Analysis

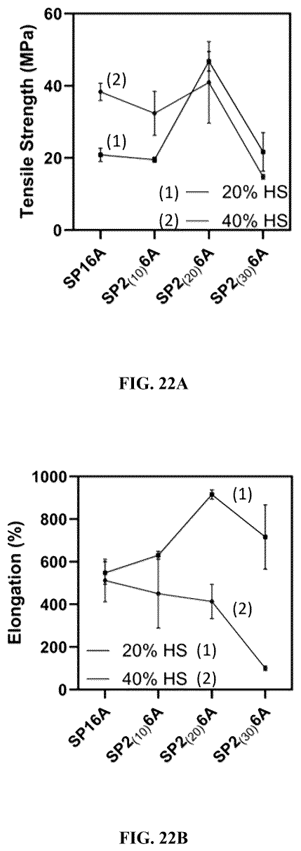

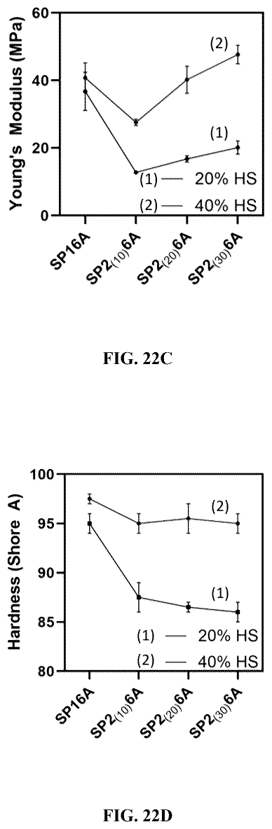

Tensile Strength, Elongation, Young's Modulus, Hardness. All eight TPUs were evaluated for tensile strength (MPa), elongation at break (%), Young's modulus (MPa), and hardness (Shore A)(FIG. 22A-FIG. 22D).

For TPUs with 20% hard segments, tensile strength remained relatively stable across the different aromatic content, with values of 20.9 MPa for SP16A-20, 19.5 MPa for SP2 (10) 6A-20, and 21.7 MPa for SP2 (30) 6A-20. However, at 40% hard segment, tensile strength decreased from 38.3 MPa for SP16A-40 to 32.4 MPa for SP2₍₁₀₎6A-40, and 14.8 MPa for SP2₍₃₀₎6A-40. Notably, TPUs with 20% aromatic content, particularly SP2 (20) 6A, exhibited higher tensile strengths of 46.8 MPa and 40.9 MPa at 20% and 40% hard segments, respectively.

Elongation at break for TPUs with a 20% hard segment increased from 548% to 716% with increasing aromatic content. However, elongation decreased from 512% to 101% at 40% hard segment as aromatic content increased. At a 20% molar ratio of FDCA, elongation improved further, reaching 915% and 413% for 20% and 40% hard segments, respectively.

Young's modulus showed similar trends for both hard segment levels: aliphatic TPUs initially had higher modulus values, which decreased with increasing aromatic content, indicating a softer material. As the aromatic content is increased, the Young's modulus also increased, highlighting that aromatic content can contribute to the hard segment domain and affect material stiffness.

Hardness values also followed similar trends regardless of TPUs at 20% or 40% hard segment domains. The hardest materials were the SP16A polymers (i.e., the aliphatic TPUs), with hardness upwards of 95 shore A. As aromatic content was introduced, the polymers softened from 95>87.5>86.5>86 shore A for 20% hard segment TPUs and 97.5>95>95.5>95 for 40% hard segment TPUs.

In summary, increasing aromatic content in TPUs with lower hard segment concentrations enhanced tensile strength and flexibility. In contrast, at higher hard segment concentrations, increased aromatic content reduced tensile strength and elongation due to phase separation and brittleness, while material properties at higher hard segment concentrations were more influenced by hard segment concentration with aromatic content playing a secondary role.

### Example 4. Comparison of Aliphatic and Aromatic Polyurethane Foams

Materials. FDCA (98+%) supplied from Shandong Ench Azelaic acid (98%) was purchased from Acros Organics, 1,3-propanediol (98%), was purchased from Susterra, and dibutyltin dilaurate (DBDTL) catalyst (95%) was purchased from Sigma Aldrich. PU additives (L-1507, Y, DBTDL, and A), were supplied from Momentive. 1,6-Hexamethylene diisocyanate (98%) was supplied by Alfa Aesar. Sodium nitrite (98%) was supplied from Fisher Chemical and hydrochloric acid (37%) was supplied from Lab Alley. The determination of hydroxyl and acid value titrations were performed according to ASTM 1899 and D664, respectively. The reagents used for the titrations were p-toluenesulfonyl isocyanate (96%) and 1.0 M tetrabutylammonium hydroxide in methanol, supplied by Sigma Aldrich. Solvents used for titrations were HPLC grade acetonitrile, toluene, 2-propanol, reagent grade 1-octanol, and potassium hydroxide supplied by Fisher Chemical. Soleic cupsole, referred to here as cupsole (see Bruckbauer et al., Macromolecules, 2024, 57 (6): 2879-2887) was supplied by Algenesis Materials. Commercial aliphatic polyol, referred to here as CP1, is supplied by Algenesis Materials.

Material Measurements. FTIR was carried out using a Perkin Elmer Spectrum X fitted with ZnSe 1 mm ATR cells. The resolution was 1.0 cm⁻¹ over 16 scans. Proton and carbon NMR was taken on a JOEL ECA 400 at ambient temperature. Foam samples were imaged under high vacuum using an FEI Quanta FEG 250 scanning electron microscope at 5 kV. X-ray diffraction (XRD) measurements were performed with XRD profiles from 10 to 90° of film samples (10 mm×5 mm×1 mm) were measured by using an X-ray diffractometer (Anton Paar XRDynamic 500) with Cu Kα radiation (2)=0.154 nm) running at 40 kV and 49 mA and the Bragg-Brentano (monochromator) beam geometry. DSC and TGA was performed on a TA instrument from −120 to 200° C. and 50 to 900° C. respectively with a temperature ramp of 10° C./min under nitrogen. GPC was carried out in a Malvern system with a Tosoh TSKgel SuperHZM-N+guard columns. The distribution of the polymers were relative to a polystyrene standard where THE served as the solvent and eluent with a flow rate of 0.35 ml/min. Mechanical testing was carried out as described in Bruckbauer et al., Macromolecules, 2024, 57 (6): 2879-2887.

Molecular weight from OH number was calculated using the following equation:

$$Mw = \frac{z * 56.106 ( g / mol )}{OH value [ \frac{mg KOH}{g} ]}$$

wherein z is functionality of polyol.

Renewable carbon content of the PU foam was calculated using the following equation:

$$Total Renewable Carbon ( \% ) = \frac{Number of renewable carbon atoms ( g )}{Total number of carbon atoms ( g )} * 100$$

Biodegradation Analysis. Biodegradation of PU foams were conducted in a controlled composting environment following the ASTM D5338-15 standard, with CO₂ evolution monitored. Substrates were generated into microplastics by a belt sander with 80 grit sandpaper. The substrate was submerged in liquid nitrogen to prevent thermal alteration during the grinding process (see Allemann et al., Scientific Reports, 2024, 14). Fresh compost was sourced from Roger's Community Garden compositing site at the University of California San Diego (32.97° N, 117.24° W). Each sample consisted of 20 g of material mixed thoroughly with 240 g of fresh compost and put into the respirometer. The sample chambers were maintained at home compositing conditions, 45° C. and approximately 58% relative humidity throughout the experiment. The experiment was stopped after 40 days of incubation and percent biodegradation relative to cellulose was determined according to the following equation:

$$\% biodegradation = \frac{\begin{matrix}{CO}_{2} production ( g ) sample - \\ {CO}_{2} production ( g ) compost only\end{matrix}}{\begin{matrix}sample mass ( g ) \times \% carbon content of \\ sample \times {( \% carbon content {CO}_{2} )}^{- 1}\end{matrix}}$$

$$\% biodegradation relative to cellulose = \frac{\% biodegradation}{{max}_{cellulose} * \% biodegradation} \times 100$$

### Preparation of Polyurethane Precursors

Synthesis of 1,7-heptamethylene diisocyanate (7HDI). A flow system was operated as described by Rajput et al. (Macromolecules, 2023, 56 (21): 8813-8822). Aqueous sodium nitrite was prepared by dissolving 37.95 g (0.55 mol) of NaNO₂ in 1042 mL DI water in an Erlenmeyer flask. A solution of aqueous azelaic dihydrazide and hydrochloric acid was prepared by dissolving 46.06 g (0.213 mol) of azelaic dihydrazide and 34.3 mL HCl in 800 mL of DI water. Pumps 1, 2, and 3, and 4 were operated at a rate of 6.5 mL per minute. After completion of the run, the solvent was removed on a rotary evaporator, and the crude material was purified via vacuum distillation at 110-115° C. to afford 27.2 g (0.15 mol) of 1,7-heptamethylene diisocyanate as a clear oil in a 70% yield. ¹H NMR (300 MHz, CDCl₃) δ 3.29 (t, J=6.7 Hz, 4H), 1.61 (m, 4H), 1.35 (m, 8H). 13C NMR (100 MHz, CDCl₃) δ 122.03, 43.03, 31.30, 28.88, 26.51.

Two polyester-polyols (SP2 and CP1) were used to make the polyurethane foams of this example. The protocol to prepare SP2 is described below. CP1 is a commercially available aliphatic polyester-polyol of the following structure:

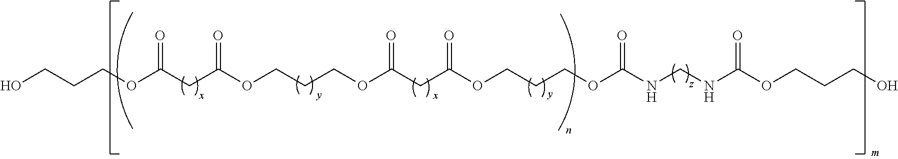

wherein x is 2-8, y is lor 2, z is 5 or 6, m varies depending on the compound molecular weight, and n is 1-6. Molecular weight of CP1 is shown in Table 10.

Synthesis of poly(propylene furanoate-azelate)(SP2). 67.09 g 2,5-furandicarboxylic acid (0.43 mol, 1.0 eq) and 186.67 g 1,3-propane diol (PDO)(2.46 mol, 5.7 eq) were combined in a 2-neck round bottom flask equipped with a magnetic stir bar. The flask was attached to a dean-stark apparatus with a cooled jacketed reflux condenser for monitoring water released from the polymerization reaction. The reaction temperature was increased to 150° C., stirred at 500 rpm under a constant nitrogen stream. Once a homogenous mixture was obtained, azelaic acid (323.61 g, 4.0 eq) was added and the temperature was further increased to 170° C. Typically, after 8 hours, 80% of the expected water biproduct, 77.37 g, was collected in the dean-stark apparatus. After 24 hours, 0.044 wt % (0.254 g) of catalytic dibutyltin dilaurate (DBTL) was added to the flask, and polycondensation was continued for typically 48-72 hours. Once the condensation reaction was completed, the polyol was submitted for acid and hydroxyl titrations to obtain acid (<1) and hydroxyl count, respectively, to ensure reaction completion. After the desired acid number was obtained, the polyol was put in a vacuum oven for 3 days at 90° C. to remove remaining water to afford SP2. ¹H NMR (400 MHz, DMSO-d₆) δ 7.40, 4.32, 4.12, 4.04, 3.50, 2.24, 2.00, 1.85, 1.69, 1.47, 1.22. ¹³C NMR (101 MHz, DMSO-d₆) δ 173.28, 157.62, 146.44,119.38, 62.98, 62.60, 61.38, 60.94, 60.85, 57.53, 57.37, 33.75, 31.83, 28.63, 28.57, 27.77, 24.70, 24.61.

### Characterization of the Polyols

The two polyols, SP2 and CP1, were characterized under nuclear magnetic resonance (NMR) spectroscopy, fourier-transform infrared (FTIR) spectroscopy, acid and hydroxyl titrations, and gel permeation chromatography (GPC) supporting structural confirmation of polyester-polyols with molecular weights of 1697 g/mol and 1705 g/mol by hydroxyl titrations for SP2 and CP1, respectively. The ester peak can be characterized by FTIR utilizing the carbonyl stretch and carbon-oxygen stretch at 8=1727 cm⁻¹ and 1151 cm⁻¹ for CP1 and δ-1720 cm⁻¹ and 1166 cm⁻¹ for SP2 which reveals the occurrence of polycondensation. For SP2, the NMR results exhibited formation of an ester peak at 172 ppm resulting from reaction completion and confirmed by acid titrations with an acid number less than 0.3 mg KOH/g. Furthermore, GPC resulted in a polydispersity index (PDI) of 1.80 for SP2 and 1.58 for CP1 with molecular weights of 5687 g/mol and 5128 g/mol respectfully. Data is summarized in Table 10.

TABLE 10
Molecular weight distribution of polyester-polyols

| | acid value | OH value | MW by OH | MW by GPC | polydispersity |
|---|---|---|---|---|---|
| polyol | (mg KOH/g) | (mg KOH/g) | (g/mol) | (g/mol) | index (PDI) |
| SP2 | 0.2 | 66.1 | 1697 | 5687 | 1.80 |
| CP1 | 0.6 | 65.8 | 1705 | 5128 | 1.58 |

### Preparation of Polyurethane Foam

Aromatic- and aliphatic-based polyols were formulated with varying aromatic- or aliphatic-diisocyanates, resulting in an array of flexible polyurethane foams using the general procedure described below. The polyurethane foams are described in Table 11.

General procedure to prepare polyurethane foam. Polyester-polyol (SP2 or CP1) was dried in a vacuum oven for 24 h to remove water before polymerization. Polyester-polyol, chain extender (PDO), surfactant (L-1507), water, blowing catalyst (A1), gelling catalysts (DBTDL) were added to a FLACKTEK™ plastic cup and mixed at 2000 RPM for 1 minute. The mixture was heated to 75° C. and then nucleated for 30 seconds with an overhead stirrer and heated to 75° C. for 5 minutes. Isocyanate was adjusted based off mass loss from nucleation and then added to the polyol mixture and mixed at 2350 RPM for 10 seconds, then poured into a 10 mm closed mold system that was heated to 55° C. Foams were demolded after 24 hours at 55° C. and tested for physical and thermal properties after 48 hours. For kinetic experiments, catalyst loadings were adjusted to 0.900 T12 and 0.400 Al for aliphatic diisocyanate-based formulations to mimic industrial manufacturing settings.

Naming convention for polyurethane foams. The foams were marked as SP26A, SP27A, SP244M, CP16A, and CP17A according to the type of polyols (SP-synthesized polyol, renewable; CP-commercial polyol, renewable), notation on whether the polyol was aliphatic (1) or aromatic (2), and the diisocyanate that was used (6A-1,6-hexamethylene diisocyanate (6HDI); 7A-1,7-heptamethylene diisocyanate, renewable (7HDI); 44M-methylenediphenyl diisocyanate (MDI)).

TABLE 11
Components in the polyurethane foams (parts
per 100 parts polyester-polyol)

| Compound | SP26A | SP27A | CP16A | CP17A | SP244M |
|---|---|---|---|---|---|
| SP2 | 100 | 100 | — | — | 100 |
| CP1 | — | — | 100 | 100 | — |
| PDO | 3.00 | 3.00 | 3.00 | 3.00 | 3.00 |
| Y | 1.00 | 1.00 | 1.00 | 1.00 | 1.00 |
| L | — | — | — | — | 0.200 |
| D27 | — | — | — | — | 0.100 |
| A1 | 0.100 | 0.125 | 0.100 | 0.125 | — |
| DBTDL | 0.200 | 0.250 | 0.200 | 0.250 | — |
| water | 1.00 | 1.00 | 1.00 | 1.00 | 0.900 |
| 6A | 26 | — | 26 | — | — |
| 7A | — | 31 | — | 27 | — |
| 44M | — | — | — | — | 40 |

SP2—poly(propylene furanoate-azelate); CP1—commercially available aliphatic polyester-polyol; PDO—1,3-propanediol; Y—surfactant; A1 and L—blowing catalyst; DBTDL—dibutyltin dilaurate catalyst; D27—gelling catalyst; 6A—1,6-hexamethylene diisocyanate; 7A—1,7-heptamethylene diisocyanate; 44M—methylenediphenyl diisocyanate.

SP2-based foams were synthesized with an FDCA-based aromatic polyol and aliphatic or aromatic diisocyanates while CP1-based foams were synthesized with an aliphatic polyol and aliphatic diisocyanates. Aromatic diisocyanates have been traditionally used in commercial production due to their high reactivity required for the formation of rigid and flexible polyurethane foam systems to achieve appreciable demold times. To ensure industrially relevant formulations with aliphatic diisocyanates, reaction kinetics were studied using industrial standards of cream time, rise time, tack-free time, and pinch time. Catalyst loadings were subjected to current petroleum manufacturing processing with cream times under 5 seconds as a baseline standard.

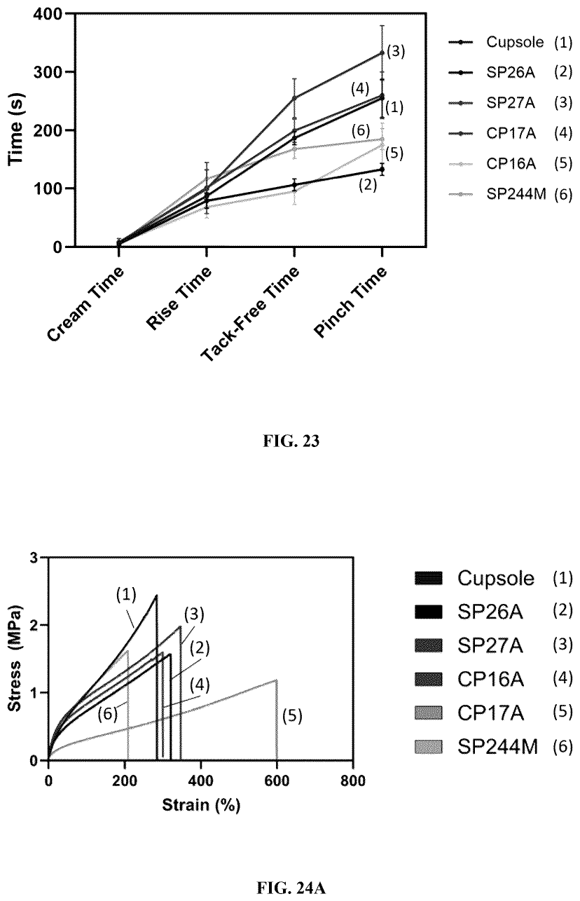

It was observed that both aliphatic and aromatic diisocyanates exhibited industrially relevant demold times based on gelling and blowing catalyst loadings, with pinch times under 360 seconds for each foam (FIG. 23). Aromatic diisocyanate-based foams showed demold times of 255±17 seconds for commercial cupsole and 185±18 seconds for SP244M. Faster demold times were recorded for 6HDI-based foams, with 133±10 seconds for SP26A and 175±38 seconds for CP16A. However, increasing the methylene unit in aliphatic diisocyanates resulted in longer pinch times, 333±47 seconds for SP27A and 260±40 seconds for CP17A. These results suggest that as the chain length of linear aliphatic diisocyanates increases, their reactivity decreases.

These results further suggest that 7HDI foams (SP27A and CP17A) would have longer final pinch times compared to their 6HDI counterparts. This difference in reaction times could also influence the material properties as it could affect the degree of phase separation which is crucial for desirable properties for polyurethanes. In short, these variations in pinch times appear to be primarily due to two factors: the reactivity of the diisocyanates and the amount of catalyst loading. Reactivity generally follows the following trend: aromatic diisocyanates >short-chain aliphatic diisocyanates >long-chain aliphatic diisocyanates. Despite these differences, it was still possible to produce industrially processable foams using typical catalyst loadings of gelling and blowing agents in PU flexible foam systems.

### Structure and Morphology of the Polyurethane Foams

Each foam underwent structural characterization using scanning electron microscopy (SEM), x-ray diffraction (XRD), and FTIR spectroscopy.

The FTIR spectra of the various polyurethane foams confirmed the polyurethane structure with the typical N—H stretch at ~3335 cm⁻¹ attributed to the urethane and urea groups. The carbonyl band was located at ~1725 cm⁻¹ contributing to the formation of the urethane and urea carbonyl groups. Other characteristic bands included the alkane C—H stretch at ~2926 cm⁻¹, N—H bending at ~1526 cm⁻¹, and the presence of the stretching vibration of C—O and C—O—C at ~1150 cm⁻¹ and ~1065 cm⁻¹, respectively. The absence of the isocyanate peak at ~2270 cm⁻¹ indicated a complete reaction of each foam.

SEM enabled the determination of cell size of the foams as the polyol and diisocyanate components changed between MDI, 6HDI, and 7HDI. It was observed that utilizing an aromatic diisocyanate in the presence of either an aromatic polyol (SP2) or aliphatic polyol (CP1) resulted in the smallest cell size. When aromaticity was confined to the polyester-polyol, a slight increase in cell size was observed, and when no aromatic moieties were present, cells of 1 mm were observed. With the change of one methylene unit from six to seven when using 7HDI instead of 6HDI, we also observed a decrease in cell size. These results suggest that, under the same conditions, aromatic moieties can provide an increase in cell structure.

X-ray diffraction provided patterns with a broad peak at 2θ=21° corresponding to the amorphous region for polyurethanes. The intensity of the amorphous phase for the PU foams were as follows: SP244M>SP27A=SP26A >CP16A >Cupsole=CP17A. Notably, SP244M, which has a relatively higher degree of rigidity and planar conformation due to the influence of the aromatic polyol and aromatic diisocyanate, has the highest peak intensity, whereas CP17A, which is entirely composed of flexible, aliphatic chains, exhibits the lower peak intensity. This data suggests that as the intensity of the amorphous region increases, the material has a higher ordered structure within the amorphous region. These sharper signals indicate that the corresponding materials have higher crystallinity linked to a higher degree of phase segregation and/or chain organization.

### Properties and Application of the Polyurethane Foams

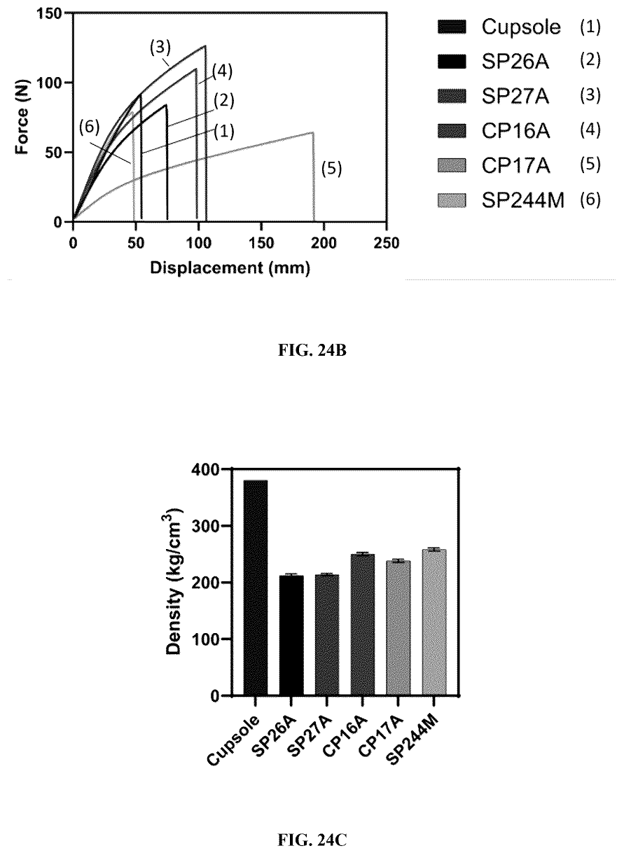

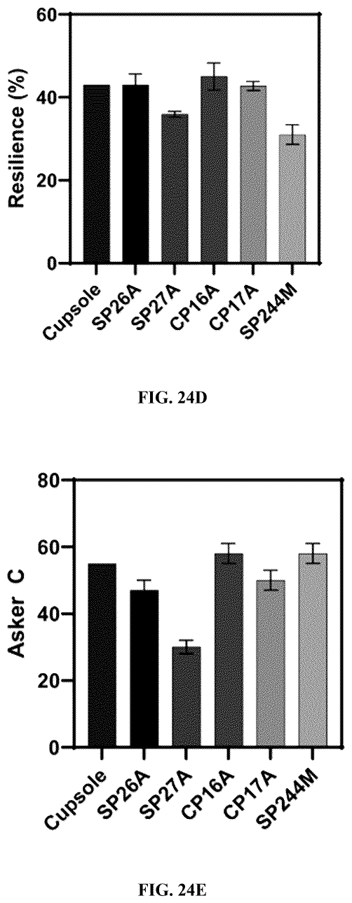

Property testing of the flexible PU foams SP26A, SP27A, SP244M, CP16A, and CP17A was investigated through various mechanical and thermal analysis. All flexible PU foams showed advantageous or appreciable mechanical and thermal properties for various applications such as the footwear or the mattress industry (FIGS. 24A-24E and Table 12).

TABLE 12
Mechanical and thermal properties of the PU foams

| material | | | | | | |
|---|---|---|---|---|---|---|
| properties | SP26A | SP27A | SP244M | CP16A | CP17A | cupsole* |
| tensile strength | 13.3 ± 1.4 | 8.2 ± 0.2 | 16.86 ± 0.7 | 16.7 ± 1.0 | 12.39 ± 0.99 | 24.7 |
| (kg/cm²) | | | | | | |
| elongation (%) | 288 ± 34 | 208 ± 9.1 | 218 ± 11 | 320 ± 32 | 325 ± 74 | 278 |
| tear c strength | 8.02 ± 0.2 | 5.83 ± 0.2 | 8.38 ± 0.4 | 10.3 ± 0.6 | 10.28 ± 0.60 | 9.81 |
| (kg/cm) | | | | | | |
| compression | — | — | 16.8 ± 1.8 | 12.8 ± 2.5 | — | 19 |
| (%) | | | | | | |
| hardness | 47 ± 3 | 30 ± 2 | 58 ± 3 | 52 ± 1.5 | 50 ± 3 | 55 |
| (Asker C) | | | | | | |
| rebound (%) | 43 ± 2.6 | 36 ± 0.7 | 31 ± 2.4 | 45 ± 0.4 | 43 ± 1.1 | 43 |
| density | 212 ± 3 | 214 ± 3 | 258 ± 3 | 238 ± 3 | 238 ± 3 | 380 |
| (kg/cm³) | | | | | | |
| glass transition | −42 | −44 | −29 | −48 | −46 | −36 |
| (° C.) | | | | | | |
| decomposition | 302 | 308 | 315 | 299 | 302 | 309 |
| temperature, | | | | | | |
| 5% (° C.) | | | | | | |
| renewable | 81 | 100 | 68 | 81 | 100 | unknown |
| content (%) | | | | | | |

*commercial cupsole foam

Measurable differences were observed between the even-numbered 6-carbon chain length (6HDI) and the odd-numbered 7-carbon chain length (7HDI) diisocyanates when reacted with aromatic polyester-polyols at the same target density. The most noteworthy change in properties was hardness resulting in a 40% softer material of SP27A compared to SP26A. As a result, decreases were observed in every mechanical property with the most noticeable changes in tensile strength from 13.3 to 8.2 MPa and elongation from 288% to 208% for SP26A and SP27A, respectively, as well as a decrease in rebound from 43% to 36%. Without being bound to theory, the reason for these noticeable changes in mechanical properties may be due to the orientation of the urethane groups resulting from reaction with 6HDI versus 7HDI. The difference in one methylene group in the aliphatic chain of the diisocyanate reagents may lead to hydrogen bonding differences (parallel, antiparallel, or a combination of both) with neighboring polymeric chains on the molecular level for the resultant polyurethanes. Notably, no major material property differences were observed when comparing aliphatic polyester-polyol, CP1, with 6HDI and 7HDI. The synthesis of CP17A resulted in a 4% softer material than that of CP16A with only a decrease in tensile strength to 12.4 from 16.7 MPa, while other mechanical properties such as rebound, elongation, and tear c strength remained the same. It may be that a secondary effect such as chain entanglement, much like in hydrogels or PU dispersions, may play a role in polymer properties in addition to the above-described odd-even carbon chain effect.

Thermal analysis was carried out using differential scanning calorimetry (DSC) and thermogravimetric analysis (TGA). Glass transition temperatures were observed between −48° C. to −29° C. PU foams formed using aromatic diisocyanates showed higher glass transition temperatures of −36° C. and −29° C. for cupsole and SP244M, respectively. SP244M incorporates aromatic moieties in both the polyol and diisocyanates precursors, resulting in the highest glass transition temperature. The estimation of the soft segment glass transition temperature was not possible due to the small thermal effects of this transition. TGA reported high thermal stability, i.e., above 295° C., for each PU foam.

Two trends in thermal decomposition were observed. First, PU foams with aromatic diisocyanates resulted in higher thermal stability which increased with the addition of aromatic polyester-polyol from 309° C. to 315° C. for cupsole to SP244M, respectively. Secondly, an average increase of 5° C. in thermal stability was observed in PU foams prepared from 7HDI compared to PU foams prepared from 6HDI.

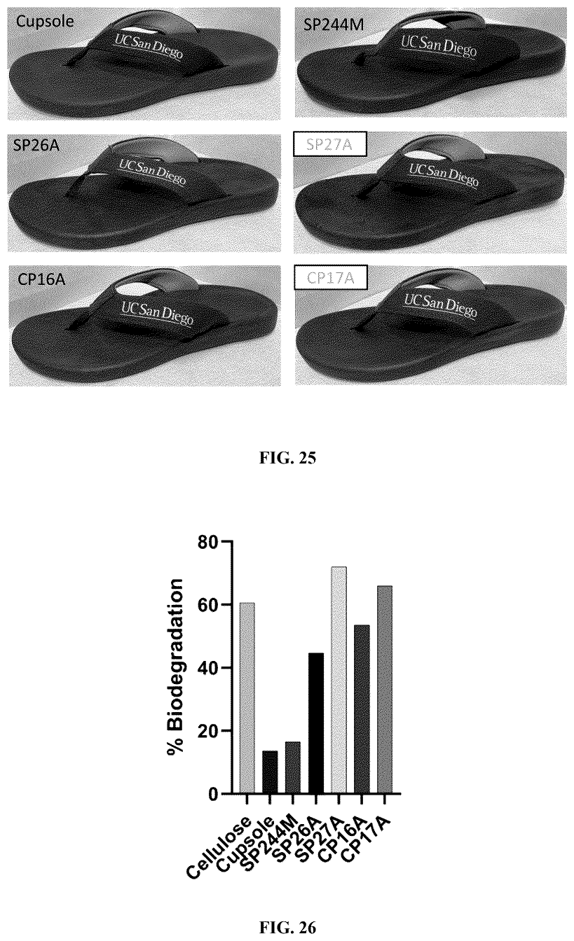

PU foams SP26A, SP27A, SP244M, CP16A, and CP17A were used in the production of flip flops are an example of a mechanically demanding plastic object that requires robust mechanical properties such as tensile strength and tear c strength while not compromising on compression or rebound properties to afford comfortable, yet durable products (FIG. 25).

### Biodegradation of the Polyurethane Foams

To demonstrate biodegradation of the PU foams as microplastic particles, these foams were subjected to composting conditions and incubated at 45° C. in respirometry chambers measuring CO₂ evolution under aerobic conditions according to ASTM 5338-15 standard methods. To ensure viability of the test, cellulose (positive control) and a compost-only chamber were used as internal controls for comparison of the degradation rate of the materials. The experiment was terminated after 40 days, and total biodegradation percentage for each sample was calculated using the following equation.

$$\% biodegradation = \frac{\begin{matrix}{CO}_{2} production ( g ) sample - \\ {CO}_{2} production ( g ) compost only\end{matrix}}{\begin{matrix}sample mass ( g ) \times \% carbon content of \\ sample \times {( \% carbon content {CO}_{2} )}^{- 1}\end{matrix}}$$

Results are shown in FIG. 26.

During the biodegradation process, it was observed that PU foams prepared from aromatic diisocyanate resulted in slower degradation rates: cupsole reached 14% and SP244M reached 17%, respectively. When the aromatic moiety was isolated to the polyol precursor, an increase in biodegradation rate to 45% and 72% for SP26A and SP27A, respectively, was observed, with the latter exceeding the biodegradation rate of cellulose. In the absence of aromatic moieties in the PU foam, the biodegradation rate reached 54% and 66% for CP16A and the fully renewable foam, CP17A, respectively. Without being bound to theory, this increase in biodegradation rate may be due to the aliphatic chains being more amenable to microbial metabolism as they are usually converted into alcohols and mineralized to CO₂ through common metabolic pathways, whereas aromatic structures are sterically hindered and require more energy for metabolism, resulting in a slower uptake by organisms and, as a result, a slower degradation rate. The increase in degradation rate between 6HDI- and 7HDI-based foams could be a result of their chain alignment based off the above-described odd-even carbon chain effect.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### Certain Embodiments

Embodiment 1. A biodegradable polyurethane comprising subunits from an aliphatic diisocyanate, a chain extender, and a polyester-polyol, wherein the polyester-polyol comprises subunits from 2,5-furandicarboxylic acid.

Embodiment 2. The biodegradable polyurethane of Embodiment 1, wherein the aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1, 12-diisocyanatododecane; isophorone diisocyanate; methylene dicyclohexyl diisocyanate; or a combination of two or more thereof.

Embodiment 3. The biodegradable polyurethane of Embodiment 1 or Embodiment 2, wherein the aliphatic diisocyanate comprises 1,3-trimethylene diisocyanate; 1,5-pentamethylene diisocyanate; 1,7-heptamethylene diisocyanate; or a combination of two or more thereof.

Embodiment 4. The biodegradable polyurethane of Embodiment 1 or Embodiment 2, wherein the aliphatic diisocyanate comprises 1,4-tetramethylene diisocyanate; 1,6-hexamethylene diisocyanate; 1,8-octamethylene diisocyanate; 1,12-diisocyanatododecane; or a combination of two or more thereof.

Embodiment 5. The biodegradable polyurethane of any one of Embodiments 1-4, wherein the aliphatic diisocyanate is derived from a photosynthetic source.

Embodiment 6. The biodegradable polyurethane of Embodiment 5, wherein the photosynthetic source comprises algae, plant(s), or a combination thereof.

Embodiment 7. The biodegradable polyurethane of any one of Embodiments 1-6, wherein the chain extender comprises 1,3-propanediol; 1,4-butanediol; 1,5-pentanediol; 1,6-hexanediol; or a combination of two or more thereof.

Embodiment 8. The biodegradable polyurethane of any one of Embodiments 1-7, wherein the chain extender comprises 1,3-propanediol.

Embodiment 9. The biodegradable polyurethane of any one of Embodiments 1-8, wherein the polyester-polyol further comprises subunits from one or more linear aliphatic dicarboxylic acids with at least 3 carbons and one or more C₂-C₆ diols.

Embodiment 10. The biodegradable polyurethane of Embodiment 9, wherein the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof.

Embodiment 11. The biodegradable polyurethane of Embodiment 9 or Embodiment 10, wherein the one or more linear aliphatic dicarboxylic acids comprise azelaic acid.

Embodiment 12. The biodegradable polyurethane of any one of Embodiments 9-11, wherein the one or more linear aliphatic dicarboxylic acids are derived from a photosynthetic source.

Embodiment 13. The biodegradable polyurethane of Embodiment 12, wherein the photosynthetic source comprises algae, plant(s), or a combination thereof.

Embodiment 14. The biodegradable polyurethane of any one of Embodiments 9-13, wherein subunits from 2,5-furandicarboxylic acid are present in an amount of 1 mol % to 30 mol % relative to subunits from total molar amount of all dicarboxylic acids used to prepare the polyester-polyol.

Embodiment 15. The biodegradable polyurethane of any one of Embodiments 9-14, wherein subunits from 2,5-furandicarboxylic acid are present in an amount of 10 mol % to 30 mol % relative to subunits from total molar amount of all dicarboxylic acids used to prepare the polyester-polyol.

Embodiment 16. The biodegradable polyurethane of any one of Embodiments 9-15, wherein the one or more C₂-C₆ diols comprise 1,3-propanediol; 1,4-butanediol; 1,5-pentanediol; 1,6-hexanediol; or a combination of two or more thereof.

Embodiment 17. The biodegradable polyurethane of any one of Embodiments 9-16, wherein the one or more C₂-C₆ diols comprise 1,3-propanediol.

Embodiment 18. The biodegradable polyurethane of any one of Embodiments 1-17, wherein the 2,5-furandicarboxylic acid is derived from a photosynthetic source.

Embodiment 19. The biodegradable polyurethane of Embodiment 18, wherein the photosynthetic source comprises algae, plant(s), or a combination thereof.

Embodiment 20. The biodegradable polyurethane of any one of Embodiments 1-19, wherein the polyester-polyol has a molecular weight as measured by gel permeation chromatography (GPC) of about 3900 g/mol to about 11000 g/mol.

Embodiment 21. The biodegradable polyurethane of any one of Embodiments 1-20 having 20% to 40% hard segments as calculated by the following equation:

$$Hard segment ( \% ) = \frac{{g}_{( chain extender )} + {g}_{( diisocyanate )}}{{g}_{( total mass )}} * 100$$

wherein g_{(chain extender)} is mass of chain extender, g_{(diisocyanate)} is mass of diisocyanate, and g_{(total mass)} is total mass of the polyurethane.

Embodiment 22. The biodegradable polyurethane of any one of Embodiments 1-21, wherein the molar ratio of subunits from polyester-polyol to subunits from chain extender is 0.3:1 to 1.7:1.

Embodiment 23. The biodegradable polyurethane of any one of Embodiments 1-22, wherein the molar ratio of subunits from diisocyanate to subunits from chain extender is 1.4:1 to 3.0:1.

Embodiment 24. The biodegradable polyurethane of any one of Embodiments 1-23, wherein the molar ratio of subunits from diisocyanate to subunits from polyester-polyol is 1.70:1 to 4.65:1.

Embodiment 25. The biodegradable polyurethane of any one of Embodiments 1-21, wherein the chain extender is incorporated in an amount of 1 to 20 parts per 100 parts of polyester-polyol to prepare the biodegradable polyurethane.

Embodiment 26. The biodegradable polyurethane of any one of Embodiments 1-21 or Embodiment 25, wherein the aliphatic diisocyanate is incorporated in an amount of 20 to 50 parts per 100 parts of polyester-polyol to prepare the biodegradable polyurethane.

Embodiment 27. The biodegradable polyurethane of any one of Embodiments 1-26 in the form of a thermoset polyurethane.

Embodiment 28. The biodegradable polyurethane of any one of Embodiments 1-27 in the form of a foam.

Embodiment 29. The biodegradable polyurethane of any one of Embodiments 1-26 in the form of a thermoplastic polyurethane.

Embodiment 30. A method to prepare a biodegradable polyurethane, the method comprising:
contacting 2,5-furandicarboxylic acid, one or more linear aliphatic dicarboxylic acids with at least 3 carbons, and one or more C₂-C₆ diols in a first polymerization reaction to obtain a polyester-polyol; and
contacting the polyester-polyol with a chain extender and an aliphatic diisocyanate in a second polymerization reaction to obtain the biodegradable polyurethane.

Embodiment 31. The method of Embodiment 30, wherein the aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; isophorone diisocyanate; methylene dicyclohexyl diisocyanate; or a combination of two or more thereof.

Embodiment 32. The method of Embodiment 30 or Embodiment 31, wherein the aliphatic diisocyanate comprises 1,3-trimethylene diisocyanate; 1,5-pentamethylene diisocyanate; 1,7-heptamethylene diisocyanate; or a combination of two or more thereof.

Embodiment 33. The method of Embodiment 30 or Embodiment 31, wherein the aliphatic diisocyanate comprises 1,4-tetramethylene diisocyanate; 1,6-hexamethylene diisocyanate; 1,8-octamethylene diisocyanate; 1,12-diisocyanatododecane; or a combination of two or more thereof.

Embodiment 34. The method of any one of Embodiments 30-33, wherein the aliphatic diisocyanate is derived from a photosynthetic source.

Embodiment 35. The method of Embodiment 34, wherein the photosynthetic source comprises algae, plant(s), or a combination thereof.

Embodiment 36. The method of any one of Embodiments 30-35, wherein the chain extender comprises 1,3-propanediol; 1,4-butanediol; 1,5-pentanediol; 1,6-hexanediol; or a combination of two or more thereof.

Embodiment 37. The method of any one of Embodiments 30-36, wherein the chain extender comprises 1,3-propanediol.

Embodiment 38. The method of any one of Embodiments 30-37, wherein the polyester-polyol further comprises subunits from one or more linear aliphatic dicarboxylic acids with at least 3 carbons and one or more C₂-C₆ diols.

Embodiment 39. The method of Embodiment 38, wherein the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof.

Embodiment 40. The method of Embodiment 38 or Embodiment 39, wherein the one or more linear aliphatic dicarboxylic acids comprise azelaic acid.

Embodiment 41. The method of any one of Embodiments 38-40, wherein the one or more linear aliphatic dicarboxylic acids are derived from a photosynthetic source.

Embodiment 42. The method of Embodiment 41, wherein the photosynthetic source comprises algae, plant(s), or a combination thereof.

Embodiment 43. The method of any one of Embodiments 38-42, wherein 2,5-furandicarboxylic acid is present in an amount of 1 mol % to 30 mol % relative to total molar amount of all dicarboxylic acids used to prepare the polyester-polyol.

Embodiment 44. The method of any one of Embodiments 38-43, wherein 2,5-furandicarboxylic acid is present in an amount of 10 mol % to 30 mol % relative to total molar amount of all dicarboxylic acids used to prepare the polyester-polyol.

Embodiment 45. The method of any one of Embodiments 38-44, wherein the one or more C₂-C₆ diols comprise 1,3-propanediol; 1,4-butanediol; 1,5-pentanediol; 1,6-hexanediol; or a combination of two or more thereof.

Embodiment 46. The method of any one of Embodiments 38-45, wherein the one or more C₂-C₆ diols comprise 1,3-propanediol.

Embodiment 47. The method of any one of Embodiments 30-46, wherein the 2,5-furandicarboxylic acid is derived from a photosynthetic source.

Embodiment 48. The method of Embodiment 47, wherein the photosynthetic source comprises algae, plant(s), or a combination thereof.

Embodiment 49. The method of any one of Embodiments 30-48, wherein the molar ratio of polyester-polyol to chain extender is 0.3:1 to 1.7:1.

Embodiment 50. The method of any one of Embodiments 30-49, wherein the molar ratio of diisocyanate to chain extender is 1.4:1 to 3.0:1.

Embodiment 51. The method of any one of Embodiments 30-50, wherein the molar ratio of subunits from diisocyanate to subunits from polyester-polyol is 1.70:1 to 4.65:1.

Embodiment 52. The method of any one of Embodiments 30-48, wherein the aliphatic diisocyanate is incorporated in an amount of 20 to 50 parts per 100 parts of polyester-polyol.

Embodiment 53. The method of any one of Embodiments 30-48 or Embodiment 52, wherein the chain extender is incorporated in an amount of 1 to 20 parts per 100 parts of polyester-polyol.

Embodiment 54. The method of any one of Embodiments 30-53, further comprising providing the 2,5-furandicarboxylic acid, the one or more linear aliphatic dicarboxylic acids, the one or more C₂-C₆ diols, the chain extender, and the aliphatic diisocyanate from photosynthetic source(s); and the photosynthetic source(s) comprise algae, plant(s), or a combination thereof.

Embodiment 55. The method of any one of Embodiments 30-54, wherein the biodegradable polyurethane is in the form of a thermoset polyurethane.

Embodiment 56. The method of any one of Embodiments 30-55, wherein the biodegradable polyurethane is in the form of a foam.

Embodiment 57. The method of any one of Embodiments 30-54, wherein the biodegradable polyurethane is in the form of a thermoplastic polyurethane.

Embodiment 58. A biodegradable thermoset polyurethane comprising subunits from a linear aliphatic diisocyanate, a linear aliphatic chain extender, and a linear aliphatic polyester-polyol.

Embodiment 59. The biodegradable thermoset polyurethane of Embodiment 58, wherein the linear aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; or a combination of two or more thereof.

Embodiment 60. The biodegradable thermoset polyurethane of Embodiment 58 or Embodiment 59, wherein the linear aliphatic diisocyanate comprises 1,3-trimethylene diisocyanate; 1,5-pentamethylene diisocyanate; 1,7-heptamethylene diisocyanate; or a combination of two or more thereof.

Embodiment 61. The biodegradable thermoset polyurethane of Embodiment 58 or Embodiment 59, wherein the linear aliphatic diisocyanate comprises 1,4-tetramethylene diisocyanate; 1,6-hexamethylene diisocyanate; 1,8-octamethylene diisocyanate; 1,12-diisocyanatododecane; or a combination of two or more thereof.

Embodiment 62. The biodegradable thermoset polyurethane of any one of Embodiments 58-61, wherein the linear aliphatic diisocyanate is derived from a photosynthetic source.

Embodiment 63. The biodegradable thermoset polyurethane of Embodiment 62, wherein the photosynthetic source comprises algae, plant(s), or a combination thereof.

Embodiment 64. The biodegradable thermoset polyurethane of any one of Embodiments 58-63, wherein the linear chain extender comprises 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof.

Embodiment 65. The biodegradable thermoset polyurethane of any one of Embodiments 58-64, wherein the linear chain extender comprises 1,3-propanediol.

Embodiment 66. The biodegradable thermoset polyurethane of any one of Embodiments 58-65, wherein the linear aliphatic polyester-polyol comprises subunits with one or more linear aliphatic dicarboxylic acids with at least 3 carbons and one or more C₂-C₁₀ diols.

Embodiment 67. The biodegradable thermoset polyurethane of Embodiment 66, wherein the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof.

Embodiment 68. The biodegradable thermoset polyurethane of Embodiment 66 or Embodiment 67, wherein the one or more linear aliphatic dicarboxylic acids comprise azelaic acid.

Embodiment 69. The biodegradable thermoset polyurethane of any one of Embodiments 66-68, wherein the one or more linear aliphatic dicarboxylic acids are derived from a photosynthetic source.

Embodiment 70. The biodegradable thermoset polyurethane of Embodiment 69, wherein the photosynthetic source comprises algae, plant(s), or a combination thereof.

Embodiment 71. The biodegradable thermoset polyurethane of any one of Embodiments 66-70, wherein the one or more C₂-C₁₀ diols comprise 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof.

Embodiment 72. The biodegradable thermoset polyurethane of any one of Embodiments 66-71, wherein the one or more C₂-C₁₀ diols comprise 1,3-propanediol.

Embodiment 73. The biodegradable thermoset polyurethane of any one of Embodiments 58-72, wherein the linear aliphatic chain extender is incorporated in an amount of 1 to 20 parts per 100 parts of polyester-polyol to prepare the biodegradable polyurethane.

Embodiment 74. The biodegradable thermoset polyurethane of any one of Embodiments 58-73, wherein the linear aliphatic diisocyanate is incorporated in an amount of 25 to 30 parts per 100 parts of polyester-polyol to prepare the biodegradable polyurethane.

Embodiment 75. The biodegradable thermoset polyurethane of any one of Embodiments 58-74 in the form of a foam.

Embodiment 76. A method to prepare a biodegradable thermoset polyurethane, the method comprising:
contacting one or more linear aliphatic dicarboxylic acids with at least 3 carbons, and one or more C₂-C₁₀ diols in a first polymerization reaction to obtain a linear aliphatic polyester-polyol; and
contacting the linear aliphatic polyester-polyol with a linear aliphatic chain extender and a linear aliphatic diisocyanate in a second polymerization reaction to obtain the biodegradable thermoset polyurethane.

Embodiment 77. The method of Embodiment 76, wherein the linear aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; or a combination of two or more thereof.

Embodiment 78. The method of Embodiment 76 or Embodiment 77, wherein the linear aliphatic diisocyanate comprises 1,3-trimethylene diisocyanate; 1,5-pentamethylene diisocyanate; 1,7-heptamethylene diisocyanate; or a combination of two or more thereof.

Embodiment 79. The method of Embodiment 76 or Embodiment 77, wherein the linear aliphatic diisocyanate comprises 1,4-tetramethylene diisocyanate; 1,6-hexamethylene diisocyanate; 1,8-octamethylene diisocyanate; 1,12-diisocyanatododecane; or a combination of two or more thereof.

Embodiment 80. The method of any one of Embodiments 76-79, wherein the linear aliphatic diisocyanate is derived from a photosynthetic source.

Embodiment 81. The method of Embodiment 80, wherein the photosynthetic source comprises algae, plant(s), or a combination thereof.

Embodiment 82. The method of any one of Embodiments 76-81, wherein the linear aliphatic chain extender comprises 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof.

Embodiment 83. The method of any one of Embodiments 76-82, wherein the linear aliphatic chain extender comprises 1,3-propanediol.

Embodiment 84. The method of any one of Embodiments 76-83, wherein the linear aliphatic polyester-polyol comprises subunits with one or more linear aliphatic dicarboxylic acids with at least 3 carbons and one or more C₂-C₁₀ diols.

Embodiment 85. The method of Embodiment 84, wherein the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof.

Embodiment 86. The method of Embodiment 84 or Embodiment 85, wherein the one or more linear aliphatic dicarboxylic acids comprise azelaic acid.

Embodiment 87. The method of any one of Embodiments 84-86, wherein the one or more linear aliphatic dicarboxylic acids are derived from a photosynthetic source.

Embodiment 88. The method of Embodiment 87, wherein the photosynthetic source comprises algae, plant(s), or a combination thereof.

Embodiment 89. The method of any one of Embodiments 84-88, wherein the one or more C₂-C₁₀ diols comprise 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof.

Embodiment 90. The method of any one of Embodiments 84-89, wherein the one or more C₂-C₁₀ diols comprise 1,3-propanediol.

Embodiment 91. The method of any one of Embodiments 76-90, wherein the linear aliphatic diisocyanate is incorporated in an amount of 20 to 50 parts per 100 parts of polyester-polyol.

Embodiment 92. The method of any one of Embodiments 76-91, wherein the linear aliphatic chain extender is incorporated in an amount of 1 to 20 parts per 100 parts of polyester-polyol.

Embodiment 93. The method of any one of Embodiments 76-92, further comprising providing the one or more linear aliphatic dicarboxylic acids, the one or more C₂-C₁₀ diols, the linear aliphatic chain extender, and the linear aliphatic diisocyanate from photosynthetic source(s); and the photosynthetic source(s) comprise algae, plant(s), or a combination thereof.

Embodiment 94. The method of any one of Embodiments 76-93, wherein the biodegradable polyurethane is in the form of a foam.

Other embodiments are set forth in the following claims.

What is claimed is:

1. A polyurethane comprising subunits from a linear aliphatic diisocyanate, a linear aliphatic chain extender, and a polyester-polyol.

2. The polyurethane of claim 1, wherein the linear aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; or a combination of two or more thereof.

3. The polyurethane of claim 1, wherein the linear aliphatic diisocyanate comprises 1,7-heptamethylene diisocyanate.

4. The polyurethane of claim 1, wherein the linear chain extender comprises 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof.

5. The polyurethane of claim 1, wherein the polyester-polyol comprises subunits with one or more linear aliphatic dicarboxylic acids with at least 3 carbons and one or more C₂-C₁₀ diols, wherein the one or more linear aliphatic dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, or a combination of two or more thereof.

6. The polyurethane of claim 1, wherein the polyester polyol comprises subunits from 2,5-furan dicarboxylic acid.

7. The polyurethane of claim 1, wherein the polyurethane is biodegradable.

8. The polyurethane of claim 7, wherein the polyurethane is in the form of a thermoset polyurethane.

9. The polyurethane of claim 7, wherein the polyurethane is in the form of a thermoplastic polyurethane.

10. A method to prepare a polyurethane, the method comprising:
contacting one or more dicarboxylic acids with at least 3 carbons, and one or more C₂-C₁₀ diols in a first polymerization reaction to obtain a polyester-polyol; and
contacting the polyester-polyol with a linear aliphatic chain extender and a linear aliphatic diisocyanate in a second polymerization reaction to obtain the polyurethane.

11. The method of claim 10, wherein the linear aliphatic diisocyanate comprises 1,3-trimethylene diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,12-diisocyanatododecane; or a combination of two or more thereof.

12. The method of claim 10, wherein the linear aliphatic diisocyanate comprises 1,7-heptamethylene diisocyanate.

13. The method of claim 10, wherein the linear aliphatic chain extender comprises 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof.

14. The method of claim 8, wherein the polyester-polyol comprises subunits with one or more dicarboxylic acids with at least 3 carbons and one or more C₂-C₁₀ diols, wherein the one or more C₂-C₁₀ diols comprise 1,2-ethanediol; 1,3-propanediol; 1,4-butanediol; 1,5-pentanediol; 1,6-hexanediol; 1,7-heptanediol; 1,8-octanediol; 1,9-nonanediol; 1,10-decanediol; or a combination of two or more thereof.

15. The method of claim 12, wherein the one or more dicarboxylic acids comprise malonic acid, succinic acid, glutaric acid, adipic acid, pimelic acid, suberic acid, azelaic acid, sebacic acid, undecanedioic acid, dodecanedioic acid, tridecanedioic acid, 2,5-furan dicarboxylic acid, or a combination of two or more thereof.

16. The method of claim 10, wherein the polyurethane is a thermoplastic polyurethane.

17. The method of claim 10, wherein the polyurethane is a thermoset polyurethane.

18. A composition comprising:
a polyurethane, wherein the polyurethane comprises subunits from: a linear aliphatic diisocyanate, a linear aliphatic chain extender, and a polyester-polyol,
wherein when subjected to physical or chemical processes, the polyurethane produces fewer persistent microplastics as compared to a comparator polyurethane having:
(a) a diisocyanate subunit; and
(b) at least one property that is about the same as a property of the polyurethane, wherein the property comprises a strain-based, thermal, or physical property.

19. The composition of claim 18, wherein the polyurethane comprises 1,7-heptamethylene diisocyanate.

20. The composition of claim 18, wherein the polyurethane is in the form of a thermoplastic polyurethane.
